(19) United States
(12) Patent Application Publication
(10) Pub. No.: US 2026/0127233 A1
(43) Pub. Date: May 7, 2026

(54) OPTIMIZED GEOSPATIAL DATA PROCESSES VIA A DATABASE SYSTEM

(71) Applicant: Ocient Holdings LLC, Chicago, IL (US)

(72) Inventor: Daniel Joseph Zollers, Edgeville, PA (US)

(73) Assignee: Ocient Holdings LLC, Chicago, IL (US)

(21) Appl. No.: 18/938,392

(22) Filed: Nov. 6, 2024

(51) Int. Cl. G06F 16/9537; G06F 16/2453

(52) U.S. Cl. CPC G06F 16/9537; G06F 16/24537

(57) ABSTRACT

A method executable by a processing module of a database system includes identifying a query that includes a geospatial buffer expression for a geospatial object, obtaining the geospatial object based on the geospatial buffer expression, executing a geospatial object simplification function on the geospatial object to produce a simplified geospatial object, executing an offset curve function on the simplified geospatial object to produce one or more offset curves, executing an offset curve segment loop elimination function on the one or more offset curves to produce one or more simplified offset curves, and executing a depth analysis function on the one or more simplified offset curves to produce a geospatial object buffer geography of the geospatial object, wherein the depth analysis function identifies and eliminates portions of the simplified offset curves that are located inside the geospatial object buffer geography.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates generally to computer networking and more particularly to a database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. The issuing bank validates that the card has not been reported stolen or lost, confirms whether funds/credit is available, and sends a response code back through the payment processing network to the acquiring bank as to whether the transaction is approved.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system;

FIG. 1A is a schematic block diagram of an embodiment of a database system;

FIG. 2 is a schematic block diagram of an embodiment of an administrative sub-system;

FIG. 3 is a schematic block diagram of an embodiment of a configuration sub-system;

FIG. 4 is a schematic block diagram of an embodiment of a parallelized data input sub-system;

FIG. 5 is a schematic block diagram of an embodiment of a parallelized query and response (Q&R) sub-system;

FIG. 6 is a schematic block diagram of an embodiment of a parallelized data store, retrieve, and/or process (IO& P) sub-system;

FIG. 7 is a schematic block diagram of an embodiment of a computing device;

FIG. 8 is a schematic block diagram of another embodiment of a computing device;

FIG. 9 is a schematic block diagram of another embodiment of a computing device;

FIG. 10 is a schematic block diagram of an embodiment of a node of a computing device;

FIG. 11 is a schematic block diagram of an embodiment of a node of a computing device;

FIG. 12 is a schematic block diagram of an embodiment of a node of a computing device;

FIG. 13 is a schematic block diagram of an embodiment of a node of a computing device;

FIG. 14 is a schematic block diagram of an embodiment of operating systems of a computing device;

FIGS. 15-23 are schematic block diagrams of an example of processing a table or data set for storage in the database system;

FIG. 24A is a schematic block diagram of a query execution plan implemented via a plurality of nodes;

FIGS. 24B-24D are schematic block diagrams of embodiments of a node that implements a query processing module;

FIG. 24E is a schematic block diagram of an embodiment of a plurality of nodes that communicate via shuffle networks;

FIG. 24F is a schematic block diagram of a database system communicating with an external requesting entity;

FIG. 24G is a schematic block diagram of an embodiment of a query processing system;

FIG. 24H is a schematic block diagram of an embodiment of a query operator execution flow,

FIG. 24I is a schematic block diagram of an embodiment of a plurality of nodes that utilize query operator execution flows;

FIG. 24J is a schematic block diagram of an embodiment of a query execution module that executes a query operator execution flow via a plurality of corresponding operator execution modules;

FIG. 24K is a schematic block diagram of an embodiment of a plurality of database tables stored in database storage;

FIG. 24L is a schematic block diagram of a query execution module that implements a plurality of column data streams;

FIG. 24M is a schematic block diagram of an embodiment of data blocks of a column data stream;

FIG. 24N is a schematic block diagram of an embodiment of a query execution module writing and processing of data blocks by operator execution modules;

FIG. 24O is a schematic block diagram of an embodiment of a database system that implements a segment generator that generates segments from a plurality of records;

FIG. 24P is a schematic block diagram of an embodiment of a segment generator that implements a cluster key-based grouping module, a columnar rotation module, and a metadata generator module;

FIG. 24Q is a schematic block diagram of an embodiment of a query processing system that generates and executes a plurality of IO pipelines to generate filtered records sets from a plurality of segments in conjunction with executing a query;

FIG. 24R is a schematic block diagram of an embodiment of a query processing system that generates an IO pipeline for accessing a corresponding segment based on predicates of a query;

FIGS. 25A-25B are schematic block diagrams of embodiments of a database system that includes a record processing and storage system;

FIG. 25C is a schematic block diagram of an embodiment of a page generator;

FIG. 25D is a schematic block diagram of an embodiment of a page storage system of a record processing and storage system;

FIG. 25E is a schematic block diagram of an embodiment of a node that implements a query processing module that reads records from segment storage and page storage;

FIG. 26A is a schematic block diagram of an embodiment of a segment generator of a record processing and storage system;

FIG. 26B is a schematic block diagram of an embodiment of a cluster key-based grouping module of a segment generator;

FIG. 27 is a schematic block diagram of an embodiment of a database system executing an optimized buffer process based on a buffer expression of a query request;

FIG. 28A is a diagram of an embodiment of geospatial object data;

FIG. 28B is a diagram of an embodiment of geospatial object buffer geographies;

FIG. 29 is a schematic block diagram of an embodiment of a UNION buffer process executable by a processing module of the database system;

FIG. 30 is a schematic block diagram of an embodiment of a buffer process executable by a processing module of the database system;

FIGS. 31A-31D are schematic block diagrams of an embodiment of an offset curve module operable to execute an offset curve function of a buffer process;

FIGS. 32A-32B are schematic block diagrams of an embodiment of a buffer geography determination module operable to execute a depth analysis function of a buffer process;

FIG. 33 is a schematic block diagram of an embodiment of an optimized buffer process executable by a processing module of the database system;

FIG. 34A is a schematic block diagram of an embodiment of an optimized offset curve module of an optimized buffer process;

FIG. 34B is a schematic block diagram of an embodiment of a portion of a loop condition module an optimized offset curve module;

FIG. 34C is a schematic block diagram of another embodiment of a portion of the loop condition module an optimized offset curve module;

FIG. 34D is a schematic block diagram of an embodiment of a portion of an optimized offset curve module that includes the loop elimination module;

FIG. 35A is a flowchart of an example of a method of an optimized buffer process;

FIG. 35B is a flowchart of an example of a method of an offset curve function of the optimized buffer process;

FIG. 35C is a flowchart of an example of a method of an offset curve segment loop elimination function of the optimized buffer process;

FIG. 35D is a flowchart of an example of a method of analyzing the one or more offset curves to identify the one or more loop conditions;

FIG. 35E is a flowchart of an example of a method of executing a depth analysis function on one or more simplified offset curves;

FIG. 35F is a flowchart of an example of a method of assigning a depth value to each simplified offset curve segment;

FIG. 36 is a schematic block diagram of an embodiment of a database system executing an optimized geospatial convex hull process based on a convex hull expression of a query request;

FIG. 37 is a diagram of an embodiment of a planar geospatial object convex hull geography;

FIGS. 38A-38C are prior art diagrams of an embodiment of a planar geospatial convex hull process;

FIGS. 39A-39B are diagrams of embodiments of non-planar geospatial object data;

FIGS. 40A-40B are prior art diagrams of an embodiment of a planar geospatial convex hull process adapted for geospatial object(s) on a spherical surface;

FIG. 41 is a diagram of an embodiment of initiating an optimized geospatial convex hull process;

FIGS. 42A-42H are diagrams of an embodiment of a hemisphere determination process of the optimized geospatial convex hull process;

FIG. 43 is a flowchart of an example of a method of an optimized geospatial convex hull process;

FIG. 44 is a flowchart of an example of a method of executing a hemisphere determination process of the optimized geospatial convex hull process; and

FIG. 45 is a flowchart of an example of a method of a midpoint distance determination function of a hemisphere determination process.

### DETAILED DESCRIPTION OF THE INVENTION

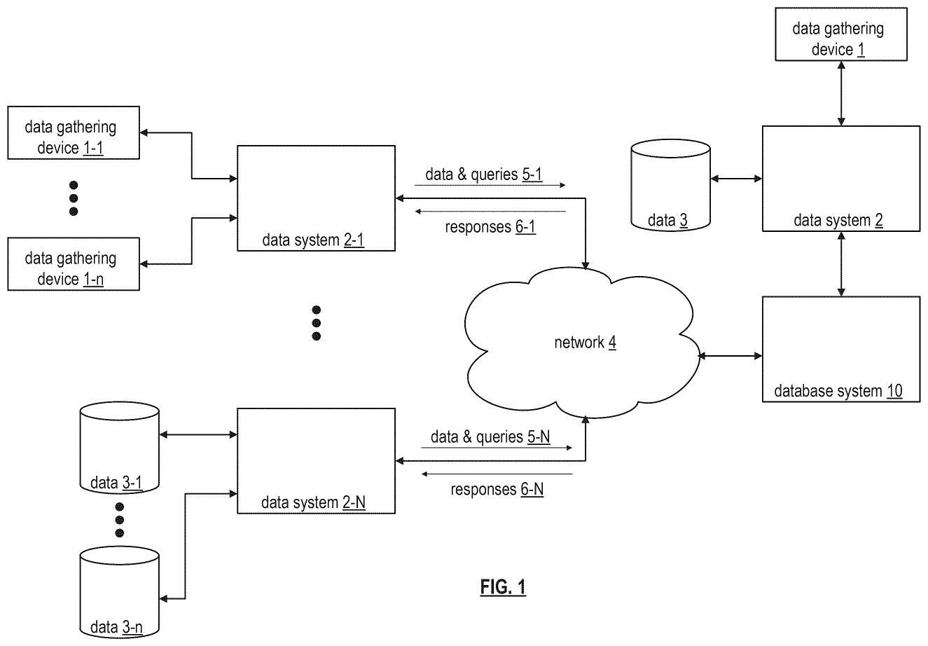

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of wide area network (WAN) connections, local area network (LAN) connections, wireless connections, wireline connections, etc. to couple the sub-systems 11, 12, 13, 15, and 16 together.

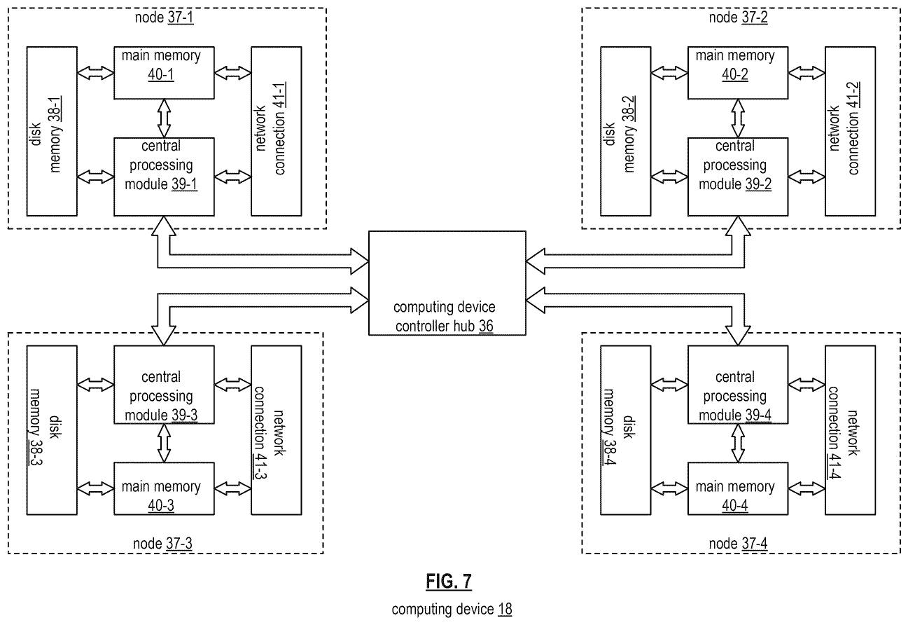

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

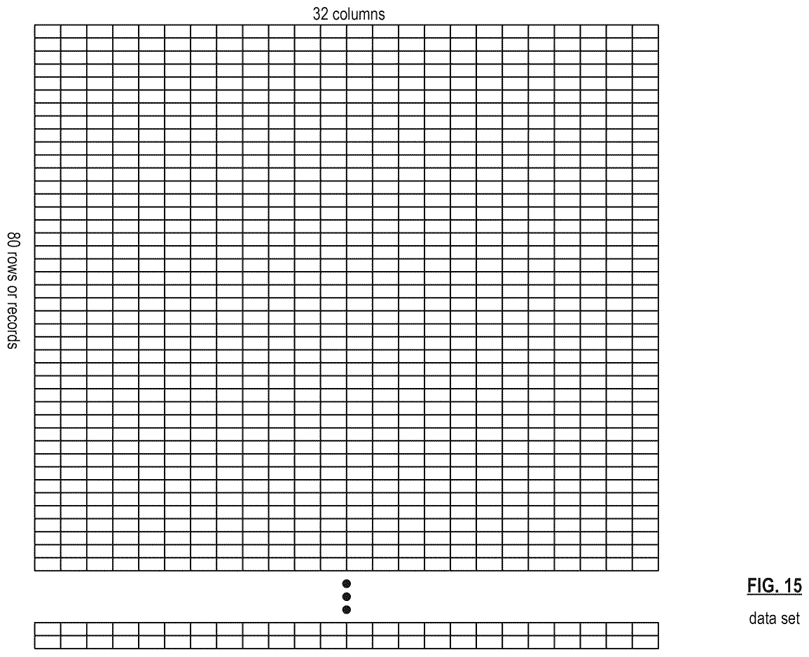

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

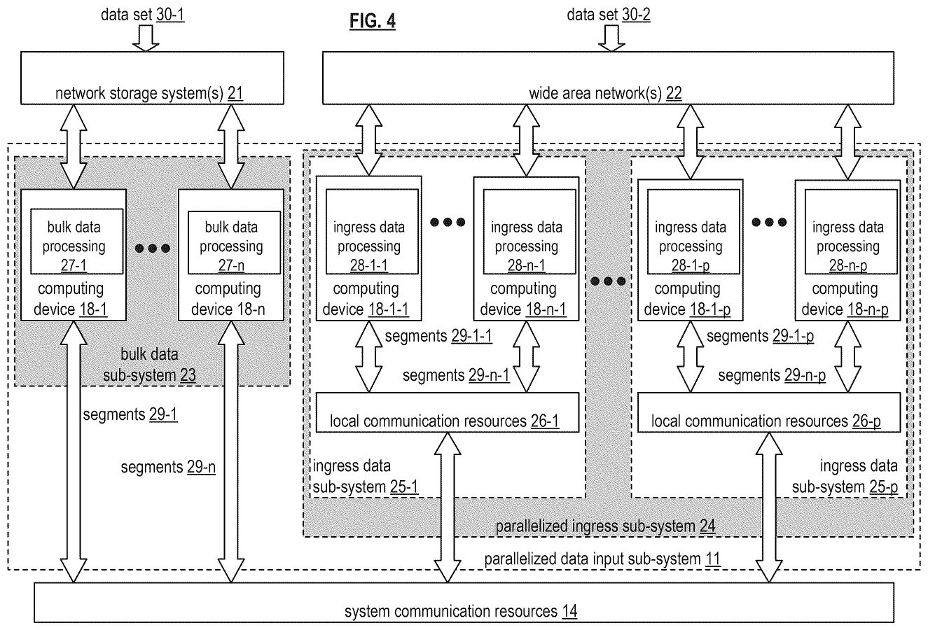

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

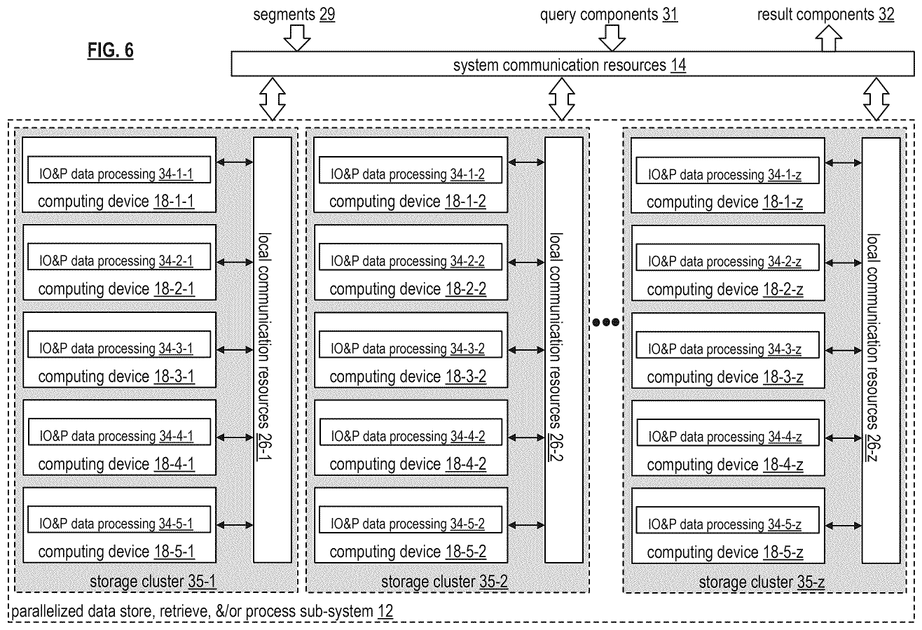

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates an SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

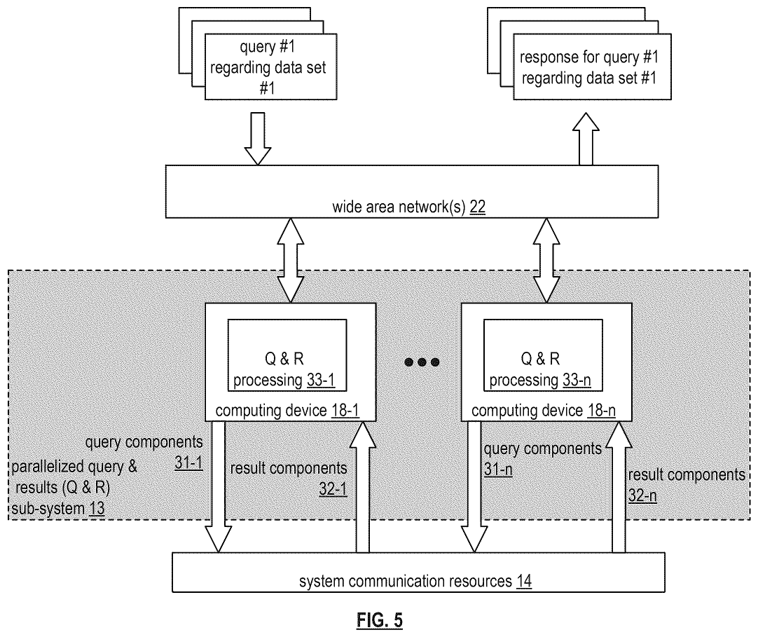

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

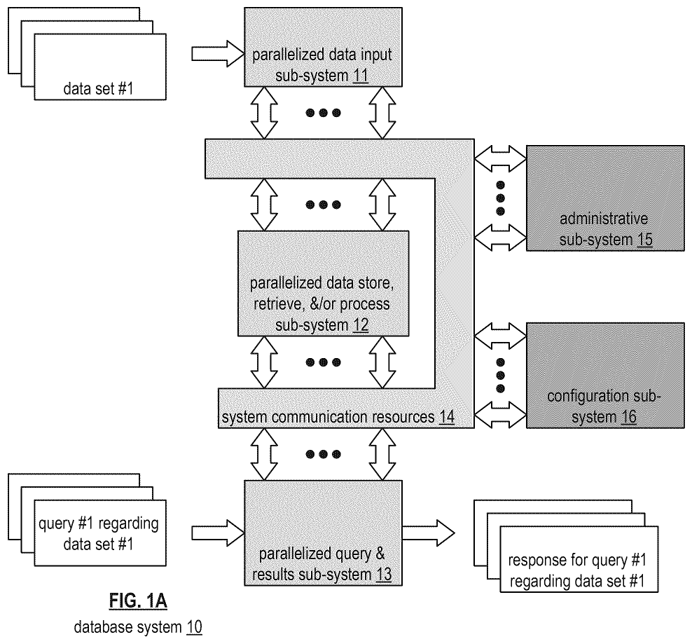

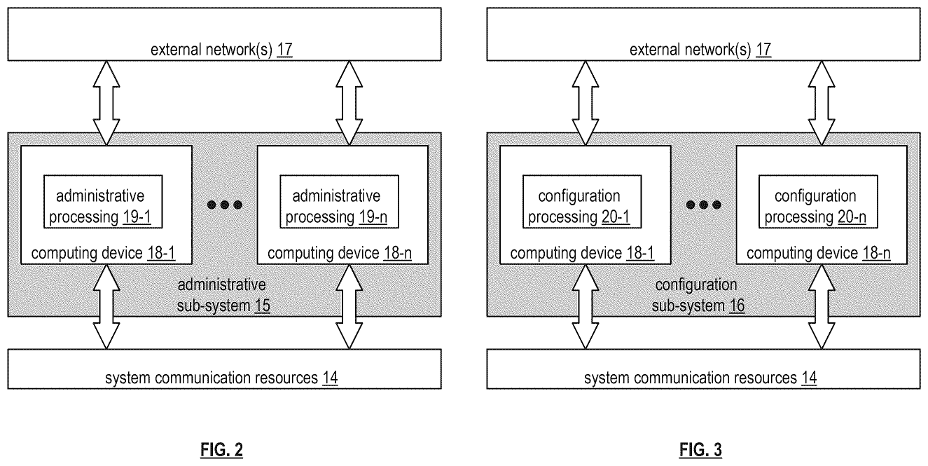

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes, and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

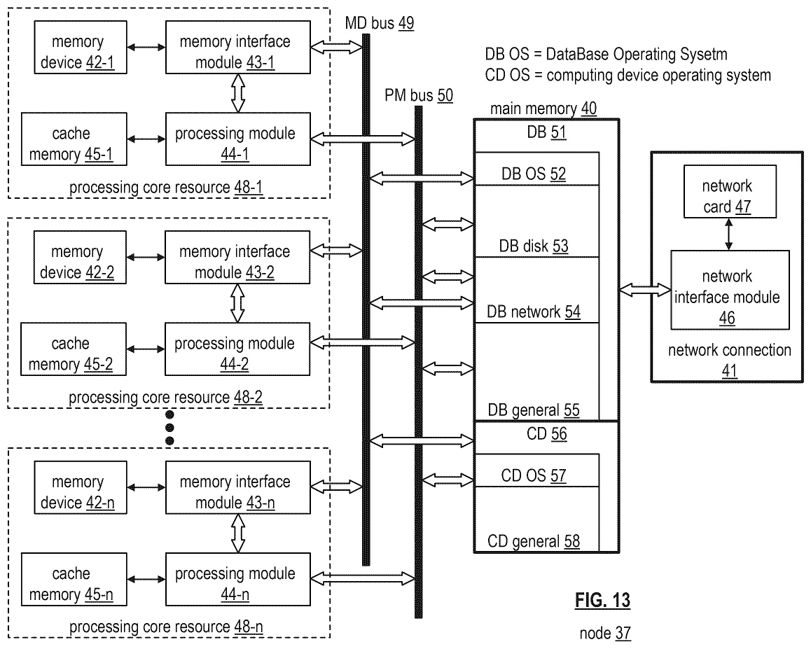

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

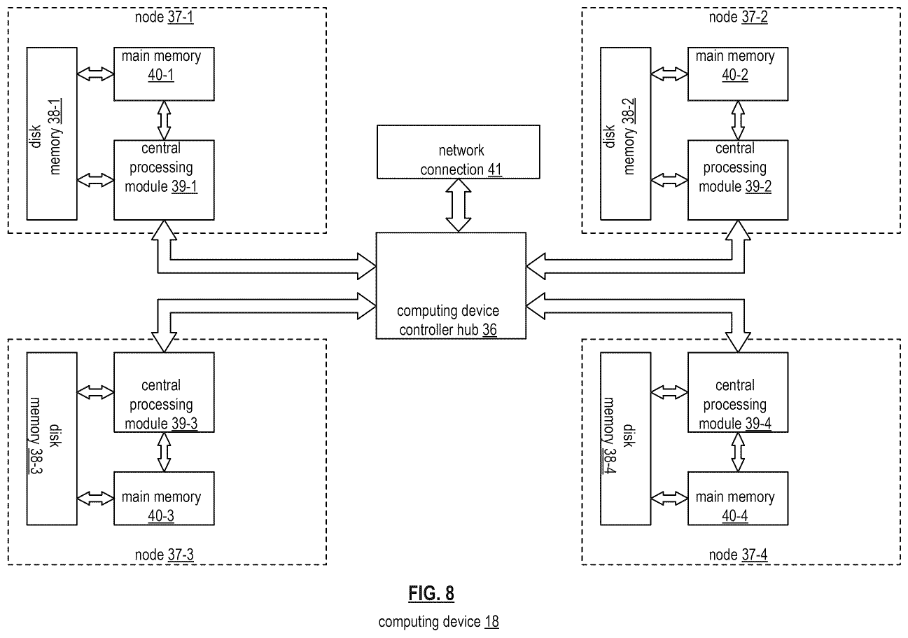

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

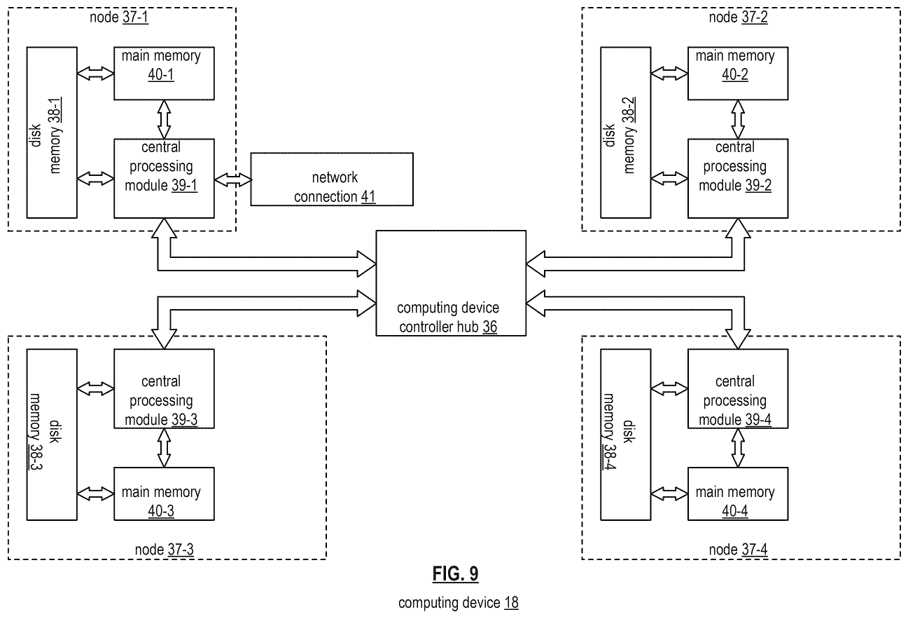

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

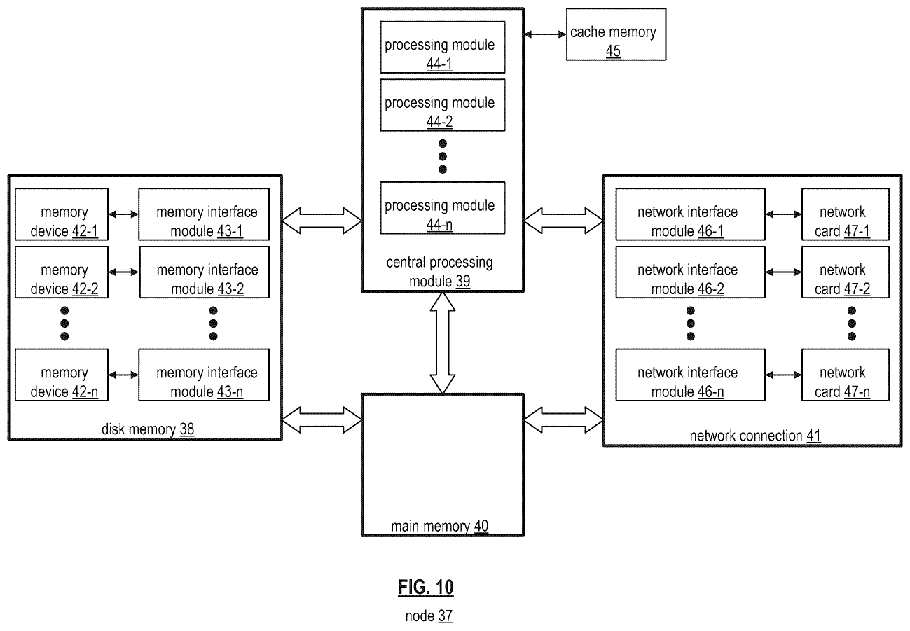

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

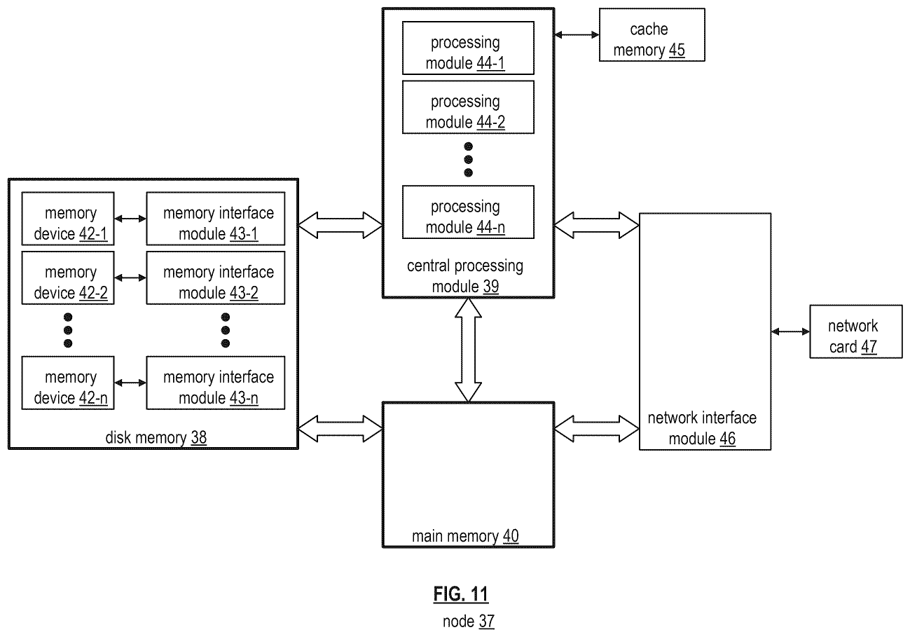

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

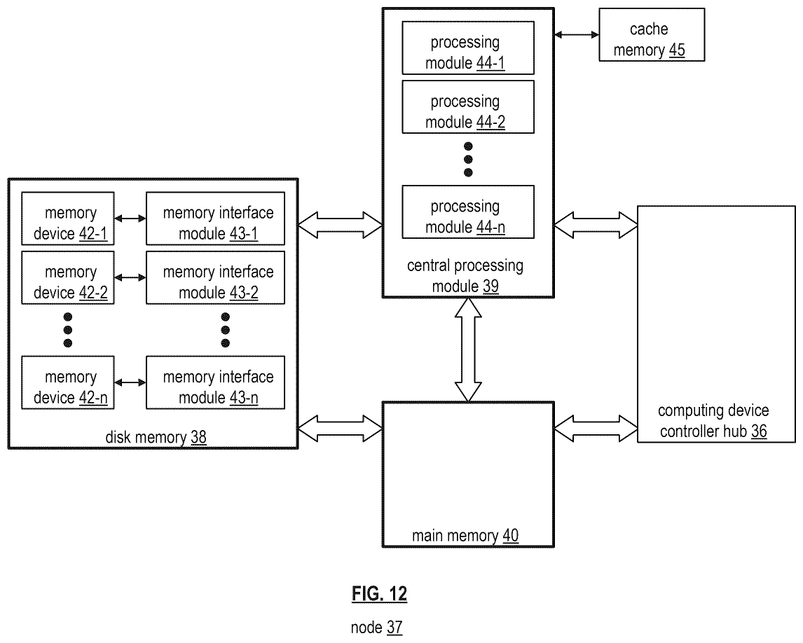

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

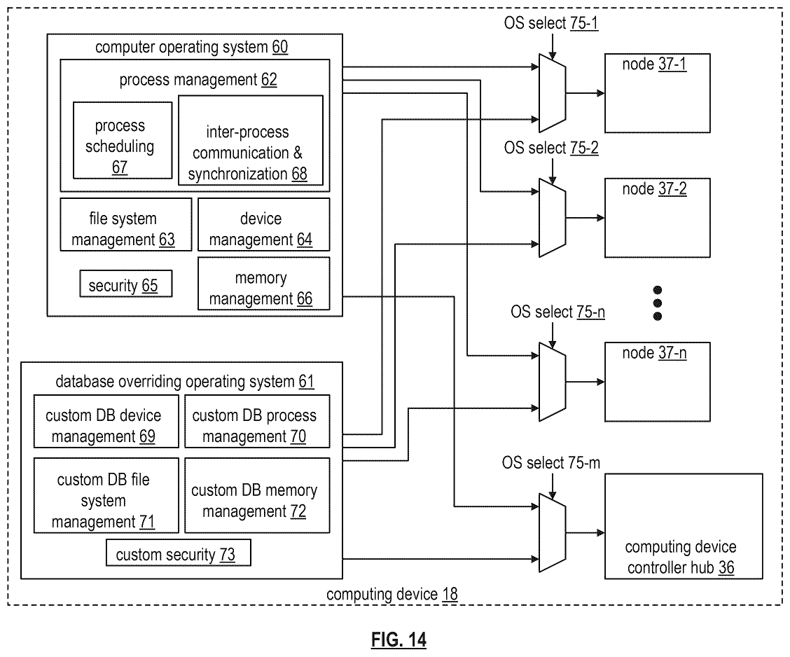

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many, concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table but is sufficient for illustrating one or more concepts regarding one or more aspects of a database system. The table is representative of a variety of data ranging from insurance data to financial data, to employee data, to medical data, and so on.

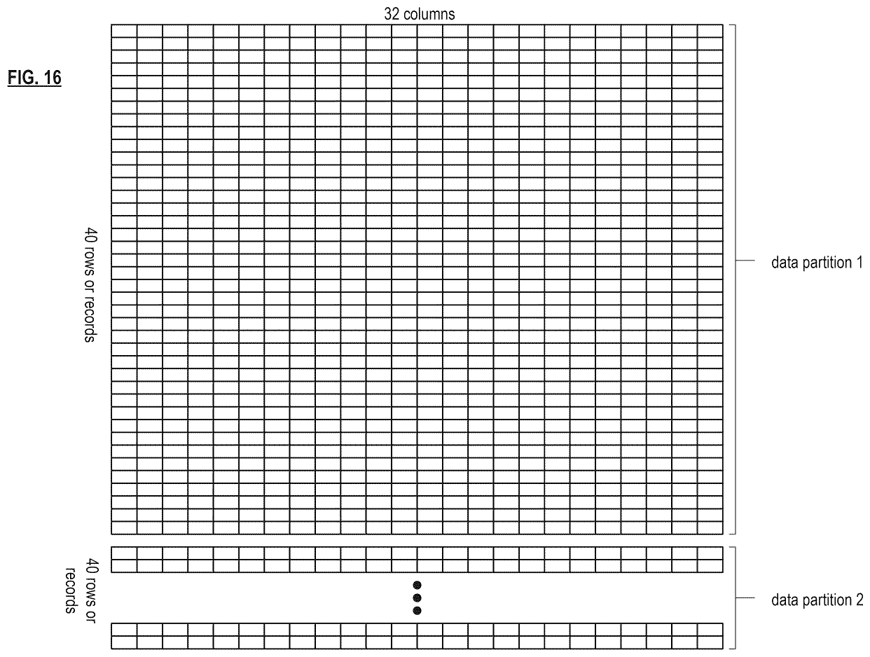

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

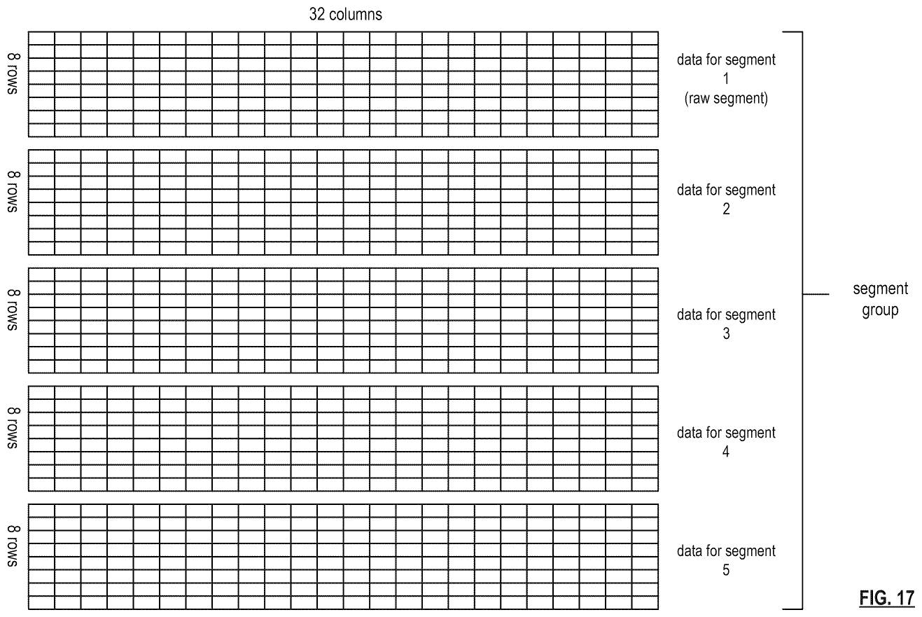

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

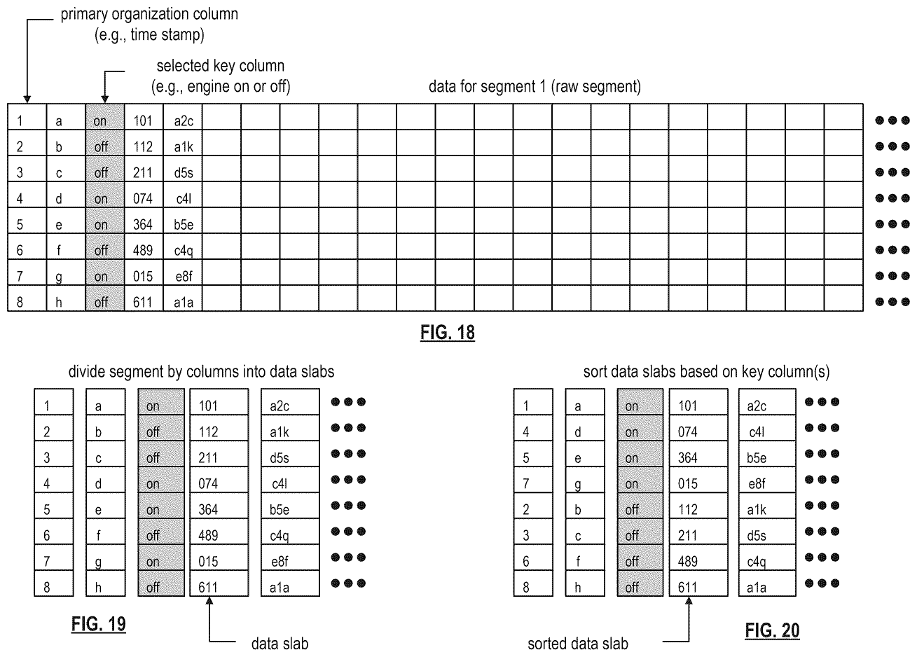

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

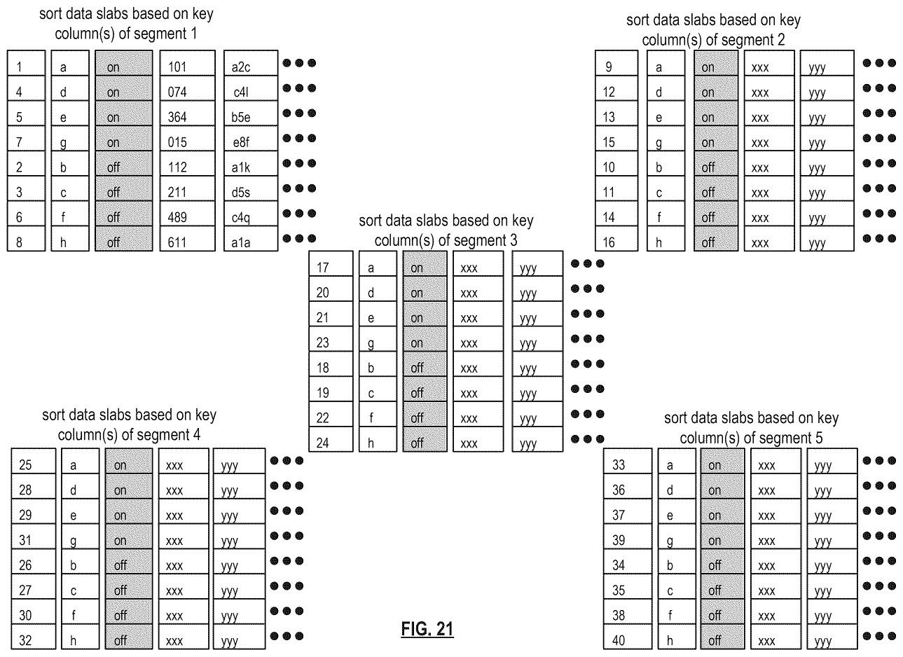

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

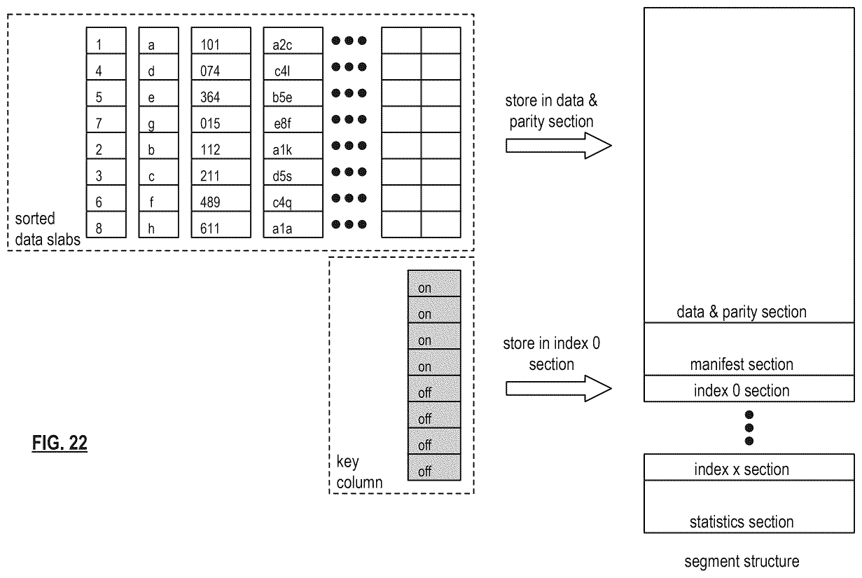

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

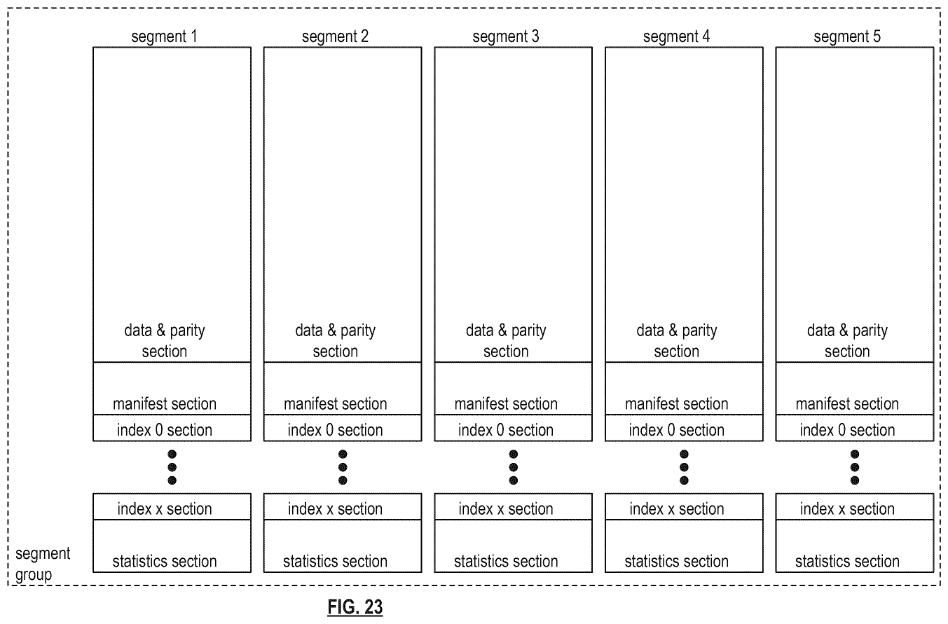

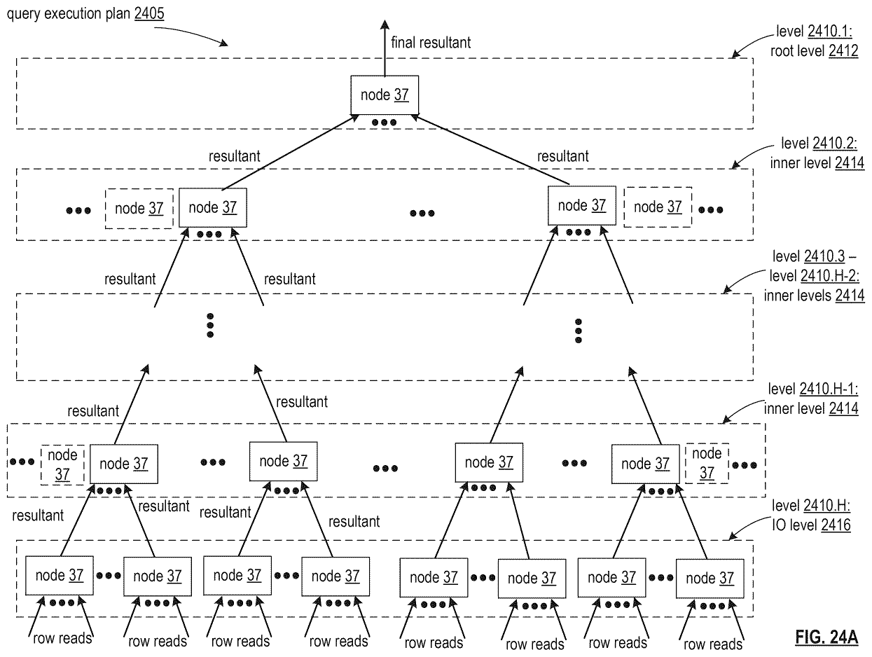

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

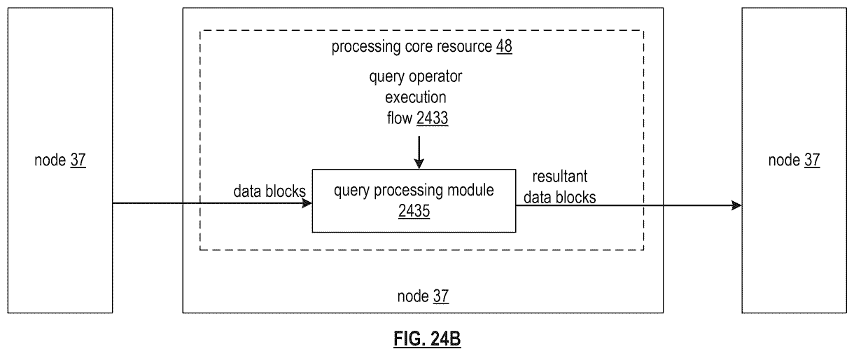

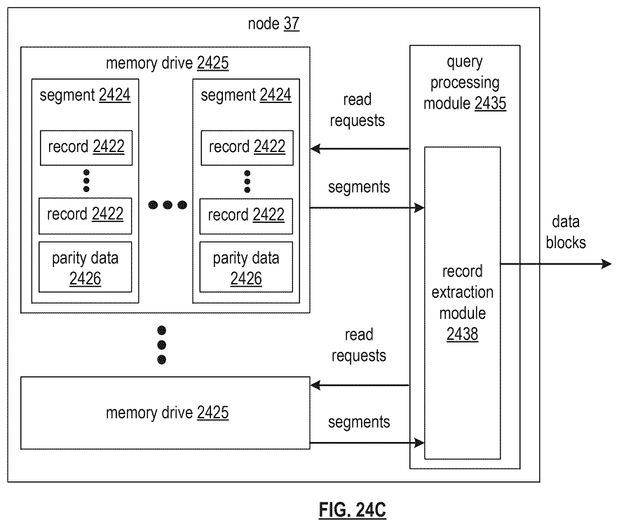

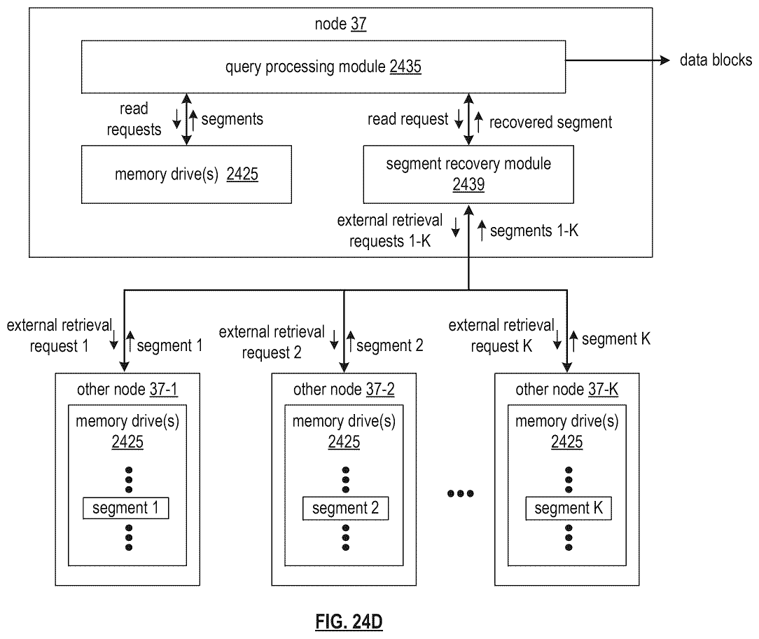

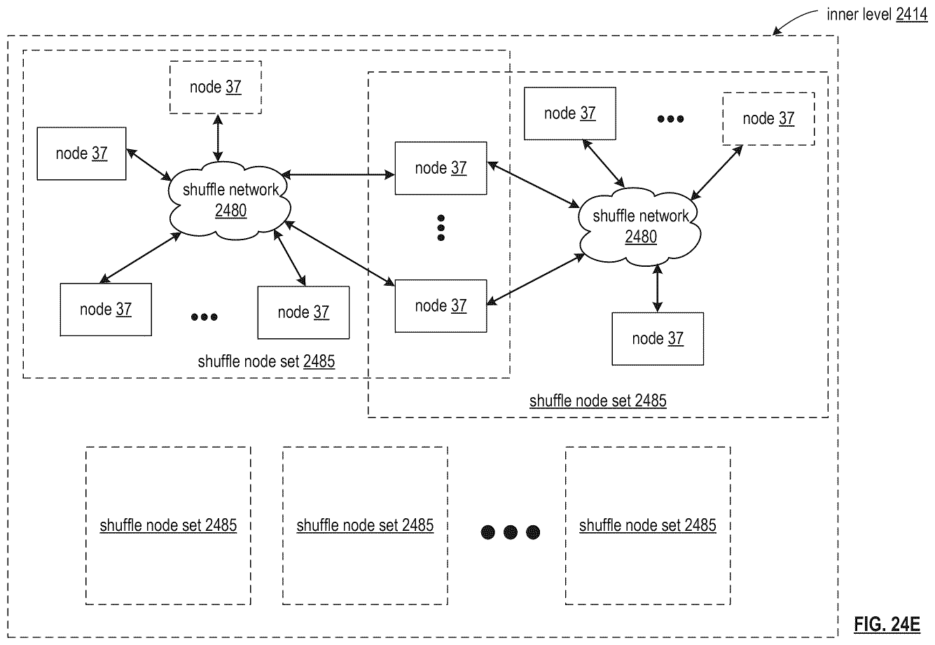

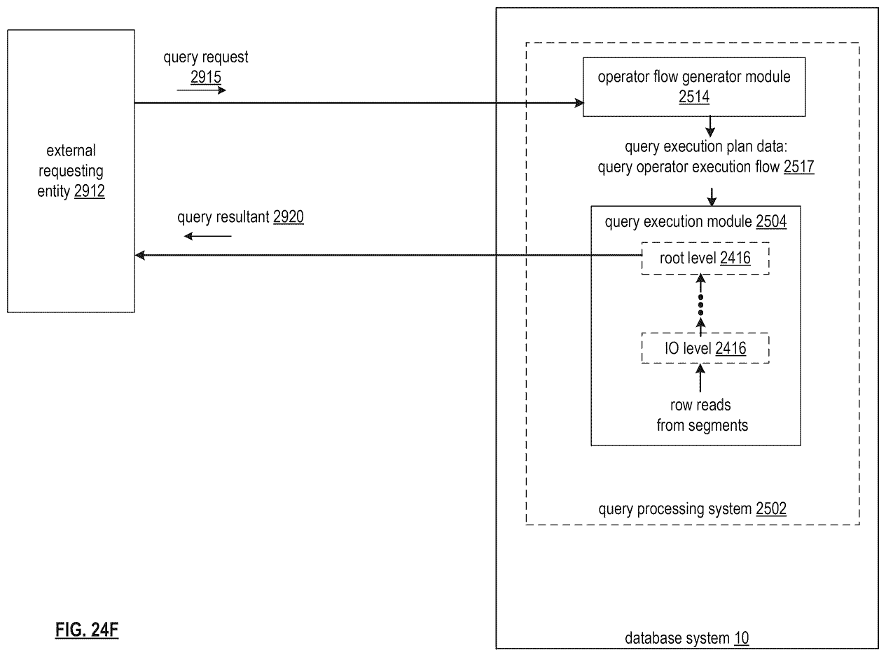

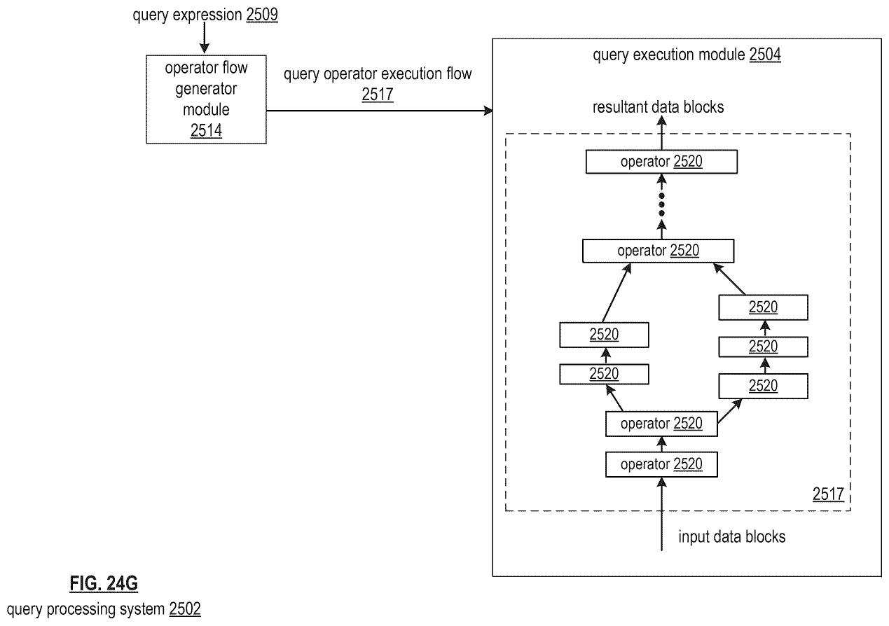

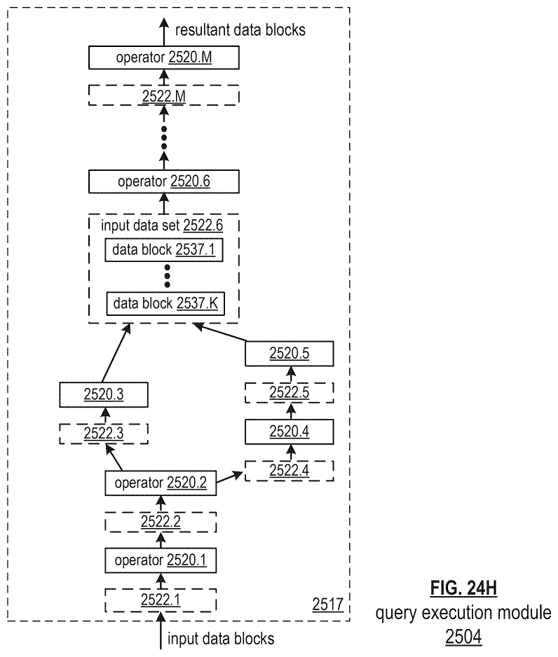

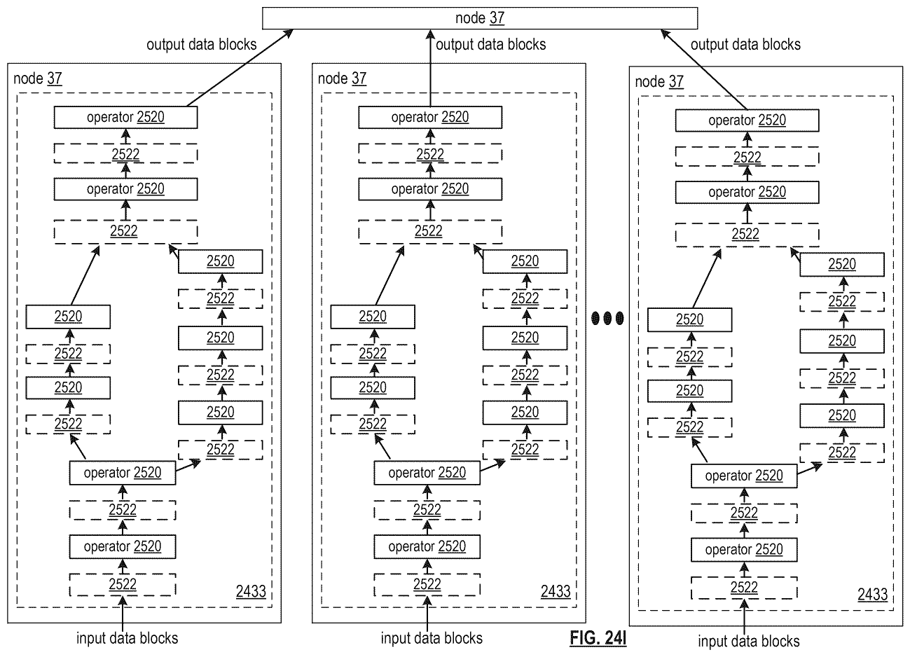

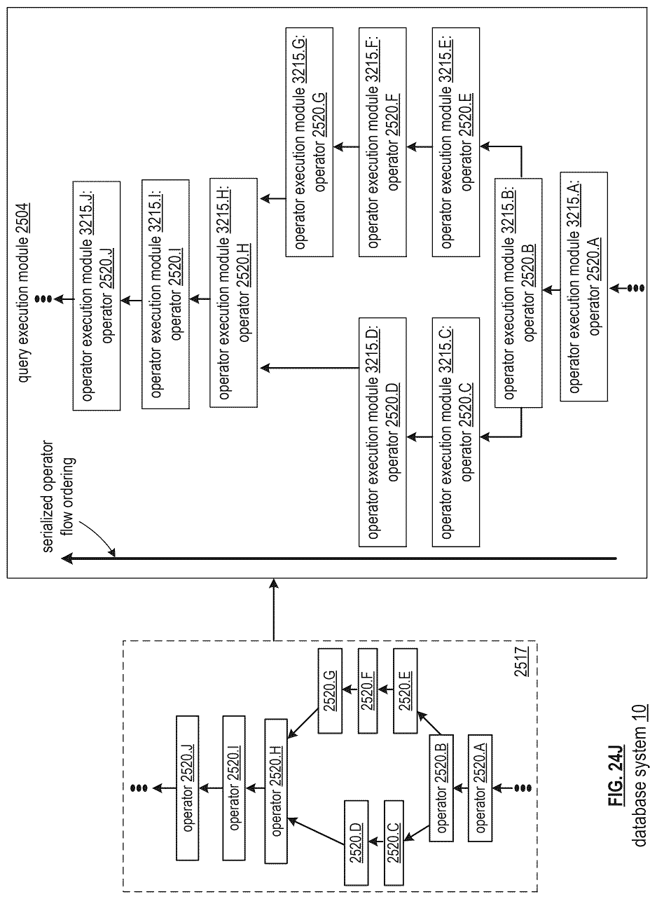

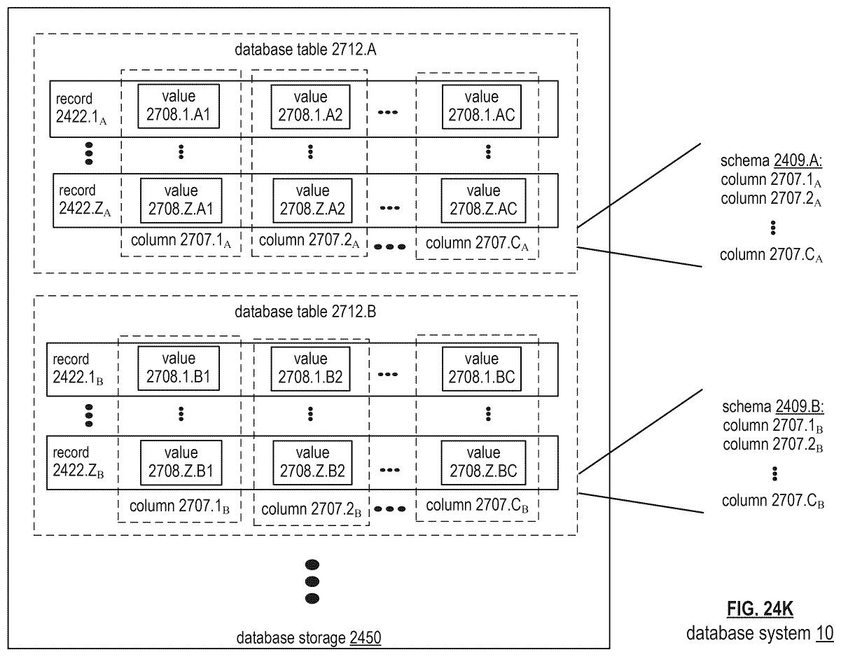

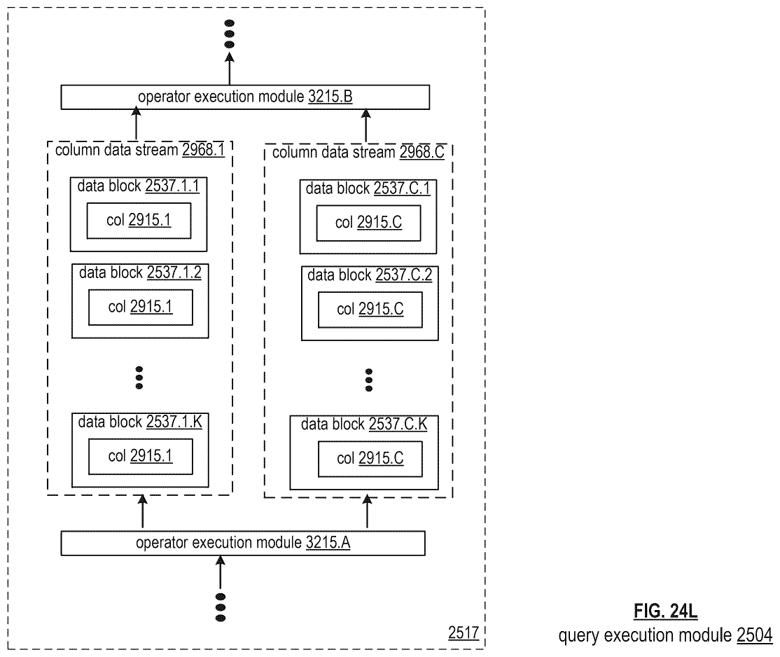

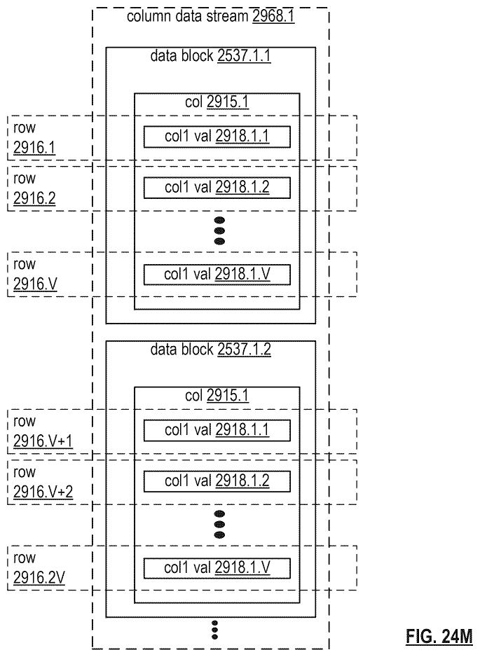

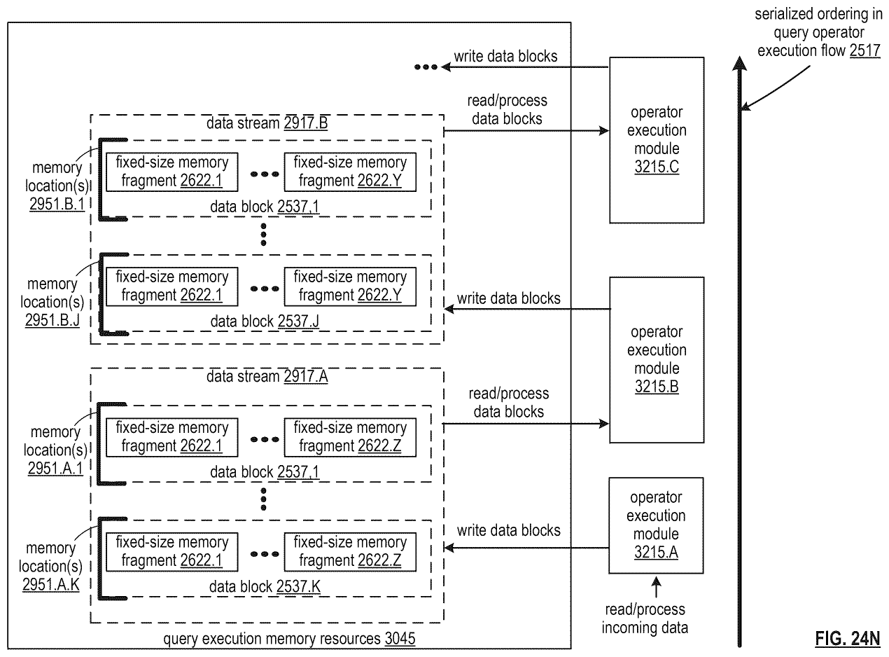

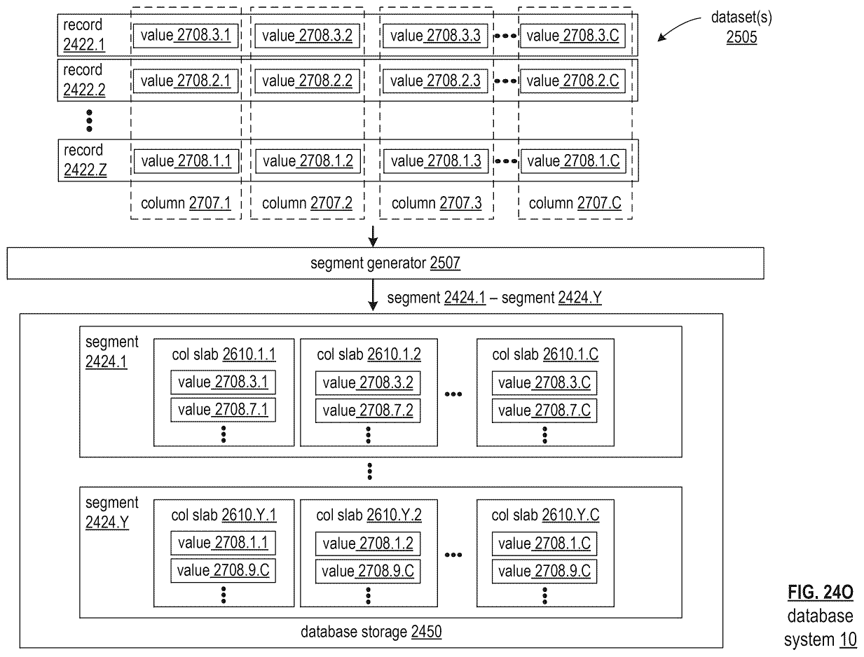

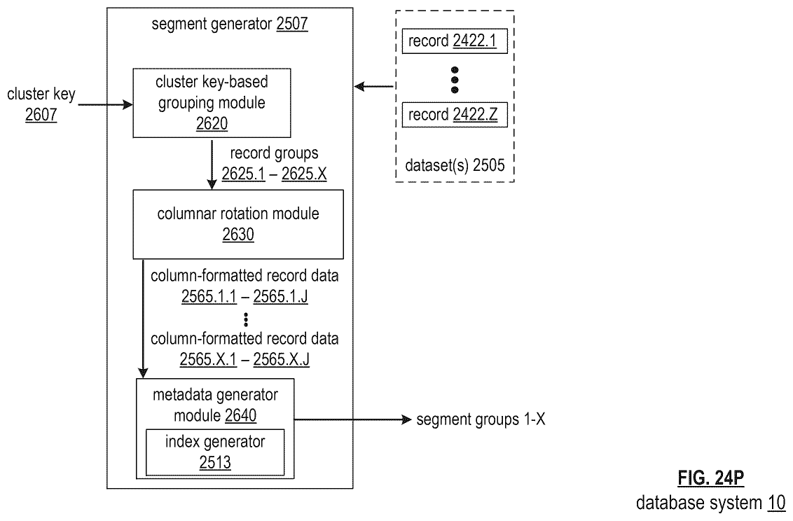

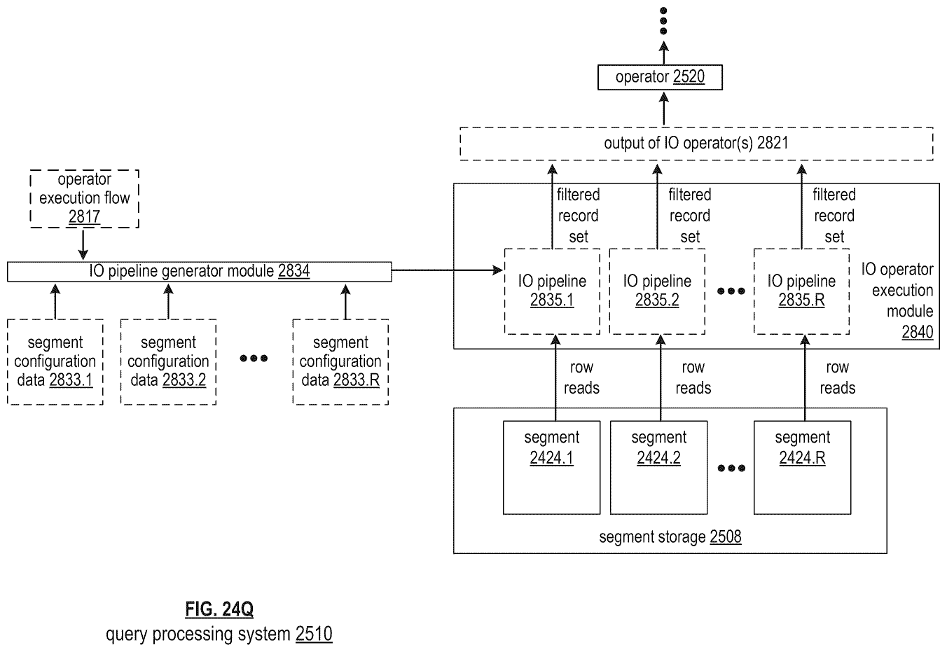

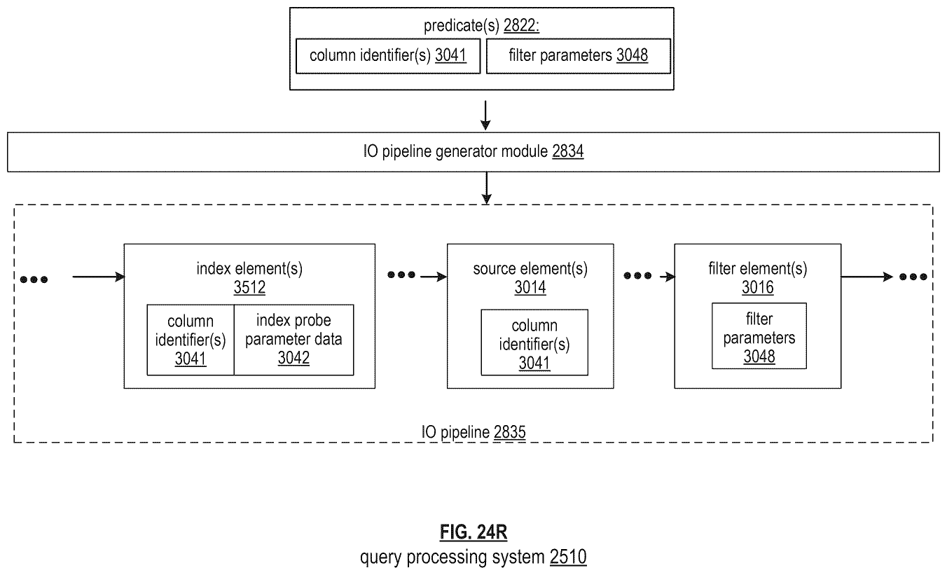

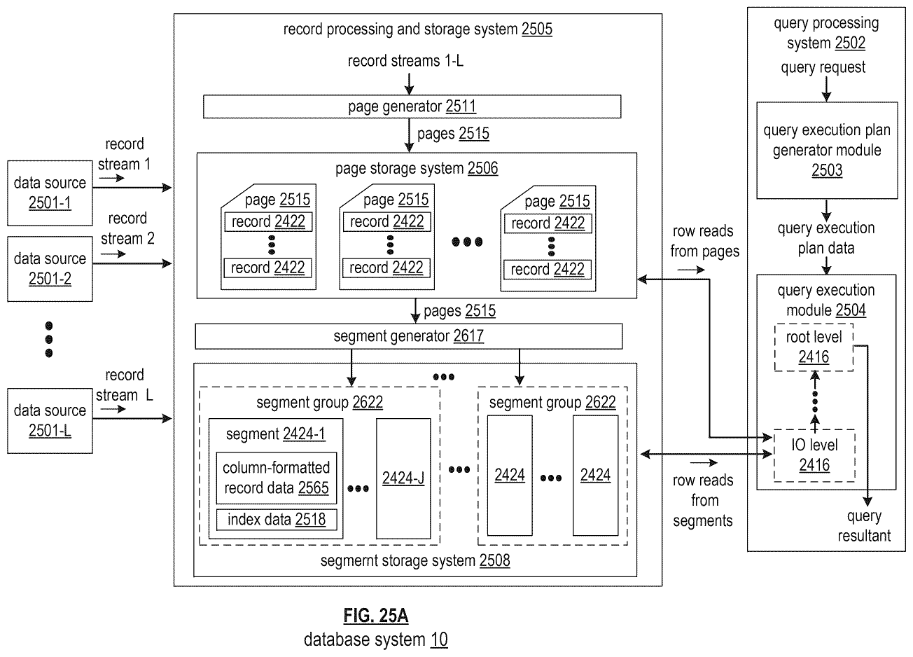

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set 35. In some cases, nodes 37 that do not store segments included in segment sets, that do not have access to stored segments, and/or that are not operable to perform row reads are not included at the IO level but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata, such as system metadata applied across a plurality of nodes 37, for example, where at least one node 37 participates in some or all features and/or functionality of FIG. 24A based on receiving and storing the system metadata in local memory of the at least one node 37 as configuration data, such as configuration data, and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata, such as system metadata, applied across a plurality of nodes 37 that includes the given node, for example, where the given node 37 participates in some or all features and/or functionality of FIG. 24B based on receiving and storing the system metadata in local memory of given node 37 as configuration data, and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata, such as system metadata, applied across a plurality of nodes 37 that includes the given node, for example, where the given node 37 participates in some or all features and/or functionality of FIG. 24C based on receiving and storing the system metadata in local memory of given node 37 as configuration data, and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata, such as system metadata, applied across a plurality of nodes 37 that includes the given node, for example, where the given node 37 participates in some or all features and/or functionality of FIG. 24D based on receiving and storing the system metadata in local memory of given node 37 as configuration data, and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node and can be nodes participating in the query execution plan of the given query and/or can be nodes that are not participating in the query execution plan of the given query.

Some or all features and/or functionality of FIG. 24E can be performed via at least one node 37 in conjunction with system metadata, such as system, applied across a plurality of nodes 37, for example, where at least one node 37 participates in some or all features and/or functionality of FIG. 24E based on receiving and storing the system metadata in local memory of the at least one node 37 as configuration data, and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2915. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2915 for execution via the database system 10, where the corresponding query resultant 2920 is transmitted back to the computing device, for example, for storage by the computing device and/or for display to the corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively, these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data, and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D . A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively, or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIGS. 24L-24M illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24L-24M can implement any embodiment of query execution module 2504 described herein and/or any performance of query execution described herein. Some or all features and/or functionality of column data streams 2968 of FIGS. 24L-24M can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24L, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24M, each data block 2537 of a given column data stream 2968 can include values 2918 for the respective column for one or more corresponding rows 2916. In the example of FIG. 24M, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively, or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple columns can be emitted in a same multi-column data stream.

FIG. 24N illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24N can implement the operator execution modules of FIG. 24J and/or can implement any query execution described herein. The data blocks 2537 can implement the data blocks of column streams of FIGS. 24L and/or 24M, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively, or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24O illustrates an embodiment of a database system 10 that implements a segment generator 2507 to generate segments 2424. Some or all features and/or functionality of the database system 10 of FIG. 24O can implement any embodiment of the database system 10 described herein. Some or all features and/or functionality of segments 2424 of FIG. 24O can implement any embodiment of segment 2424 described herein.

A plurality of records 2422.1-2422.Z of one or more datasets 2505 to be converted into segments can be processed to generate a corresponding plurality of segments 2424.1-2424. Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source or multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24P illustrates an example embodiment of a segment generator 2507 of database system 10. Some or all features and/or functionality of the database system 10 of FIG. 24P can implement any embodiment of the database system 10 described herein. Some or all features and/or functionality of the segment generator 2507 of FIG. 24P can implement the segment generator 2507 of FIG. 24O and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator 2517 as disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility Patent Application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility Patent Application for all purposes. For example, the database system 10 implements some or all features and/or functionality of record processing and storage system 2505 of. S. Utility application Ser. No. 16/985,723, U.S. Utility application Ser. No. 16/985,957, and/or U.S. Utility application Ser. No. 16/985,930.

FIG. 24Q illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24Q can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the columns slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24R illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths. These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24R can implement the IO pipeline 2835 and/or IO pipeline generator module 2834 of FIG. 24Q, and/or any embodiment of IO pipeline 2835, of IO pipeline generator module 2834, or of any query execution via accessing segments described herein.

In some embodiments, the IO pipeline generator module 2834, IO pipeline 2835, and/or IO operator execution module 2840 implements some or all features and/or functionality of the IO pipeline generator module 2834, IO pipeline 2835, and/or IO operator execution module 2840 as disclosed by: U.S. Utility application Ser. No. 17/303,437, entitled “QUERY EXECUTION UTILIZING PROBABILISTIC INDEXING”, filed May 28, 2021, which is hereby incorporated herein by reference in its entirety and made part of the present U.S. Utility Patent Application for all purposes. For example, the database system 10 can implement the indexing of segments 2424 and/or IO pipeline generation as execution for accessing segments 2424 during query execution via implementing some or all features and/or functionality as described in U.S. Utility application Ser. No. 17/303,437.

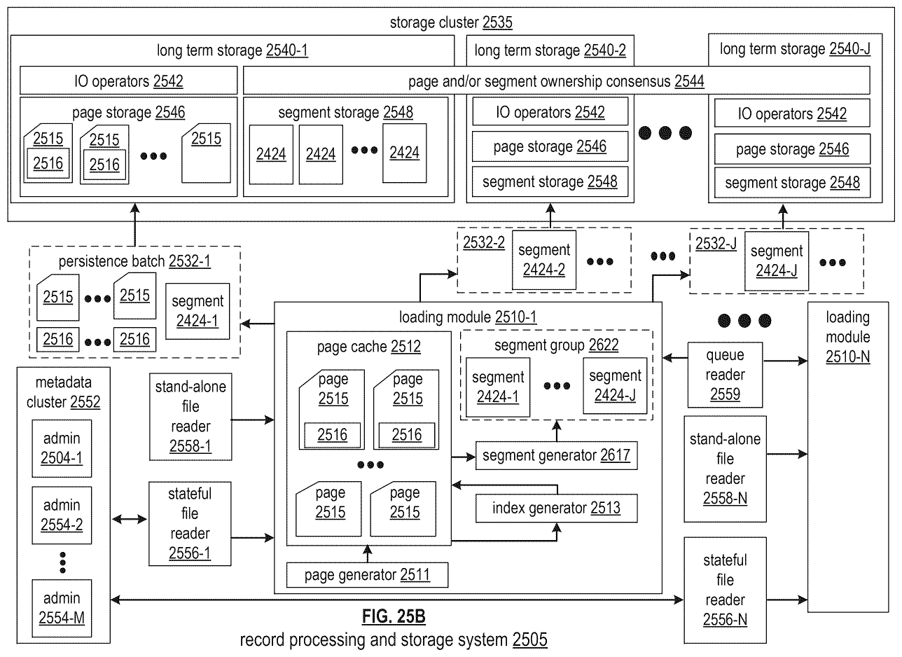

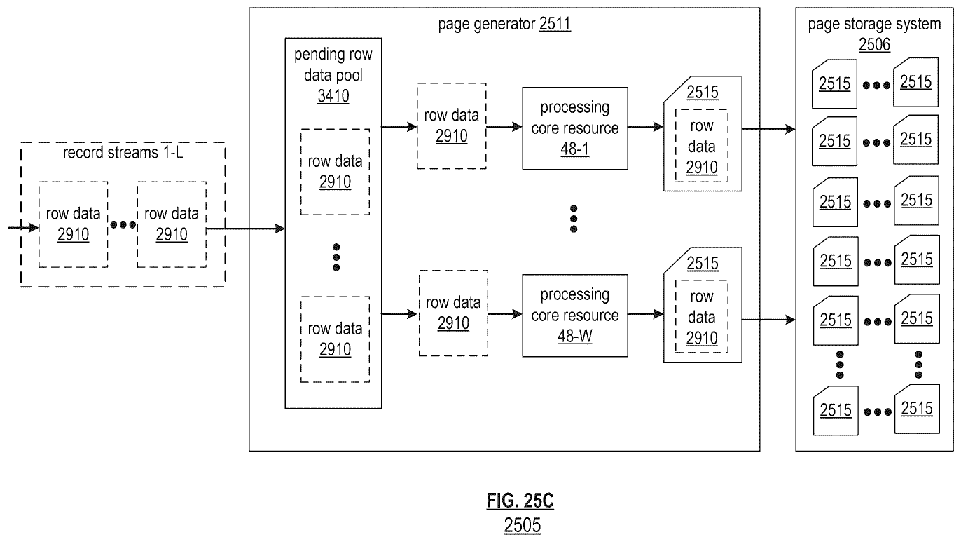

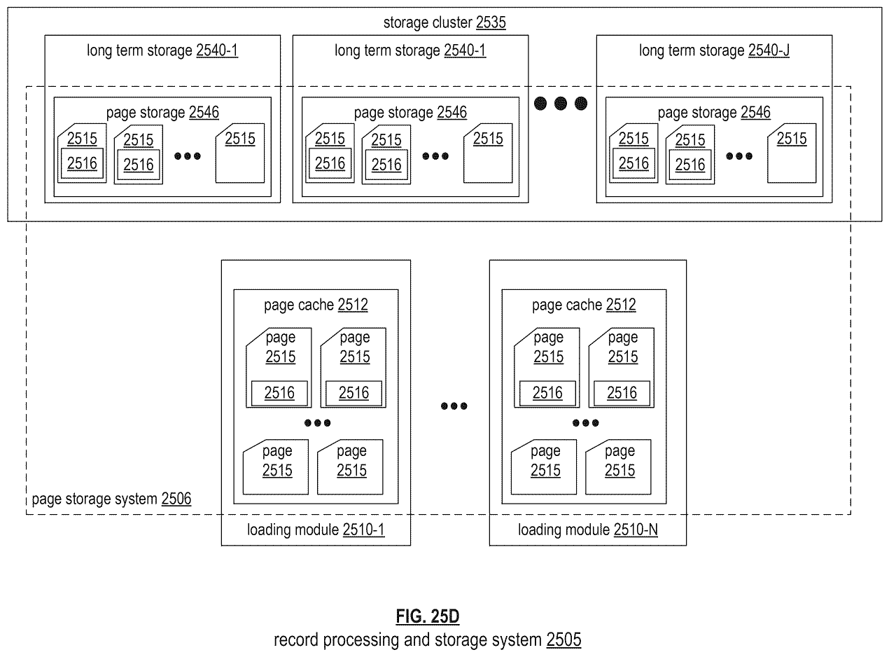

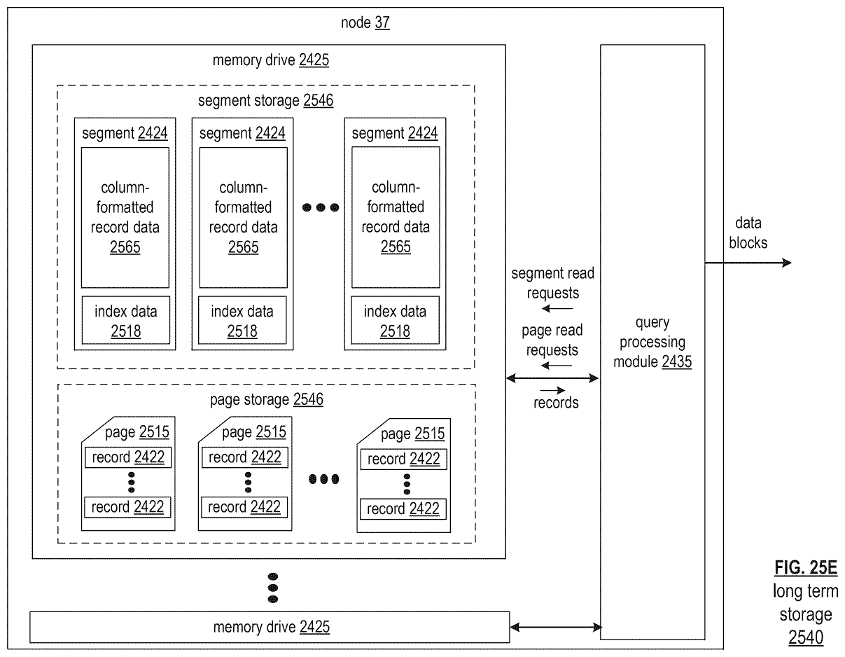

FIGS. 25A-25C illustrate embodiments of a database system 10 operable to execute queries indicating join expressions based on implementing corresponding join processes via one or more join operators. Some or all features and/or functionality of FIGS. 25A-25C can be utilized to implement the database system 10 of FIGS. 24A-24I when executing queries indicating join expressions. Some or all features and/or functionality of FIGS. 25A-25D can be utilized to implement any embodiment of the database system 10 described herein.

FIG. 25A illustrates an embodiment of a database system 10 that implements a record processing and storage system 2505. The record processing and storage system 2505 can be operable to generate and store the segments 2424 discussed previously by utilizing a segment generator 2617 to convert sets of row-formatted records 2422 into column-formatted record data 2565. These row-formatted records 2422 can correspond to rows of a database table with populated column values of the table, for example, where each record 2422 corresponds to a single row as illustrated in FIG. 15. For example, the segment generator 2617 can generate the segments 2424 in accordance with the process discussed in conjunction with FIGS. 15-23. The segments 2424 can be generated to include index data 2518, which can include a plurality of index sections such as the index sections 0-X illustrated in FIG. 23. The segments 2424 can optionally be generated to include other metadata, such as the manifest section and/or statistics section illustrated in FIG. 23.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 25A-25D. In particular, the segment storage system 2508 can be implemented by utilizing the memory drives 2425 of a plurality of IO level nodes 37 that are operable to store segments. As discussed previously, nodes 37 at the IO level 2416 can store segments 2424 in their memory drives 2425 as illustrated in FIG. 24C. These nodes can perform IO operations in accordance with query executions by reading rows from these segments 2424 and/or by recovering segments based on receiving segments from other nodes as illustrated in FIG. 24D. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 18, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t₁ gives no information about the cluster key value of a row received at a second time t₂ after t₁. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 25C. Each page 2515 generated by the page generator 2511 can include a set of records, for example, in their original row format and/or in a data format as received from data sources 2501-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

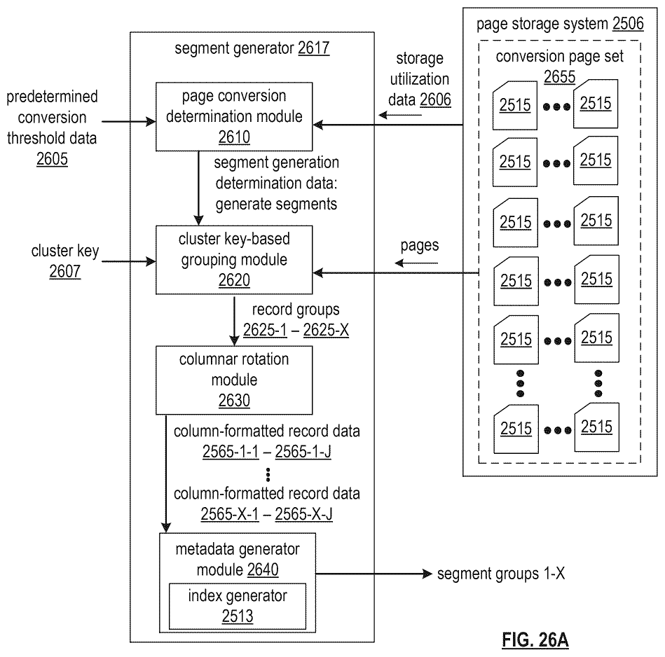

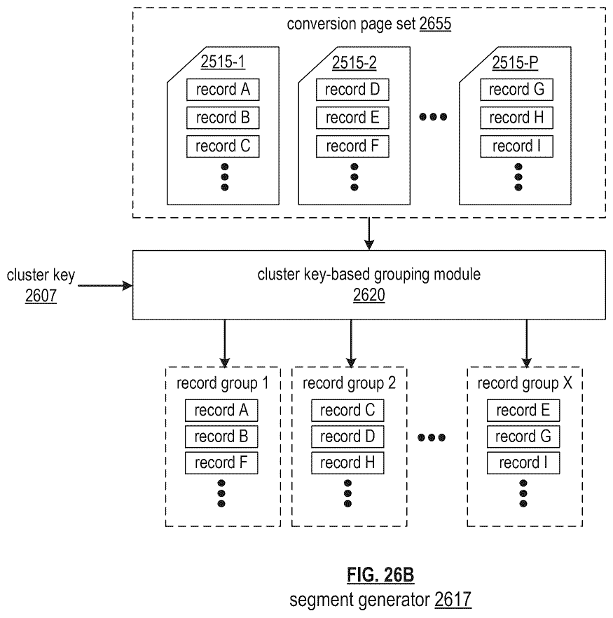

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering, For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Determining when to generate segments such that the conversion from pages into segments is delayed as long as possible, and/or such that a sufficient amount of records are converted all at once to induce more favorable levels of cluster, is discussed in further detail in conjunction with FIGS. 26A-26D. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2617 upon all stored pages all at once, where the page generator 2511 does not perform any stages of the clustering process.

In some embodiments, to further reduce the processing induced upon the record processing and storage system 2505 during this data ingress, incoming record data of data streams 1-L undergo minimal reformatting by the page generator 2511 in generating pages 2515. In some cases, the incoming data of record streams 1-L is not reformatted and is simply “placed” into a corresponding page 2515. For example, a set of records are included in given page in accordance with formatted row data received from data sources.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 25A, a query processing system 2502 can implement a query execution plan generator module 2503 to generate query execution plan data based on a received query request. The query execution plan data can be relayed to nodes participating in the corresponding query execution plan 2405 indicated by the query execution plan data, for example, as discussed in conjunction with FIG. 24A. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424 as discussed previously and as illustrated in FIG. 24C. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 25E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2617 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2617, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

In some embodiments, one or more nodes 37 of the database system 10 as discussed herein can be operable to perform multiple functionalities of the database system 10 illustrated in FIG. 25A. For example, a single node can be utilized to implement the page generator 2511, the page storage system 2506, the segment generator 2617, the segment storage system 2508, the query execution plan generator module, and/or the query execution module 2504 as a node 37 at one or more levels 2410 of a query execution plan 2405. In particular, the single node can utilize different processing core resources 48 to implement different functionalities in parallel, and/or can utilize the same processing core resources 48 to implement different functionalities at different times.

Some or all data sources 2501 can implemented utilizing at least one processor and at least one memory. Some or all data sources 2501 can be external from database system 10 and/or can be included as part of database system 10. For example, the at least one memory of a data source 2501 can store operational instructions that, when executed by the at least one processor of the data source 2501, cause the data source 2501 to perform some or all of the functionality of data sources 2501 described herein. In some cases, data sources 2501 can receive application data from the database system 10 for download, storage, and/or installation. Execution of the stored application data by processing modules of data sources 2501 can cause the data sources 2501 to execute some or all of the functionality of data sources 2501 discussed herein.

In some embodiments, system communication resources 14, external network(s) 17, local communication resources 25, wide area networks 22, and/or other communication resources of database system 10 can be utilized to facilitate any transfer of data by the record processing and storage system 2505. This can include, for example: transmission of record streams 1-L from data sources 2501 to the record processing and storage system 2505; transfer of pages 2515 to page storage system 2506 once generated by the page generator 2511; access to pages 2515 by the segment generator 2617; transfer of segments 2424 to the segment storage system 2508 once generated by the segment generator 2617; communication of query execution plan data to the query execution module 2504, such as the plurality of nodes 37 of the corresponding query execution plan 2405; reading of records by the query execution module 2504, such as IO level nodes 37, via access to pages 2515 stored page storage system 2506 and/or via access to segments 2424 stored segment storage system 2508; sending of data blocks generated by nodes 37 of the corresponding query execution plan 2405 to other nodes 37 in conjunction with their execution of the query; and/or any other accessing of data, communication of data, and/or transfer of data by record processing and storage system 2505 and/or within the record processing and storage system 2505 as discussed herein.

The record processing and storage system 2505 and/or the query processing system 2502 of FIG. 25A, and/or any other embodiment of record processing and storage system 2505 and/or the query processing system 2502 described herein, can be implemented at a massive scale, for example, by being implemented by a database system 10 that is operable to receive, store, and perform queries against a massive number of records of one or more datasets, such as millions, billions, and/or trillions of records stored as many Terabytes, Petabytes, and/or Exabytes of data as discussed previously. In particular, the record processing and storage system 2505 and/or the query processing system 2502 can each be implemented by a large number, such as hundreds, thousands, and/or millions of computing devices 18, nodes 37, and/or processing core resources 48 that perform independent processes in parallel, for example, with minimal or no coordination, to implement some or all of the features and/or functionality of the record processing and storage system 2505 and/or the query processing system 2502 at a massive scale.

Some or all functionality performed by the record processing and storage system 2505 and/or the query processing system 2502 as described herein cannot practically be performed by the human mind, particularly when the database system 10 is implemented to store and perform queries against records at a massive scale as discussed previously. In particular, the human mind is not equipped to perform record processing, record storage, and/or query execution for millions, billions, and/or trillions of records stored as many Terabytes, Petabytes, and/or Exabytes of data. Furthermore, the human mind is not equipped to distribute and perform record processing, record storage, and/or query execution as multiple independent processes, such as hundreds, thousands, and/or millions of independent processes, in parallel and/or within overlapping time spans.

Some or all features and/or functionality of FIG. 25A can be performed via at least one node 37 in conjunction with system metadata applied across a plurality of nodes 37, for example, where at least one node 37 participates in some or all features and/or functionality of FIG. 25A based on receiving and storing the system metadata in local memory of the at least one node 37 as configuration data, and/or based on further accessing and/or executing this configuration data to implement some or all functionality of the record processing storage system and/or to implement some or all functionality of the query processing system as part of its database functionality accordingly. Performance of some or all features and/or functionality of FIG. 25A can optionally change and/or be updated over time, and/or a set of nodes participating in executing some or all features and/or functionality of FIG. 25A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25B illustrates an example embodiment of the record processing and storage system 2505 of FIG. 25A. Some or all of the features illustrated and discussed in conjunction with the record processing and storage system 2505 FIG. 25B can be utilized to implement the record processing and storage system 2505 and/or any other embodiment of the record processing and storage system 2505 described herein.

The record processing and storage system 2505 can include a plurality of loading modules 2510-1-2510-N. Each loading module 2510 can be implemented via its own processing and/or memory resources. For example, each loading module 2510 can be implemented via its own computing device 18, via its own node 37, and/or via its own processing core resource 48. The plurality of loading modules 2510-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each loading modules 2510 to receive one or more of the record streams 1-L received from the data sources 2501-1-2501-L as illustrated in FIG. 25A. For example, each loading module 2510 receives a distinct subset of the entire set of records received by the record processing and storage system 2505 at a given time.

Each loading module 2510 can receive records 2422 in one or more record streams via its own stateful file reader 2556 and/or stand-alone file reader 2558. Each loading module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given loading module 2510 is implemented via its own computing device 18 and/or node 37, the same computing device 18 and/or node 37 can optionally be utilized to implement the stateful file reader 2556, and/or each stand-alone file reader 2558 communicating with the given loading module 2510.

Each loading module 2510 can implement its own page generator 2511, its own index generator 2513, and/or its own segment generator 2617, for example, by utilizing its own processing and/or memory resources such as the processing and/or memory resources of a corresponding computing device 18. For example, the page generator 2511 of FIG. 25A can be implemented as a plurality of page generators 2511 of a corresponding plurality of loading modules 2510 as illustrated in FIG. 25B. Each page generator 2511 of FIG. 25B can process its own incoming records 2422 to generate its own corresponding pages 2515.

As pages 2515 are generated by the page generator 2511 of a loading module 2510, they can be stored in a page cache 2512. The page cache 2512 can be implemented utilizing memory resources of the loading module 2510, such as memory resources of the corresponding computing device 18. For example, the page cache 2512 of each loading module 2010-1-2010-N can individually or collectively implement some or all of the page storage system 2506 of FIG. 25A.

The segment generator 2617 of FIG. 25A can similarly be implemented as a plurality of segment generators 2617 of a corresponding plurality of loading modules 2510 as illustrated in FIG. 25B. Each segment generator 2617 of FIG. 25B can generate its own set of segments 2424-1-2424-J included in one or more segment groups 2622. The segment group 2622 can be implemented as the segment group of FIG. 23, for example, where J is equal to five or another number of segments configured to be included in a segment group. In particular, J can be based on the redundancy storage encoding scheme utilized to generate the set of segments and/or to generate the corresponding parity data 2426.

The segment generator 2617 of a loading module 2510 can access the page cache 2512 of the loading module 2510 to convert the pages 2515 previously generated by the page generator 2511 into segments. In some cases, each segment generator 2617 requires access to all pages 2515 generated by the segment generator 2617 since the last conversion process of pages into segments. The page cache 2512 can optionally store all pages generated by the page generator 2511 since the last conversion process, where the segment generator 2617 accesses all of these pages generated since the last conversion process to cluster records into groups and generate segments. For example, the page cache 2512 is implemented as a write-through cache to enable all previously generated pages since the last conversion process to be accessed by the segment generator 2617 once the conversion process commences.

In some cases, each loading module 2510 implements its segment generator 2617 upon only the set of pages 2515 that were generated by its own page generator 2511, accessible via its own page cache 2512. In such cases, the record grouping via clustering key to create segments with the same or similar cluster keys are separately performed by each segment generator 2617 independently without coordination, where this record grouping via clustering key is performed on N distinct sets of records stored in the N distinct sets of pages generated by the N distinct page generators 2511 of the N distinct loading modules 2510. In such cases, despite records never being shared between loading modules 2510 to further improve clustering, the level of clustering of the resulting segments generated independently by each loading module 2510 on its own data is sufficient, for example, due to the number of records in each loading module's 2510 set of pages 2515 for conversion being sufficiently large to attain favorable levels of clustering.

In such embodiments, each loading modules 2510 can independently initiate its own conversion process of pages 2515 into segments 2424 by waiting as long as possible based on its own resource utilization, such as memory availability of its page cache 2512. Different segment generators 2617 of the different loading modules 2510 can thus perform their own conversion of the corresponding set of pages 2515 into segments 2424 at different times, based on when each loading modules 2510 independently determines to initiate the conversion process, for example, based on each independently making the determination to generate segments as discussed in conjunction with FIG. 26A. Thus, as discussed herein, the conversion process of pages into segments can correspond to a single loading module 2510 converting all of its pages 2515 generated by its own page generator 2511 since its own last the conversion process into segments 2424, where different loading modules 2510 can initiate and execute this conversion process at different times and/or with different frequency.

In other cases, it is ideal for even more favorable levels of clustering to be attained via sharing of all pages for conversion across all loading modules 2510. In such cases, a collective decision to initiate the conversion process can be made across some or all loading modules 2510, for example, based on resource utilization across all loading modules 2510. The conversion process can include sharing of and/or access to all pages 2515 generated via the process, where each segment generator 2617 accesses records in some or all pages 2515 generated by and/or stored by some or all other loading modules 2510 to perform the record grouping by cluster key. As the full set of records is utilized for this clustering instead of N distinct sets of records, the levels of clustering in resulting segments can be further improved in such embodiments. This improved level of clustering can offset the increased page movement and coordination required to facilitate page access across multiple loading modules 2510. As discussed herein, the conversion process of pages into segments can optionally correspond to multiple loading modules 2510 converting all of their collectively generated pages 2515 since their last conversion process into segments 2424 via sharing of their generated pages 2515.

An index generator 2513 can optionally be implemented by some or all loading modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 23. As another example, the index data 2516 can include indexing information utilized to determine the memory location of particular records and/or particular columns within the corresponding page 2515.

In some cases, the index data 2516 can be generated to enable corresponding pages 2515 to be processed by query IO operators utilized to read rows from pages, for example, in a same or similar fashion as index data 2518 is utilized to read rows from segments. In some cases, index probing operations can be utilized by and/or integrated within query IO operators to filter the set of rows returned in reading a page 2515 based on its index data 2516 and/or to filter the set of rows returned in reading a segment 2424 based on its index data 2518.

In some cases, index data 2516 is generated by index generator 2513 for all pages 2515, for example, as each page 2515 is generated, or at some point after each page 2515 is generated. In other cases, index data 2516 is only generated for some pages 2515, for example, where some pages do not have index data 2516 as illustrated in FIG. 25B. For example, some pages 2515 may never have corresponding index data 2516 generated prior to their conversion into segments. In some cases, index data 2516 is generated for a given page 2515 with its records are to be read in execution of a query by the query processing system 2502. For example, a node 37 at IO level 2416 can be implemented as a loading module 2510 and can utilize its index generator 2513 to generate index data 2516 for a particular page 2515 in response to having query execution plan data indicating that records 2422 be read the particular page from the page cache 2512 of the loading module in conjunction with execution of a query. The index data 2516 can be optionally stored temporarily for the life of the given query to facilitate reading of rows from the corresponding page for the given query only. The index data 2516 alternatively be stored as metadata of the page 2515 once generated, as illustrated in FIG. 25B. This enables the previously generated index data 2516 of a given page to be utilized in subsequent queries requiring reads from the given page.

As illustrated in FIG. 25B, each loading modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from loading modules 2510 to storage cluster 2535 and/or to facilitate sending of data from storage cluster 2535 to loading modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1 37-J. In some cases, each storage cluster 35-1-35-z of FIG. 6 can receive pages 2515, corresponding index data 2516, and/or segments 2424 from its own set of loading modules 2510-1-2510-N, where the record processing and storage system 2505 of FIG. 25B can include z sets of loading modules 2510-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the loading modules 2510. Alternatively, some loading modules can optionally share processing and/or memory resources long term storage 2540, for example, where a same computing device 18 and/or a same node 37 implements a particular long term storage 2540 and also implements a particular loading modules 2510.

Each loading module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a loading module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure as illustrated in FIG. 24D, where the value K of FIG. 24D is less than the value J and wherein the nodes 37 of FIG. 24D are utilized to implement the long term storage 2540-1-2540-J.

As illustrated in FIG. 25B, each persistence batch 2532-1-2532-J can optionally or additionally include pages 2515 and/or their corresponding index data 2516 generated via index generator 2513. Some or all pages 2515 that are generated via a loading module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2617. Some or all pages 2515 can be stored by storage cluster 2535 until corresponding segments 2424 are generated, where storage cluster 2535 facilitates deletion of these pages from storage in one or more long term storage 2540-1 -2540-J once these pages are converted and/or have their records 2422 successfully stored by storage cluster 2535 in segments 2424.

In some cases, a loading module 2510 maintains storage of pages 2515 via page cache 2512, even if they are sent to storage cluster 2535 in persistence batches 2532. This can enable the segment generator 2617 to efficiently read pages 2515 during the conversion process via reads from this local page cache 2512. This can be ideal in minimizing page movement, as pages do not need to be retrieved from long term storage 2540 for conversion into segments by loading modules 2510 and can instead be locally accessed via maintained storage in page cache 2512. Alternatively, a loading module 2510 removes pages 2515 from storage via page cache 2512 once they are determined to be successfully stored in long term storage 2540. This can be ideal in reducing the memory resources required by loading module 2510 to store pages, as only pages that are not yet durably stored in long term storage 2540 need be stored in page cache 2512.

Each long term storage 2540 can include its own page storage 2546 that stores received pages 2515 generated by and received from one or more loading modules 2010-1-2010-N, implemented utilizing memory resources of the long term storage 2540. For example, the page storage 2546 of each long term storage 2540-1-2540-J can individually or collectively implement some or all of the page storage system 2506 of FIG. 25A. The page storage 2546 can optionally store index data 2516 mapped to and/or included as metadata of its pages 2515. Each long term storage 2540 can alternatively or additionally include its own segment storage 2548 that stores segments generated by and received from one or more loading modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 25B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the loading module 2510 that generated the given page 2515 and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a loading module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and/or segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and/or segment ownership consensus 2544 can include one or more versions of ownership data, for example, that is generated via execution of a consensus protocol mediated via the set of long term storage 2540-1-2540-J. The page and/or segment ownership consensus 2544 can dictate that every record is owned by exactly one long term storage 2540 via access to either a page 2515 storing the record or a segment 2424 storing the record, but not both. The page and/or segment ownership consensus 2544 can indicate, for each long tern storage 2540 in the storage cluster 2535, whether some or all of its pages 2515 or some or all of its segments 2424 are to be accessed in query executions, where each long tern storage 2540 only accesses the pages 2515 and segments 2424 indicated in page and/or segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and/or segment ownership consensus 2544. For example, the long term storage 2540 can be solely responsible for durably storing the records utilized in query executions. In such embodiments, the cached and/or temporary storage of pages and/or segments of loading modules 2510, such as pages 2515 in page caches 2512, are not read for query executions via accesses to storage resources of loading modules 2510.

Some or all features and/or functionality of FIG. 25B can be performed via at least one node 37 in conjunction with system metadata applied across a plurality of nodes 37, for example, where at least one node 37 participates in some or all features and/or functionality of FIG. 25B based on receiving and storing the system metadata in local memory of the at least one node 37 as configuration data, and/or based on further accessing and/or executing this configuration data to implement some or all functionality of a loading module 2510, to implement some or all functionality of a file reader, and/or to implement some or all functionality of the storage cluster 2535 as part of its database functionality accordingly. Performance of some or all features and/or functionality of FIG. 25B can optionally change and/or be updated over time, and/or a set of nodes participating in executing some or all features and/or functionality of FIG. 25B can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25C illustrates an example embodiment of a page generator 2511. The page generator 2511 of FIG. 25C can be utilized to implement the page generator 2511 of FIG. 25A, can be utilized to implement each page generator 2511 of each loading module 2510 of FIG. 25B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively, each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a loading module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each loading module 2510 can have its own pending row data pool 3410. Alternatively, multiple loading modules 2510 can access the same pending row data pool 3410 that stores all incoming row data 2910, for example, by utilizing queue reader 2559.

The page generator 2511 can facilitate parallelized page generation via a plurality of processing core resources 48-1-48-W. For example, each loading module 2510 has its own plurality of processing core resources 48-1-48-W, where the processing core resources 48-1-48-W of a given loading module 2510 is implemented via the set of processing core resources 48 of one or more nodes 37 utilized to implement the given loading module 2510. As another example, the plurality of processing core resources 48-1-48-W are each implemented by a corresponding one of the set of each loading module 2510-1-2510-N, for example, where each loading module 2510-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received over time. As illustrated in FIG. 25C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time and can append each row data 2910 to a given page until the page 2515 is complete, where the processing core resource 48 appends subsequently retrieved row data 2910 to a new page. Alternatively, the processing core resource 48 can retrieve multiple row data 2910 at once and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding loading module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

Some or all features and/or functionality of FIG. 25C can be performed via at least one node 37 in conjunction with system metadata applied across a plurality of nodes 37, for example, where at least one node 37 participates in some or all features and/or functionality of FIG. 25C based on receiving and storing the system metadata in local memory of the at least one node 37 as configuration data, and/or based on further accessing and/or executing this configuration data to implement some or all functionality of a loading module 2510, to implement some or all functionality of page generator 2511 and/or page storage system 2506 as part of its database functionality accordingly. Performance of some or all features and/or functionality of FIG. 25C can optionally change and/or be updated over time, and/or a set of nodes participating in executing some or all features and/or functionality of FIG. 25C can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25D illustrates an example embodiment of the page storage system 2506. As used herein, the page storage system 2506 can include page cache 2512 of a single loading module 2510; can include page caches 2512 of some or all loading module 2510-1-2510-N; can include page storage 2546 of a single long term storage 2540 of a storage cluster 2535; can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

Some or all features and/or functionality of FIG. 25D can be performed via at least one node 37 in conjunction with system metadata, such as system metadata applied across a plurality of nodes 37, for example, where at least one node 37 participates in some or all features and/or functionality of FIG. 25D based on receiving and storing the system metadata in local memory of the at least one node 37 as configuration data and/or based on further accessing and/or executing this configuration data to implement some or all functionality of a loading module 2510 and/or a given long term storage 2540 as part of its database functionality accordingly. Performance of some or all features and/or functionality of FIG. 25D can optionally change and/or be updated over time, and/or a set of nodes participating in executing some or all features and/or functionality of FIG. 25D can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25E illustrates an example embodiment of a node 37 utilized to implement a given long term storage 2540 of FIG. 25B. The node 37 of FIG. 25E can be utilized to implement the node 37 of FIG. 25B, FIGS. 25C, 25D, some or all nodes 37 at the IO level 2416 of a query execution plan 2405 of FIG. 24A, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and/or segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

Some or all features and/or functionality of FIG. 25E can be performed a given node 37 in conjunction with system metadata applied across a plurality of nodes 37, for example, where the given node 37 performs some or all features and/or functionality of FIG. 25E based on receiving and storing the system metadata in local memory of the at least one node 37 as configuration data and/or based on further accessing and/or executing this configuration data to implement some or all functionality of the given node 37 of FIG. 25E as part of its database functionality accordingly. Performance of some or all features and/or functionality of FIG. 25E can optionally change and/or be updated over time based on the system metadata applied across the plurality of nodes 37 being updated over time and/or based on nodes on updating their configuration data stored in local memory to reflect changes in the system metadata based on receiving data indicating these changes to the system metadata.

FIG. 26A illustrates an example embodiment of a segment generator 2617. The segment generator 2617 of FIG. 26A can be utilized to implement the segment generator 2617 of FIG. 25A, can be utilized to implement each segment generator 2617 of each loading module 2510 of FIG. 25B, and/or can be utilized to implement any embodiments of segment generator 2617 described herein.

As discussed previously, the record processing and storage system 2505 can be operable to delay the conversion of pages into segments. Rather than frequently clustering rows and converting rows into column format, movement and/or processing of rows can be minimized by delaying the clustering and conversion process required to generate segments 2424, for example, as long as possible. This delaying of the conversion process “as long as possible” can be bounded by resource availability, such as disk and/or memory capacity of the record processing and storage system 2505. In particular, the conversion process can be delayed to accumulate as many pages in the page storage system 2506 that page storage system 2506 is capable of storing.

Maximizing the delay until pages are processed as enabled by storage resources of the record processing and storage system 2505 improves the technology of database systems by improving query efficiency. In particular, delaying the decision of which rows to group together into segments as long as possible increased the chances of having many records with common cluster keys to group together, as cluster key-based groups are formed from a largest possible set of records. These more favorable levels of clustering enable queries to be performed more efficiently as discussed previously. For example, rows that need be accessed in a given query as dictated by filtering parameters of the query are more likely to be stored together, and fewer segments and/or memory locations need to be accessed.

Maximizing the delay until pages are processed as enabled by storage resources of the record processing and storage system 2505 improves the technology of database systems by improving data ingress efficiency. By placing rows directly into pages without regard for clustering as they are received, this delayed approach minimizes the number of times a row “moves” through the system, such as from disk, to memory, and/or through the processor. In particular, by delaying all clustering until segment generation for the received rows all at once, the rows are moved exactly once, to their final resting place as a segment 2424. This conserves resources of the record processing and storage system 2505, enabling higher rates of records to be received and processed for storage via data sources 2501 and thus enabling a richer, denser database to be generated over time. For example, this can enable the record processing and storage system 2505 to effectively process incoming records at a scale of terabits per second.

This delay can be accomplished via a page conversion determination module 2610 implemented by the segment generator 2617 and/or implemented via other processing resources of the record processing and storage system 2505. The page conversion determination module 2610 can be utilized to generate segment generation determination data indicating whether the conversion process of pages into segments should be commenced at a given time. For example, the page conversion determination module 2610 generates an interrupt or notification that includes the generate segment generation determination data indicating it is time to generate segments based on determining to generate segments at the given time. The page conversion determination module 2610 can otherwise trigger the commencement of converting pages into segments once it deems the conversion process appropriate, for example, based on delaying as long as possible. The segment generator 2617 can commence the conversion process accordingly in response to the segment generation determination data indicating it is time to generate segments, for example, via a cluster key-based grouping module 2620, a columnar rotation module 2630, and/or a metadata generator module 2640.

In some cases, the page conversion determination module 2610 optionally generates some segment generation determination data indicating it is not yet time to generate segments. In some embodiments, this information may not be communicated if it is determined that is not yet time to generate segments, where only notifications instructing the conversion process be commenced is communicated to initiate the process via cluster key-based grouping module 2620, a columnar rotation module 2630, and/or a metadata generator module 2640.

The page conversion determination module 2610 can generate segment generation determination data: in predetermined intervals; in accordance with a schedule; in response to determining a new page has been generated and stored in page storage system 2506; in response determining at least a threshold number of new pages have been generated and stored in page storage system 2506; in response to determining the storage space and/or memory utilization of page storage system 2506 has changed; in response to determining the total storage capacity of page storage system 2506 has changed; in response to determining at least one memory drive of the page storage system 2506 has failed or gone offline; in response to receiving storage utilization data from page storage system 2506; based on instruction supplied via user input, for example, via administration sub-system 15 and/or configuration sub-system 16; based on receiving a request; and/or based on another determination.

The page conversion determination module 2610 can generate its segment generation determination data based on comparing storage utilization data 2606 to predetermined conversion threshold data 2605. The storage utilization data can optionally be generated by the page storage system 2506. The record processing and storage system 2505 can indicate and/or be based on one or more storage utilization metrics indicating: an amount and/or percentage of storage resources of the page storage system 2506 that are currently being utilized to store pages 2515; an amount and/or percentage of available resources of the page storage system 2506 that are not currently being utilized to store pages 2515; a number of pages 2515 currently stored by the page storage system 2506; a data size, such as a number of bytes, of the set of pages 2515 currently stored by the page storage system 2506; an expected amount of time until storage resources of the page storage system 2506 are expected to become fully utilized for page storage based on current and/or historical data rates of record streams 1-L; current health data and/or failure data of storage resources of the page storage system 2506; an amount of time since the last conversion process was initiated and/or was completed; and/or other information regarding the storage utilization of the page storage system 2506.

In some cases, the storage utilization data 2606 can relate specifically to storage utilization of a page cache 2512 of a loading module 2510 of FIG. 25B, where the segment generator 2617 of FIG. 26A is implemented by the corresponding loading module 2510 and where the segment generator 2617 of FIG. 26A is operable to perform the conversion process only upon pages 2515 in the page cache 2512. In some cases, the storage utilization data 2606 can relate specifically to storage utilization across all page caches 2512 of all loading modules 2510-1-2510-N, where the page conversion determination module 2610 of FIG. 26A is implemented to dictate whether the conversion process be commenced across all corresponding loading modules 2510. In some cases, the storage utilization data 2606 can alternatively or additionally include storage utilization of page storage 2546 of one or more of the long term storage 2540-1-2540-J of FIG. 25B. The storage utilization data 2606 can relate to any combination of storage resources of page storage system 2506 as discussed in conjunction with FIG. 25D that are utilized to store a particular set of pages to be converted into segments in tandem via the conversion process performed by segment generator 2617.

The storage utilization data 2606 can be sent to and/or requested by the segment generator 2617: in predefined intervals; in accordance with scheduling data; based on the page conversion determination module 2610 determining to generate the segment generation determination data; based on a determination, notification, and/or instruction that the page conversion determination module 2610 should generate the segment generation determination data; and/or based on another determination. In some cases, some or all of the page conversion determination module 2610 is implemented via processing resources and/or memory resources of the page storage system 2506, for example, to enable the page conversion determination module 2610 to monitor and/or measure the storage utilization data 2606 of its own resources included in page storage system 2506.

The predetermined conversion threshold data 2605 can indicate one or more threshold metrics or other threshold conditions that, when met by one or more corresponding metrics of the storage utilization data 2606 at a given time, trigger the commencement of the conversion process. In particular, the page conversion determination module generates the segment generation determination data indicating that segments be generated when the at least one metric of the storage utilization data 2606 meets the threshold metrics and/or conditions of the predetermined conversion threshold data 2605 and/or otherwise compares favorably to a condition for page conversion indicated by the predetermined conversion threshold data 2605. If the none of the metrics of the storage utilization data 2606 compare favorably to corresponding threshold metrics of predetermined conversion threshold data 2605, the page conversion determination module generates the segment generation determination data indicating that segments not be generated at this time, or otherwise does not generate the segment generation determination data in this case as no instruction to commence conversion need be communicated.

In some cases, the page conversion determination module generates the segment generation determination data indicating that segments be generated only when at least a predetermined threshold number of metrics of the storage utilization data 2606 compare favorably to the corresponding threshold metrics of the predetermined conversion threshold data 2605. In such cases, if less than the predetermined threshold number of metrics of the storage utilization data 2606 compare favorably to corresponding threshold metrics of predetermined conversion threshold data 2605, the page conversion determination module generates the segment generation determination data indicating that segments not be generated at this time, or otherwise does not generate the segment generation determination data in this case as no instruction to commence conversion need be communicated.

In some cases, there is only one metric in the storage utilization data 2606 that is compared to a corresponding metric of the predetermined conversion threshold data 2605, and the page conversion determination module generates the segment generation determination data when the metric in the storage utilization data 2606 meets or otherwise compares favorably to the corresponding metric of the predetermined conversion threshold data 2605.

As used herein, the storage utilization data 2606 compares favorably to the predetermined conversion threshold data 2605 when the conditions indicated in the predetermined conversion threshold data 2605 that dictate the conversion process be initiated are met by corresponding metrics of the storage utilization data 2606. As used herein, the storage utilization data 2606 compares unfavorably to the predetermined conversion threshold data 2605 when the conditions indicated in the predetermined conversion threshold data 2605 that dictate the conversion process be initiated are not met by corresponding metrics of the storage utilization data 2606. In some embodiments, the page conversion determination module 2610 generates the segment generation determination data indicating that segments be generated and/or otherwise indicating that the conversion process be initiated only when the storage utilization data 2606 compares favorably to the predetermined conversion threshold data 2605.

The predetermined conversion threshold data 2605 can indicate one or more conditions that trigger the conversion process such as: a total memory capacity of page storage system 2506; a threshold maximum amount and/or percentage of storage resources of the page storage system 2506 that can be utilized to store pages 2515; a threshold minimum amount and/or percentage of resources page storage system that must remain available; a threshold minimum number of pages 2515 that must be included in the set of pages for conversion; a threshold maximum number of pages 2515 that can be converted in a single conversion process; a threshold maximum and/or threshold a data size of the set of pages that can be converted in a single conversion process; a threshold minimum amount of time that storage resources of the page storage system can be expected to become fully utilized for page storage based on current and/or historical data rates of record streams 1-L; threshold requirements for health data and/or failure data of storage resources of the page storage system 2506; a threshold minimum and/or threshold maximum amount of time at which a new conversion process must commence since the last conversion process was initiated and/or was completed; and/or other information regarding the requirements and/or conditions for initiation of the conversion process.

The predetermined conversion threshold data 2605 can be received and/or configured based on user input, for example, via administrative sub-system 15 and/or via configuration sub-system 16. The predetermined conversion threshold data 2605 can alternatively or additionally be determined automatically by the record processing and storage system 2505. For example, the predetermined conversion threshold data 2605 can be determined automatically to indicate and/or be based on determining a threshold memory capacity of the page storage system 2506; based on determining a threshold amount of bytes worth of pages 2515 the page storage system 2506 can store; and/or based on determining a threshold expected and/or average amount of time that pages can be generated and stored in the page storage system 2506 by the page generator 2511 until the page storage system 2506 becomes full. Note that these thresholds can be automatically buffered to account for a threshold percentage of drive failures, a historical expected rate of drive failures, a threshold amount of additional pages data that may be stored in communication lag since the storage utilization data 2606 was sent, a threshold amount of additional pages data that may be stored in processing lag to perform some or all of the conversion process, and/or other buffering to ensure that segment generation is completed before page storage system 2506 reaches its capacity.

As another example, the predetermined conversion threshold data 2605 can be determined automatically based on determining a sufficient number of records 2422 and/or a sufficient number of pages 2515 that can achieve sufficiently favorable levels of clustering. For example, this can be based on tracking and/or measuring clustering metrics for records in previous iterations of the conversion process and/or based on analysis of the measuring clustering metrics for records in previous iterations of the process to determine and/or estimate these thresholds. The storage utilization data 2606 can also be measured and/or tracked for each of this plurality of previous conversion processes to determine average and/or estimated storage utilization metrics that rendered conversion processes with favorable levels of clustering based on the corresponding clustering metrics measured for these previous conversion processes.

The clustering metrics can be based on a total or average number and/or proportion of records in each segment that: match cluster key of at least a threshold proportion of other records in the segment, are within a threshold vector distance and/or other similarity measure from at least a threshold number of other records in the segment. The clustering metrics can alternatively or additionally be based on an average and/or total number of segments whose records have a variance and/or standard deviation of their cluster key values that compare favorably to a threshold. The clustering metrics can alternatively or additionally be determined in accordance with any other similarity metrics and/or clustering algorithms.

Once the page conversion determination module 2610 generates segment generation determination data indicating that segments be generated via the conversion process, the segment generator 2617 can initiate the process of generating stored pages into segments. This can include identifying the pages for conversion in the conversion process. For example, all pages currently stored by the page storage system 2506 and awaiting their conversion into segments 2424 at the time when segment generation determination data is generated to indicating that the conversion process commence are identified for conversion. This set of pages can constitute a conversion page set 2655, where only the set of pages identified for conversion in the conversion page set 2655 are processed by segment generator 2617 for a given conversion process. For example, the record processing and storage system 2505 may continue to receive records from data sources 2501, and rather than buffering all of these records until after this conversion process is completed, additional pages can be generated at this time for storage in page storage system 2506. However, as processing of pages into segments has already commenced, these pages may not be clustered and converted during this conversion process and can await their conversion in the next iteration of the conversion process. As another example, the page storage system 2506 may still be storing some other pages that were previously converted into segments but were not yet deleted. These pages are similarly not included in the conversion page set 2655 because their records are already included in segments via the prior conversion.

The segment generator can implement a cluster key-based grouping module 2620 to generate a plurality of record groups 2625-1-2625-X from the plurality of records 2422 included in the conversion page set 2655. The cluster key-based grouping module 2620 can receive and/or determine a cluster key 2607, which can be automatically determined by the cluster key-based grouping module 2620, can be stored in memory, can be received from another computing device, and/or can be configured via user input. The cluster key can indicate one or more columns, such as the key column(s) of FIGS. 18-22, by which the records are to be sorted and segregated into the record groups. For example, the plurality of records 2422 included in the conversion page set 2655 are sorted and/or grouped by cluster key, where records 2422 with matching cluster keys and/or similar cluster keys are grouped together in the resulting record groups 2625-1-2625-X. The record groups 2625-1-2625-X can be a fixed size, or can be dynamic in size, for example, based on including only records that have matching and/or similar cluster keys. An example of generating the record groups 2625-1-2625-X via the cluster key-based grouping module 2620 is illustrated in FIG. 26B.

The records 2422 of each record group in the set of record groups 2625-1-2625-X generated by the cluster key-based grouping module 2620 are ultimately included in one segment 2424 of a corresponding segment group in the set of segment groups 1-X generated by the segment generator 1-X. For example, segment group 1 includes a set of segments 2424-1-2424-J that include the records 2422 from record groups 2625-1, segment group 2 includes another set of segments 2424-1-2424-J that include the records 2422 from record groups 2625-2, and so on. The identified record groups 2625-1-2625-X can be converted into segments in a same or similar fashion as discussed in conjunction with FIGS. 18-23.

The record groups are processed into segments via a columnar rotation module 2630 of the segment generator 2617. Once the plurality of record groups 2625-1-2625-X are formed, the columnar rotation module 2630 can be implemented to generate column-formatted record data 2565 for each record group 2625. For example, the records 2422 of each record group are extracted from pages 2515 as row-formatted data. In particular, the records 2422 can be received from data sources 2501 as row-formatted data and/or can be stored in pages 2515 as row-formatted data. All records 2422 in the same record group 2625 are converted into column-formatted row data 2565 in accordance with a column-based format, for example, by performing a columnar rotation of the row-formatted data of the records 2422 in the given record group 2625. The column-formatted row data 2565 generated for a given record group 2625 can be divided into a set of column-formatted row data 2565-1-2565-J, for example, where the column-formatted row data 2565 is redundancy storage error encoded by the segment generator 2617 as discussed previously, and where each column-formatted row data 2565-1-2565-J is included in a corresponding segment of a set of J segments 2424 of a segment group 2622.

The final segments can be formed from the column-formatted row data 2565 to include metadata generated via a metadata generator module 2640. The metadata generator module 2640 can be operable to generate the manifest section, statistics section, and/or the set of index sections 0-x for each segment as illustrated in FIG. 23. The metadata generator module 2640 can generate the index data 2518 for each segment 2424 by utilizing the same or different index generator 2513 of FIG. 25B, where index data 2518 generated for segments 2424 via the metadata generator module 2640 is the same as or similar to the index data 2516 generated for pages as discussed in conjunction with FIG. 25B. The column-formatted row data 2565 and its metadata generated via metadata generator module 2640 can be combined to form a final corresponding segment 2424.

Some or all features and/or functionality of FIG. 26A can be performed via at least one node 37 in conjunction with system metadata applied across a plurality of nodes 37, for example, where at least one node 37 participates in some or all features and/or functionality of FIG. 26A based on receiving and storing the system metadata in local memory of the at least one node 37 as configuration data and/or based on further accessing and/or executing this configuration data to implement some or all functionality of segment generator 2617 and/or page storage system 2508 as part of its database functionality accordingly. Performance of some or all features and/or functionality of FIG. 26A can optionally change and/or be updated over time, and/or a set of nodes participating in executing some or all features and/or functionality of FIG. 26A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 26B illustrates an example embodiment of a cluster key-based grouping module 2620 implemented by segment generator 2617. This example serves to illustrate that the grouping of sets of records in pages does not necessarily correlate with the sets of records in the record groups generated by the cluster key-based grouping module 2620. In particular, in embodiments where the pages can be generated directly from sets of incoming records as they arrive without any initial clustering, the grouping of sets of records in pages may have no bearing on the record groups generated by the cluster key-based grouping module 2620 due to the timestamp and/or receipt time of various records not necessarily having a correlation with cluster key. The embodiment of cluster key-based grouping module 2620 of FIG. 26B can be utilized to implement the segment generator 2617 of FIG. 26A and/or any other embodiment of the segment generator 2617 discussed herein.

In this example, a plurality of P pages 2515-1-2515-P of conversion page set 2655 include records received from one or more sources over time up until the page conversion determination module 2610 dictated that conversion of this conversion page set 2655 commence. The plurality of records in pages 2515-1-2515-P can be considered an unordered set of pages to be clustered into record groups. Regardless of which pages these records may belong to, records are grouped into their record groups in accordance with cluster key. In this example, records of page 2515-1 are dispersed across at least record groups 1 and 2; records of page 2515-2 are dispersed across at least record groups 1, 2, and X, and records of page 2515-P are dispersed across at least record groups 2 and X.

The value of X can be: predetermined prior to clustering, can be the same or different for different conversion page sets 2655; can be determined based on a predetermined minimum and/or maximum number of records that are included per record group; can be determined based on a predetermined minimum and/or maximum data size per record group; can be determined based on each record group having a predetermined level of clustering, for example, in accordance with at least one clustering metric, and/or can be determined based on other information. In some cases, different record groups of the set of record groups 1-X can include different numbers of records, for example, based on maximizing a clustering metric across each record group.

For example, all records with a matching cluster key, such as having one or more columns corresponding to the cluster key with matching values, can be included in a same record group. As another example, a set of records having similar cluster keys can all be included in a same record group. As another example, if the value of the cluster key can be represented as a continuous variable, numeric variable, or other variable with an inherent ordering with respect to a cluster key domain, the cluster key domain can be subdivided into a plurality of discrete intervals. In such cases, a given record group, or a given set of record groups, can include records with cluster keys having values in the same discrete interval of the cluster key domain. As another example, a record group has cluster key values that are within a predefined distance from, or otherwise compare favorably to, an average cluster key value of cluster keys within the record group. In such cases, a Euclidian distance metric, another vector distance metric, and/or any other similarity and/or distance metric can be utilized to measure distance between cluster key values of the record group. In some cases, a clustering algorithm and/or an unsupervised machine learning model can be utilized to form record groups 1-X.

Some or all features and/or functionality of FIG. 26B can be performed via at least one node 37 in conjunction with system metadata applied across a plurality of nodes 37, for example, where at least one node 37 participates in some or all features and/or functionality of FIG. 26B based on receiving and storing the system metadata in local memory of the at least one node 37 as configuration data and/or based on further accessing and/or executing this configuration data to implement some or all functionality of cluster key-based grouping module 2620 as part of its database functionality accordingly. Performance of some or all features and/or functionality of FIG. 26B can optionally change and/or be updated over time, and/or a set of nodes participating in executing some or all features and/or functionality of FIG. 26B can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

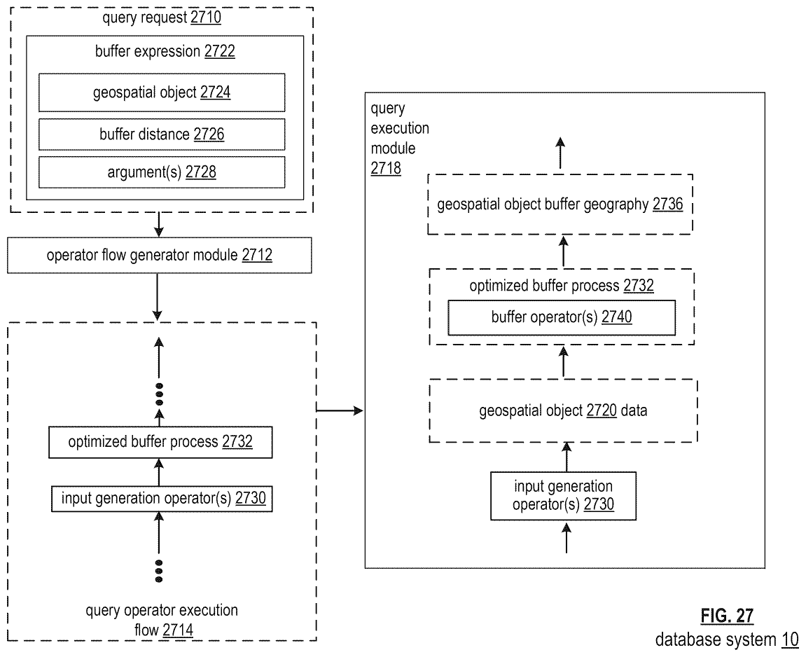

FIGS. 27A-27I present embodiments of a database system 10 operable to index data based on one or more special indexing conditions 3817. For example, in addition to indexing data under “normal” conditions (e.g. indexing by their non-null values), additional indexing conditions can be applied to further index data (e.g. indexing null values, indexing empty arrays, indexing arrays containing null values, etc.). This can be useful in generating and applying IO pipelines 2835 for query expressions requiring rows having these special conditions be included and/or reflected in a query resultant, and/or requiring these rows having these special conditions be filtered out (e.g. when a negation is applied rendering use of a set difference against a full set of rows). In particular, index elements can be utilized as described previously to identify rows having these special conditions without sourcing the data and reading the row values in a same or similar fashion as applying index elements in IO pipelines discussed previously. IO pipelines can be generated to include index elements for special conditions based on determining types of rows that need identified for inclusion and/or filtering by applying set logic rules to the query predicate and/or operators in the query expression.

Such functionality can improve the technology of database systems by improving the efficiency of query executions. In particular, fewer rows need be read via source elements in executing queries when identifying rows having special conditions for inclusion and/or filtering in generating the query resultant, based on generating and utilizing corresponding index data for these special conditions.

Such functionality can be applied at a massive scale, where a massive number of rows are processed and indexed via one or more special index conditions, and/or where index data is applied to identify a massive number of rows, or a subset of a massive number of rows, in executing queries. Some or all functionality described herein with regards to generating index data for special conditions or utilizing index data for special conditions in query execution, cannot practically be performed by the human mind.

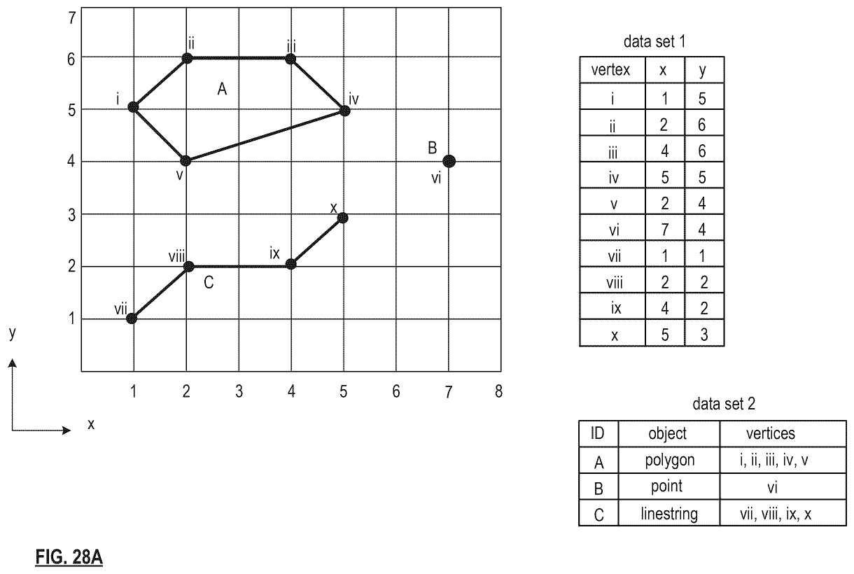

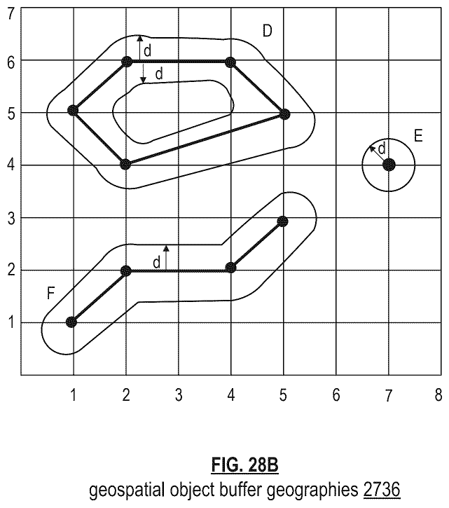

FIG. 27 is a schematic block diagram of an example of processing at least a portion of a query request 2710 that includes a buffer expression 2722 by a database system 10. The buffer expression 2722 indicates a geospatial object 2724, a buffer distance 2726, and one or more arguments 2728. A geospatial object 2724 is a representation of a geographic object, such as a place or thing that has a location on Earth. A geospatial object includes geospatial data made up of geometries such as one or more points, lines, and/or polygons. Types of geospatial objects are discussed in more detail with reference to FIG. 28A.

A geospatial buffer process takes a geospatial object, a specified distance, and one or more arguments and returns a geography that represents the collection of all points within the specified distance of the geospatial object. While the term geography is used herein, the term geometry may also be appropriate depending on the data type of the geospatial object 2724. For example, geometry type data represents data in a Euclidean coordinate system while geography type data represents data in a round-earth coordinate system. For ease of illustration, many examples herein are shown on a Cartesian coordinate system, but one or more of the disclosed embodiments are applicable to data in flat or non-flat (e.g., spherical) coordinate systems.

The one or more arguments 2728 of the buffer expression 2722 may include user specified parameters that indicate how the resulting geography is to be generated. For example, the one or more arguments 2728 may indicate a full or partial buffer (e.g., external, internal, right hand, left hand, full, etc.), endcap styles (e.g., round, flat, square, etc.), join/corner styles (e.g., round, mitre/miter, bevel, etc.), error tolerances, quad_segs (the number of line segments used to approximate a quarter circle), etc. When the one or more arguments are set by default, the one or more arguments may or may not be included in the buffer expression since they are stored settings. The buffer expression can be implemented as an SQL ST_Buffer or any other type of buffer process in any query language.

The operator flow generator module 2712 can generate the query operator execution flow 2714 to indicate performance of an optimized buffer process 2732 via one or more corresponding operators. The operators of the optimized buffer process 2732 can be configured based on the geospatial object 2724, the buffer distance 2726, and/or the one or more arguments 2728. The optimized buffer process 2732 can be implemented via one or more serialized operators and/or multiple parallelized branches of operators configured to execute the corresponding buffer expression.

The operator flow generator module 2712 can generate the query operator execution flow 2714 to indicate performance of the optimized buffer process 2732 upon output data blocks generated via one or more input generation operators 2730. For example, the input generation operators 2730 may include one or more serialized operators and/or multiple parallelized branches of operators utilized to retrieve a set of rows from memory, for example, to perform IO operations, to filter the set of rows, to manipulate and/or transform values of the set of rows to generate new values of a new set of rows for performing the optimized buffer process, or otherwise retrieve and/or generate the geospatial object 2720 data (e.g., an input row set).

The query execution module 2718 can be implemented to execute the query operator execution flow 2714 to facilitate performance of the corresponding buffer expression 2722. This can include executing the input generation operators 2730 to generate input data that may include a plurality of input rows. The plurality of input rows of an input row set can be generated via the input generation operators 2730 as a stream of data blocks sent to the optimized buffer process 2732 for processing.

The optimized buffer process 2732 can implement one or more buffer operators 2740 to process a geospatial object input (e.g., an input row set) to generate a geospatial object buffer geography (e.g., an output row set that includes a plurality of output rows). The one or more buffer operators 2740 can be implemented as one or more operators configured to execute some or all of the corresponding optimized buffer process 2732. The geospatial object buffer geography 2736 may be generated as output rows of an output row set by the optimized buffer process 2732 as a stream of data blocks emitted as a query resultant of the query request 2710 and/or sent to other operators serially after the optimized buffer process 2732 for further processing.

The geospatial object buffer geography 2736 may be outputted to at least one node of a plurality of nodes of the database system for use in the query request on a data set. For example, the query request includes the buffer expression but also a data set for use with the resulting geospatial object buffer geography. For example, the query relates to generating a geospatial object buffer geography that represents a distance around a city center, and the data set is all restaurants located within the geospatial object buffer geography.

The geospatial object buffer geography 2736 may also be outputted as the query resultant on a data set. As another example, the geospatial object buffer geography 2736 may be sent to memory for storage.

The query execution module 2718 may execute the query operator execution flow 2714 via a plurality of nodes 37 of a query execution plan 2405, for example, in accordance with nodes 37 participating across different levels of the plan (as discussed with reference to FIG. 24A, etc.). For example, the input generation operators 2730 are implemented via nodes at a first one or more levels of the query execution plan 2405, such as an IO level and/or one or more inner levels directly above the IO level.

The input generation operators 2730 can be implemented via a common set of nodes at these one or more levels. Alternatively, some of the input generation operators 2730 are processed via a first set of nodes of these one or more levels and some of the input generation operators 2730 are processed via a second set of nodes that have a non-null difference with and/or that are mutually exclusive with the first set of nodes.

The optimized buffer process 2732 can be implemented via nodes at a second one or more levels of the query execution plan 2405, such as one or more inner levels directly above the first one or more levels, and/or the root level. For example, one or more nodes at the second one or more levels implementing the optimized buffer process 2732 receive input rows for processing from child nodes implementing the input generation operators 2730. The one or more nodes implementing the optimized buffer process 2732 at the second one or more levels can optionally belong to a same shuffle node set 2485 and can laterally exchange input rows with each other via one or more shuffle operators and/or broadcast operators via a corresponding shuffle network 2480.

FIG. 28A is a diagram of an example embodiment of geospatial object 2720 data. The geospatial object 2720 data is depicted here in tables (data set 1 and data set 2) for simplicity of example. The geospatial object 2720 data in a different format and may be stored in database storage implemented via the parallelized data store, retrieve, and/or process sub-system 12, via memory drives 2425 of one or more nodes 37, and/or via other memory and/or storage resources of database system 10 of one or more of the preceding Figures. For example, the database tables can be stored as segments as discussed in conjunction with FIGS. 15-23 and/or FIGS. 24B-24D . A database table can be implemented as one or more datasets and/or a portion of a given dataset, such as the dataset of FIG. 15.

The geospatial object 2720 data shown includes three geometries: a polygon A with vertices i, ii, iii, iv, and v, a point B with vertex vi, and a line (also referred to as a linestring) C with vertices vii, viii, ix, and x. The geospatial object 2720 data includes data plotted on the Cartesian plane, but other types of geospatial object 2720 data and coordinate systems may be used. Further, vertices may also include other data points such as a-values representative of elevation and/or m values representative of measurements along line features.

A geospatial object may be defined to include all or some of the geospatial object 2720 data. For example, a geospatial object may be polygon A, point B, or line C or some combination and/or multiple thereof. In this example, each geometry (polygon A, point B, or line C) is defined as an individual geospatial object. The geospatial object 2720 data is organized according to vertices with XY coordinates as depicted in data set 1 as well as object type as depicted in data set 2.

FIG. 28B is a diagram of an example embodiment of geospatial object buffer geographies 2736 of the geospatial objects of FIG. 28A. A buffer process generates a polygon or multipolygon that surrounds an input geospatial object at a specified distance. With the individual input data sets of the polygon A, point B, and line C of FIG. 28A, the buffer process generates the buffer geographies D, E, and F respectively at a given distance “d.” The polygon buffer geography D and line buffer geographies F have rounded joins, but other join/corner styles are possible. The polygon is a closed geospatial object and therefore the geospatial object geography D does not have endpoints. The line is an open geospatial object and therefore the geospatial object geography F has endpoints (rounded in this example). The polygon geospatial object geography D is buffered both internally and externally (e.g., a full buffer). In other embodiments, a closed geography/geometry may be buffered either internally or externally. Similarly, a line may be buffered on one side or the other (e.g., left or right-side buffering) or fully buffered as shown here. Many buffer styles and options are possible.

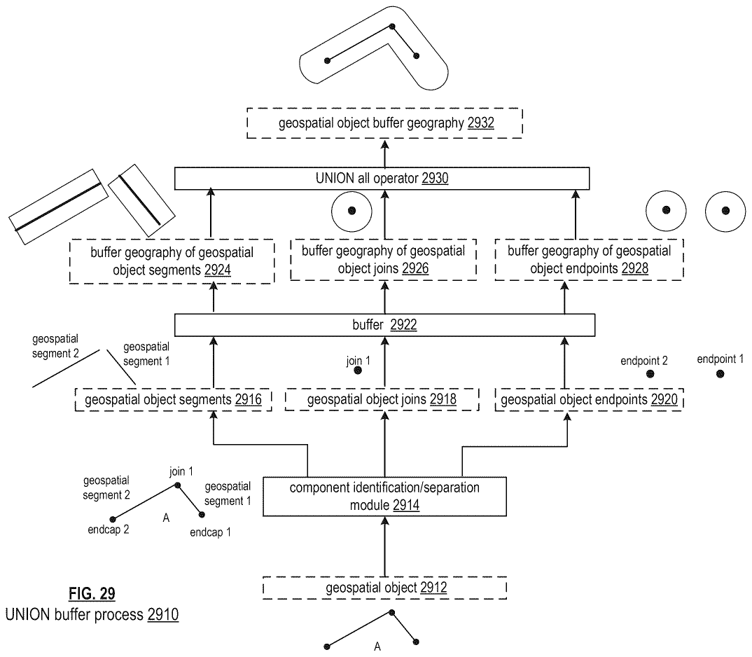

FIG. 29 is a schematic block diagram of an embodiment of a UNION buffer process 2910 executable by a processing module (e.g., a query execution module) of the database system. The union buffer process 2910 includes a component identification/separation module 2914, a buffer module 2911 and a UNION all operator 2930. The union buffer process 2910 obtains a geospatial object 2912 (e.g., via a set of input rows). In this example, the geospatial object 2912 is a line A. The component identification/separation module 2914 identifies the components of the geospatial object 2912 and separates the geospatial object 2912 into its components. Components of a geospatial object may include geospatial line segments, points, joins, and/or endpoints. For example, the component identification/separation module 2914 analyzes a list of points of the geospatial object and functions that describe lines between these points to determine geospatial line segments (e.g., geospatial segments 1 and 2) of the geospatial object 2912, points of the geospatial object 2912 that represent joins (e.g., join 1), and points of the geospatial object 2912 that represent endpoints (e.g., endpoints 1 and 2).

The buffer module 2922 generates a buffer geography for each component (e.g., buffer geography of geospatial object segments 2924, buffer geography of geospatial object joins 2926, and buffer geography of geospatial object endpoints 2928 (i.e., endcaps). For example, the buffer module 2922 expands each component to include points within or equal to a specified distance. The UNION all operator 2930 combines geographies produced by the buffer module 2922 to produce a single geospatial object geography 2932 result.

While a simple example is shown here, accumulating buffer geography components of a buffer geography to perform multiple UNION all operations requires a considerable amount of work in the event of larger inputs. Even if the geospatial object is simplified (e.g., by a line simplification algorithm), the union buffer process may require more time, power, and computational resources than desired.

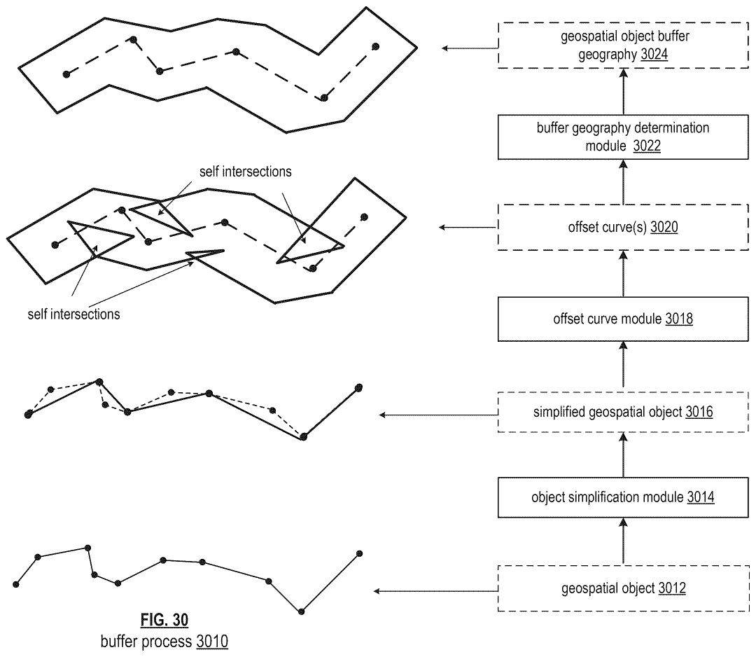

FIG. 30 is a schematic block diagram of an embodiment of a buffer process 3010 executable by a processing module (e.g., a query execution module) of the database system. The buffer process 3010 eliminates the need to generate multiple individual buffer geographies for multiple UNION all operations of the union buffer process of FIG. 29 and thus improves performance. For point geographies, the buffer process is unchanged since the buffer process for a single point generates a polygonal approximation to a circle around a point. Thus, the foregoing improved buffer processes are intended for geographies including a plurality of points, one or more lines, and/or one or more polygons.

The buffer process 3010 includes an object simplification module 3014 that executes a geospatial object simplification function on a geospatial object 3012 to produce a simplified geospatial object 3016. For example, the object simplification module 3014 executes an iterative end-point fit algorithm such as a planar Douglas-Peucker simplification algorithm or a variation of the Douglas-Peucker simplification algorithm for geospatial objects on a spherical surface. See J. L. G Pallero, Robust Line Simplification on the Surface of the Sphere, COMPUTERS & GEOSCIENCES, 83, 146-152 (2015). An iterative end-point fit algorithm decimates a curve composed of line segments to a similar curve with fewer points. Typically, with spherical variations of the Douglas-Peucker simplification algorithm, a self intersection check is required. However, the geospatial object simplification function does not require a self intersection checking step which greatly improves performance compared to functions that would require a self intersection checking step.

In this example, the geospatial object 3012 is a line (also referred to as a linestring) and the simplified geospatial object 3016 is a simplified version of the line with less segments and points. The buffer process 3010 further includes an offset curve module 3018 that executes an offset curve function to generate one or more offset curves 3020 based on the simplified geospatial object 3016. In this example, the buffer expression identified in the database query indicated that the buffer is a full buffer (buffering from both sides of the geospatial object). The one or more offset curves 3020 are composed of joined offset curve segments projected from a distance from each geospatial object line segment in the geospatial object. The generated offset curves typically have self and/or cross intersections which can present computational problems for buffer defining algorithms as well as inaccuracies in the resulting buffer geographies.

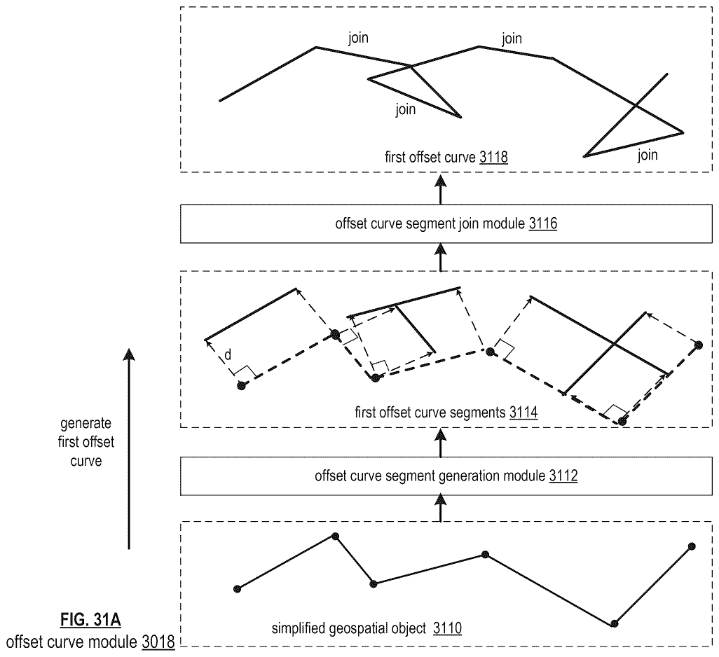

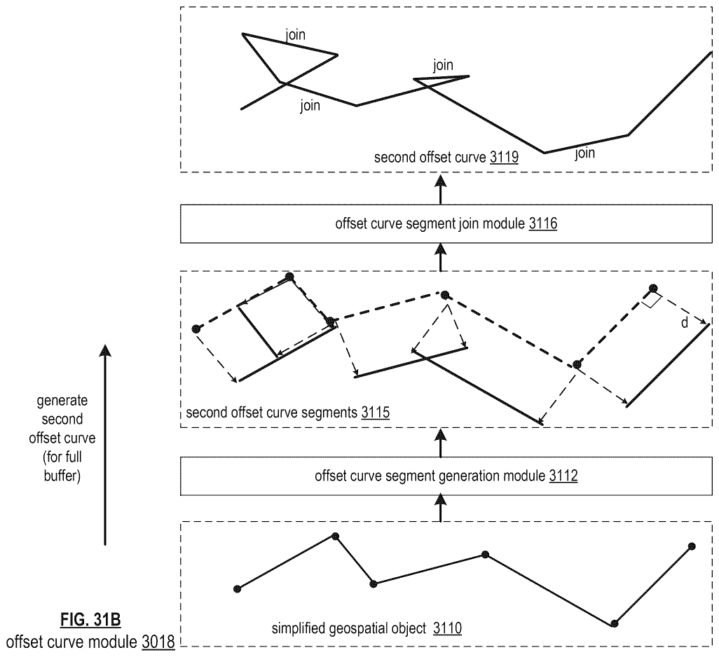

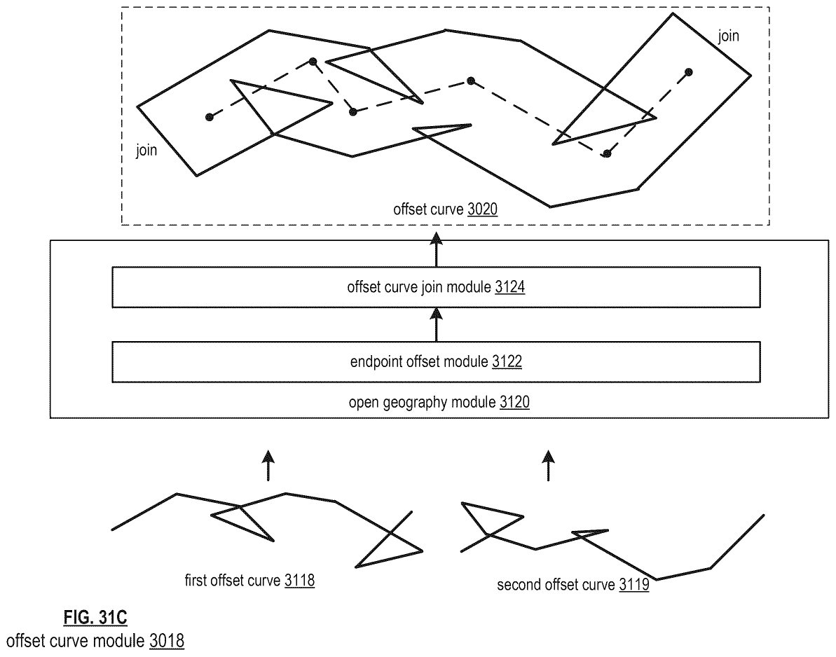

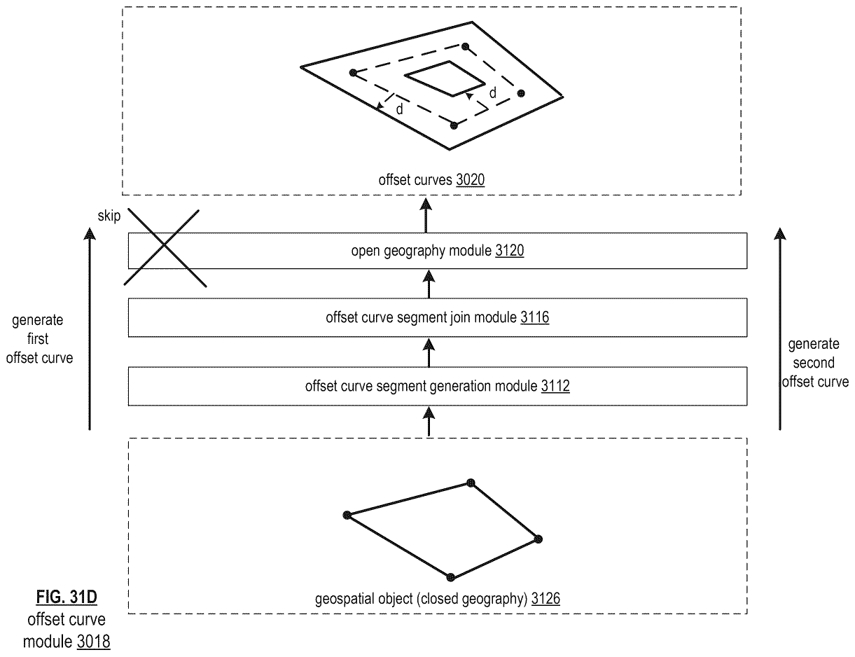

A self intersection is an intersection of lines of the offset curve. When the offset curve includes two offset curves (e.g., the geospatial object is a polygon or closed line), intersections may also exist between the two offset curves. These are referred to as cross intersections. Generating the one or more offset curves will be discussed in more detail with reference to FIGS. 31A-31D.

There are two main ways that offset curve intersections occur: 1) the geospatial object is arranged in such a way as the offset curves unavoidably collide with each other (e.g., a C shaped line with a specified distance large enough for the buffers from the top and bottom of the C to intersect), and 2) where a line makes right turns. As shown, the simplified geospatial object 3016 includes several right turns and thus, the generated offset curve has several self intersections.

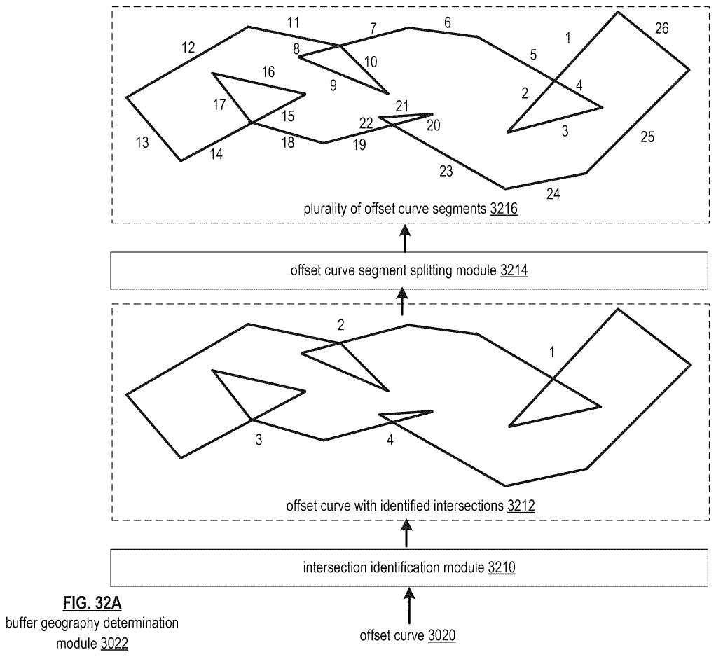

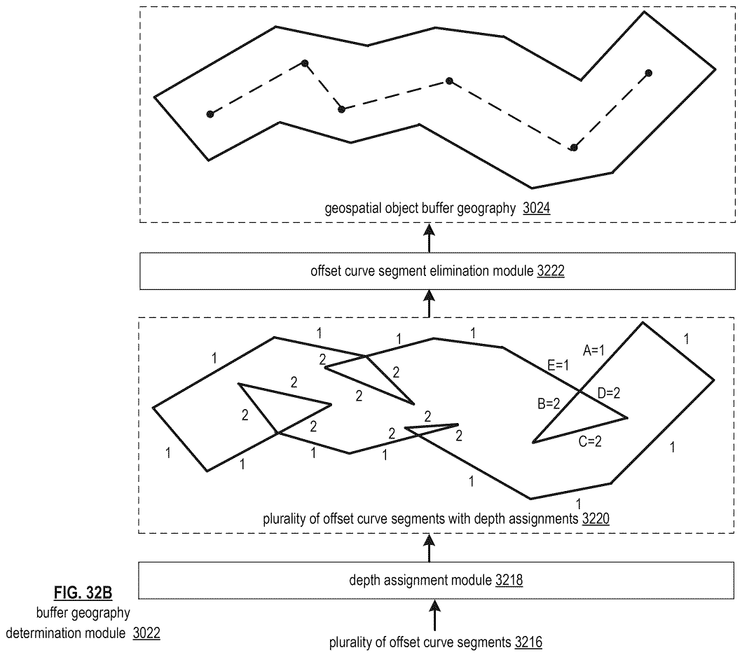

The buffer process 3010 further includes a buffer geography determination module 3022 that executes a depth analysis function on the one or more offset curves 3020 to produce the geospatial object buffer geography 3024. The depth analysis function identifies and eliminates part(s) of the offset curve 3020 that are “inside” the geospatial object buffer geography 3024 to form the geospatial object buffer geography 3024. Executing the depth analysis function on the one or more offset curves 3020 to generate the geospatial object buffer geography 3024 from will be discussed in greater detail with reference to FIGS. 32A-32B.

FIGS. 31A-31D are schematic block diagrams of an embodiment of an offset curve module 3018 operable to execute an offset curve function of a buffer process (e.g., buffer process 3010 of FIG. 30) executable by a processing module (e.g., the query execution module) of the database system. As shown in FIG. 31A, the offset curve module 3018 includes an offset curve segment generation module 3112 and an offset curve segment join module 3116. The offset curve segment generation module 3112 takes a geospatial object input such as simplified geospatial object 3110 (e.g., the simplified line of FIG. 30) and generates first offset curve segments 3114. The example of FIG. 31A expands on the example of FIG. 30 where the buffer expression indicates a full buffer (a buffer on both sides of the geospatial object) will be generated.

The offset curve segment generation module 3112 generates offset curve segments by determining one or more geospatial object segments of the geospatial object. A geospatial object segment is a portion of a line of the geospatial object defined by two distinct endpoints. When considering geospatial objects on the surface of a sphere, intermediate points can be added to longer geospatial object segments at a user-specified tolerance parameter to break these long geospatial object segments into smaller geospatial object segments. Because great circle arcs on a sphere cannot be parallel, breaking up long geospatial object segments keeps the geospatial object segment and its corresponding offset curve at the correct distance.

The simplified geospatial object is traversed in a first direction where, for each identified geospatial object segment, an offset curve segment is generated by projecting the first and second points of the geospatial object segment out by a specified distance (d) at a 90-degree right-hand turn with respect to the first direction. When the buffer expression indicates that the buffer is not a full buffer (e.g., internal, external, right, or left), the first direction is the direction of the desired buffer side. The offset curve segment join module 3116 adds the appropriate join (e.g., a user specified join type) to join consecutive offset curve segments 3115 to produce a first offset curve 3118. In this example, the joins have a bevel (flat) style to concatenate the offset curve segments.

FIG. 31B is similar to FIG. 31A and depicts the offset curve segment generation module 3112 and the offset curve segment join module 3116 of the offset curve module 3018. When the buffer expression is not a full buffer (e.g., as indicated by the buffer expression), the example of FIG. 31B can be skipped. The offset curve segment generation module 3112 takes the simplified geospatial object 3110 and generates at least one second offset curve segment 3115.

To generate the second geospatial object segments 3115, the simplified geospatial object 3110 is traversed in a second direction. For each geospatial object segment, an offset curve segment is generated by projecting the first and second points of the geospatial object segment out by a specified distance (d) at a 90-degree right-hand turn with respect to the second direction. The offset curve segment join module 3116 adds the appropriate join (e.g., a user specified join type) to join consecutive offset curve segments 3115 to produce a second offset curve 3119. In this example, the joins are a bevel (flat) style to concatenate the offset curve segments.

FIG. 31C depicts an open geography module 3120 of the offset curve module 3018. The open geography module 3120 includes an endpoint offset module 3122 and an offset curve join module 3124. When the geospatial object is an open geography (e.g., a line), the endpoint offset module 3122 generates endpoint offsets for the input offset curve(s) (e.g., the first offset curve 3118 and the second offset curve 3119) in accordance with a specified style to produce a first offset curve with an endpoint offset and a second offset curve with an endpoint offset.

The offset curve join module 3124 joins the first and second offset curve along with their respective endpoint offsets to produce the offset curve 3020 with endcaps. Here, endcap style is a square style where the endcap of the buffer is squared off at the buffer distance (d) beyond the line ends. Many styles and types of endcaps are possible. Alternatively, the endpoint offset module 3122 joins the endpoint offsets with the first offset curve to produce a first offset curve with endcaps, joins the endpoint offsets with the second offset curve to produce the second offset curve with endcaps, and the offset curve join module 3124 joins the first offset curve with endcaps and second offset curve with endcaps to produce the offset curve 3020. When the geospatial object is a closed geography, generating endcaps and joining the individual offset curves is not necessary and the open geography module's 3120 functions can be skipped.

FIG. 31D depicts an example of an offset curve module 3018 executing an offset curve function on a geospatial object with a closed geography 3126 such as the polygon shown to produce offset curves 3020. The offset curve module 3018 includes the offset curve segment generation module 3112, the offset curve segment join module 3116, and the open geography module 3120.

The offset curve segment generation module 3112 generates offset curve segments by determining one or more geospatial object segments of the geospatial object 3126. In this example, a full buffer is shown with an internal and external offset curve. To generate first geospatial object segments, the geospatial object is traversed in a first direction. For each geospatial object segment, an offset curve segment is generated by projecting the first and second points of the geospatial object segment out by a specified distance (d) at a 90-degree right-hand turn with respect to the first direction. The offset curve segment join module 3116 adds the appropriate join (e.g., a user specified join type) to join consecutive offset curve segments to produce a first offset curve (shown as the outside curve in the offset curve 3020). In this example, the joins are a mitre style (i.e., “sharp” up to a certain distance). Because the geography is closed, the open geography module's 3120 functions are skipped.

To generate the second geospatial object segments, the geospatial object 3126 is traversed in a second direction. For each geospatial object segment, an offset curve segment is generated by projecting the first and second points of the geospatial object segment out by a specified distance (d) at a 90-degree right-hand turn with respect to the second direction. The offset curve segment join module 3116 adds the appropriate join (e.g., a user specified join type) to join consecutive offset curve segments to produce a second offset curve (as shown as the interior curve of offset curves 3020. Because the geography is closed, the open geography module's 3120 functions are skipped and the resulting offset curves 3020 are the first and second offset curves.

FIGS. 32A-32B are schematic block diagrams of an embodiment of a buffer geography determination module 3022 operable to execute a depth analysis function of a buffer process executable by a processing module (e.g., a query execution module) of the database system. The depth analysis function identifies and eliminates portions of the offset curves that are located inside the geospatial object buffer geography (i.e., unnecessary portions of the offset curves formed by self and/or cross intersections). FIG. 32A depicts an intersection identification module 3210 and an offset curve segment splitting module 3214 of the buffer geography determination module 3022. The intersection identification module 3210 takes the one or more offset curves 3020 generated by the offset curve module of previous Figures and identifies intersections in the one or more offset curves 3020.

Intersections can be self-intersections (e.g., an offset curve intersects itself) or a cross intersection (e.g., an offset curve intersects another offset curve). The intersection identification module 3210 may be able to determine intersections by using containment relationships and/or analyzing the points of offset curves and offset curve segments. For example, coordinates in the offset curve segments can be analyzed to determine which coordinates (e.g., coordinate pairs) are shared between offset curve segments.

For example, the intersection identification module 3210 identifies four self-intersections in the offset curve 3020 to produce an offset curve with identified intersections 3212. The offset curve segment splitting module 3214 splits the offset curve with identified intersections 3212 into a plurality of offset curve segments 3216 based on the identified intersections. As shown, the offset curve segment splitting module 3214 splits the offset curve with identified intersections 3212 into 26 offset curve segments based on existing offset curve segments and new offset curve segments created by the intersections.

FIG. 32B continues the example of the buffer geography determination module 3022 executing the depth analysis function to identify and eliminate portions of the offset curves that are located inside the geospatial object buffer geography. FIG. 32B includes a depth assignment module 3214 and an offset curve segment elimination module 3216 of the buffer geography determination module 3022. The depth assignment module 3214 takes the plurality of offset curve segments 3216 and assigns a depth to each offset curve segment. The depth may be an integer value. The depth increases (e.g., by 1) from one offset curve segment to the next offset curve segment when the next offset curve segment is further “inside” the offset curve than the previous offset curve segment. This occurs when there is an intersection point at the end of a first offset curve segment (e.g., offset curve segment A) and the beginning of the second offset curve segment (e.g., offset curve B), and the first offset curve segment is to the right of the intersected part of the offset curve (when traveling in a left direction around the offset curve segments) and the second offset curve segment is to the left of the intersected part of the offset curve.

Conversely, the depth value decreases (e.g., by 1) when there is an intersection point at the end of a first offset curve segment (e.g., offset curve segment E) and the beginning of a second offset curve segment (e.g., offset curve segment D), and the first offset curve segment is to the left of the intersected part of the offset curve (when traveling in a left direction around the offset curve segments) and the second offset curve segment is to the right of the intersected part of the offset curve.

As shown, offset curve segment A is assigned a depth value of 1 and offset curve segment B is assigned a depth value of 2 since offset curve segment B is more “inside” the offset curve. The offset curve segment C is assigned a depth value of 2 since there is no intersection at the end of offset curve segment B. The offset curve segment D is assigned a value of 2 since there is no intersection at the end of offset curve segment C. Offset curve segment E has been assigned a value of 1 since it is less “inside” the offset curve than offset curve segment D. The rest of the depth assignments carry on in a similar way.

When there are two offset curves, depths of the offset curve segments need to be synchronized by careful analysis at the first cross intersection. If there are no cross intersections between the two offset curves, the geospatial object geography is a polygon with a hole or one of the offset curves completely covers the other. The two cases can be distinguished by analyzing containment relationships between the separate geospatial object geographies formed by each offset curve.

The offset curve segment elimination module 3222 eliminates offset curve segments that are assigned a depth value above a depth threshold. For example, the depth threshold is 1 and the offset curve segments assigned a 2 are eliminated. This may be done by starting with an offset curve segment having a minimal depth and proceeding around the offset curve. At an intersection, the offset curve segment elimination module 3222 proceeds to the offset curve segment that preserves minimal depth. When returning to an offset curve segment already encountered, save the offset curve segment as part of the resulting geospatial object geography and continue with an unvisited offset curve segment of minimal depth until none are left.

As such, the modules of FIGS. 32A-32B perform a depth analysis function to identify and eliminate portions of the offset curves that are located inside the geospatial object buffer geography. While FIGS. 32A-32B depict the process on a relatively simple geospatial object, complex geospatial objects that produce offset curves with many self intersections having offset curve segments at increasing depths within the geospatial buffer geography, may require considerable computational resources to perform the depth analysis function and may render the function impractical from a performance standpoint. Further, a large number of self intersections increases the likelihood of accuracy issues in output of the depth analysis function.

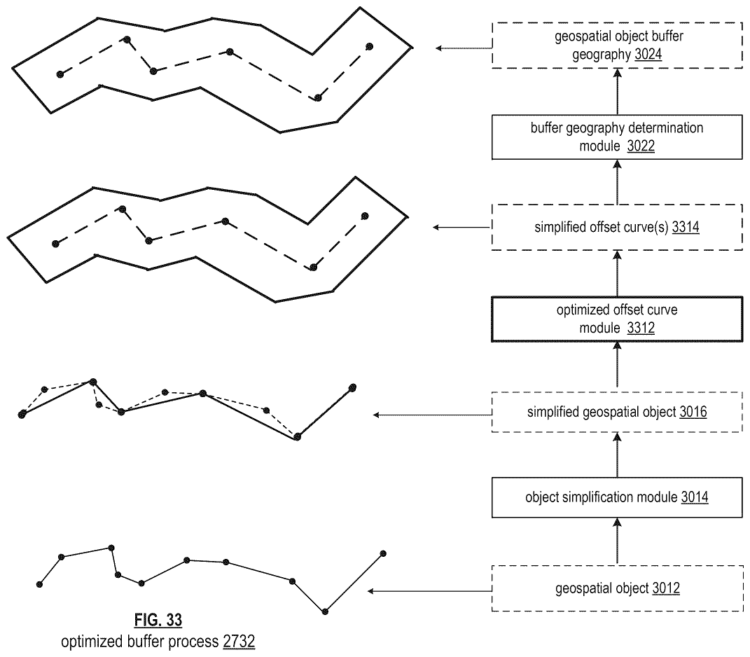

FIG. 33 is a schematic block diagram of an embodiment of an optimized buffer process 2732 executable by a processing module (e.g., a query execution module) of the database system. The optimized buffer process 2732 is similar to the buffer process of previous Figures except that the offset curve module has been replaced with an optimized offset curve module 3312. The optimized offset curve module 3312 takes a simplified geospatial object 3016, generates one or more offset curves, and executes an offset curve segment loop and elimination function on the one or more offset curves to generate one or more simplified offset curves 3314.

The optimized offset curve module 3312 includes the steps of the offset curve module of FIGS. 31A-31D and after the one or more offset curves are generated, the optimized offset curve module 3312 performs the offset curve segment loop elimination function operable to remove self intersection loops caused by right turns.

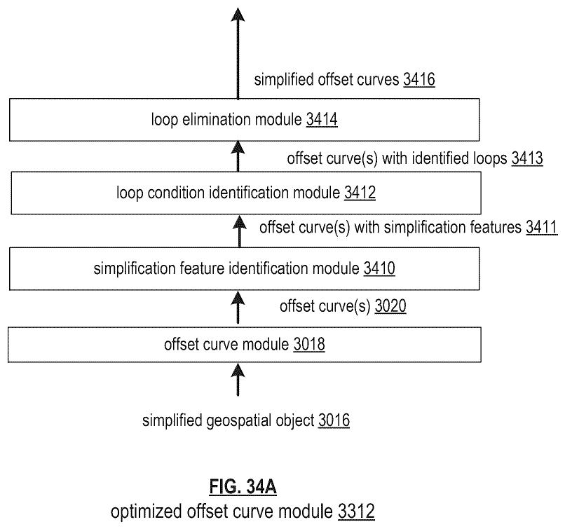

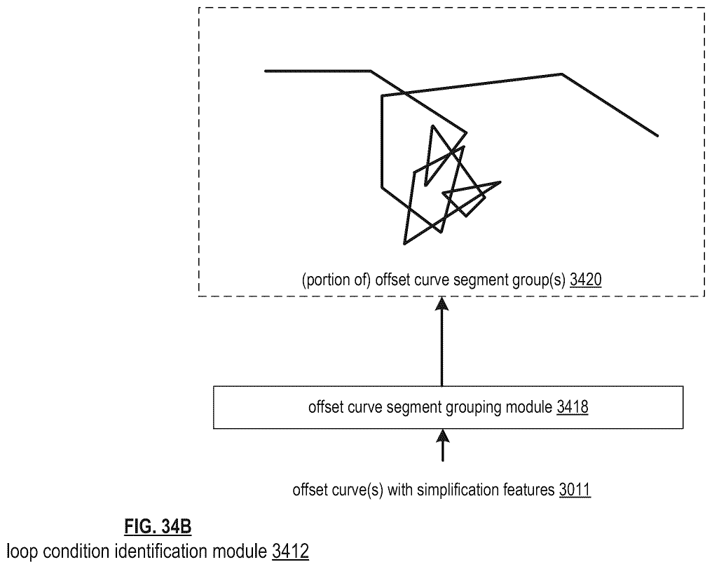

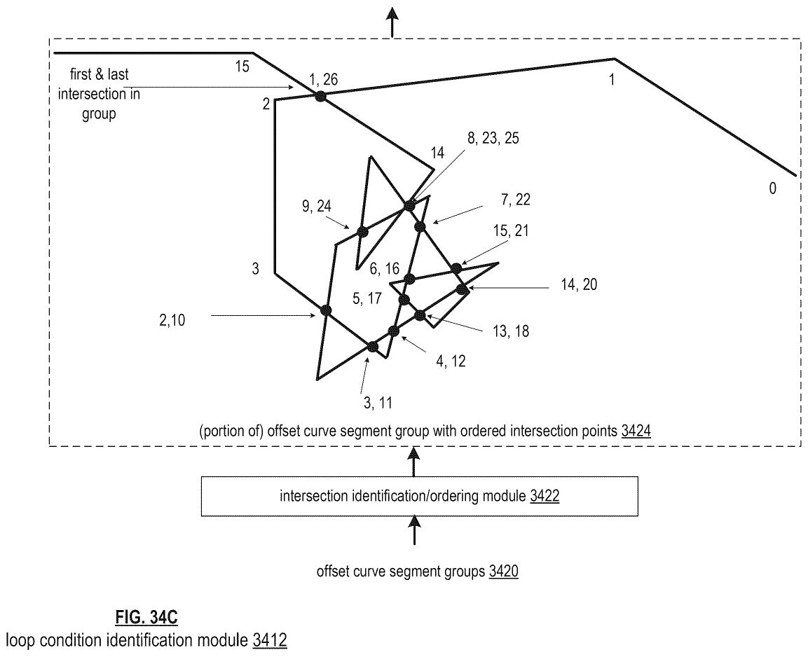

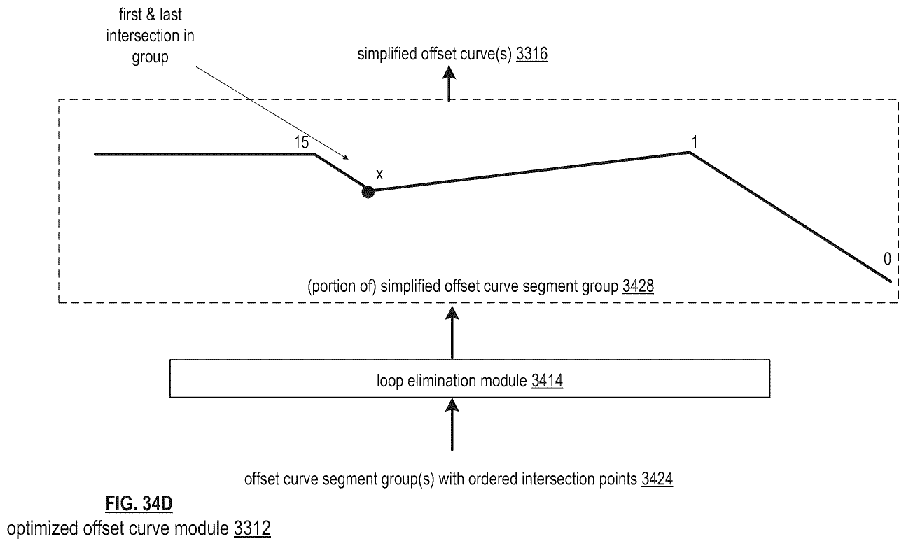

As shown, the “loops” that previously existed in the offset curve 3020 of FIG. 30 have been eliminated in the simplified offset curve 3314. While the geospatial object and its offset curve depicted here are simple here for illustrative purposes, when several consecutive right turns form intersections contained in one overall loop, eliminating all the offset curve segments in that loop can greatly improve the performance and accuracy of the depth analysis function performed by the buffer geography determination module 3022. The optimized offset curve module 3312 will be discussed in more detail with reference to FIGS. 34A-34D.

FIG. 34A is a schematic block diagram of an embodiment of an optimized offset curve module 3312 of an optimized buffer process. The optimized offset curve module 3312 generates one or more offset curves 3020 from a geospatial object 3016 and executes an offset curve segment loop elimination function on one or more offset curves 3020 to produce one or more simplified offset curves 3416. The optimized offset curve module 3312 includes an offset curve module 3018, a simplification feature identification module 3410, a loop condition identification module 3412, and a loop elimination module 3412.

The offset curve module 3018 operates similarly to the offset curve module of FIGS. 31A-31D to take a simplified geospatial object 3016 and generate one or more offset curves 3020. The simplification feature identification module 3410 analyzes the one or more offset curves 3020 for one or more simplification features. For example, the simplification feature identification module analyzes the one or more offset curves 3020 for consecutive right-hand turns through spatial analysis techniques. If the simplification feature identification module 3410 does not identify the one or more simplification features, the loop condition identification module 3412 and the loop elimination module 3414 can be skipped and the one or more offset curves can be output as the one or more simplified offset curves.

The loop condition identification module 3412 analyzes the one or more offset curves with the simplification features 3411 to identify one or more loop conditions. The loop condition identification module 3412 will be discussed in greater detail with reference to FIGS. 34B-34C. When the one or more loop conditions are identified, the loop elimination module 3414 eliminates the loops identified by the one or more loop conditions to produce one or more simplified offset curves 3416.

When the one or more loop conditions are not identified, the loop elimination module 3414 can be skipped and the one or more offset curves can be output as the one or more simplified offset curves. The loop elimination module is discussed in more detail with reference to FIG. 34D

FIG. 34B is a schematic block diagram of an embodiment of a portion of a loop condition module 3412 an optimized offset curve module 3312. The portion of the loop condition module 3412 includes an offset curve segment grouping module 3418. The offset curve segment grouping module 3418 groups a plurality of offset curve segments and offset curve joins of the one or more offset curves with simplification features into right turn groups and no right turn groups. The right turn groups include offset curve segments and offset curve joins of the plurality of offset curve segments and offset curve joins that form right turns and the no right turn groups include offset curve segments and offset curve joins of the plurality of offset curve segments and offset curve joins that do not form right turns.

For each right turn group of the right turn groups, the offset curve segment grouping module 3418 concatenates a proceeding no right turn group of the no right turn groups and a following no right turn group of the no right turn groups with the right turn group to form one or more offset curve segment groups 3420 of the one or more offset curves. In this example, for illustrative purposes, only a portion of an offset curve segment group is shown (a right turn group portion of offset curve segment group 3420). The portion of an offset curve segment group 3420 contains many self intersections which would render this portion of an offset curve segment group 3420 difficult for the buffer geography determination module of FIGS. 32A-32B to analyze.

FIG. 34C is a schematic block diagram of another embodiment of a portion of the loop condition module 3412 an optimized offset curve module 3312. FIG. 34C continues the example of the loop condition identification module 3414 of FIG. 34B and includes an intersection identification/ordering module 3422. The intersection identification/ordering module 3422 takes the one or more offset curve segment groups 3420 generated by the offset curve segment grouping module 3418 and, for each offset curve segment group, identifies and orders intersections in the offset curve segment group to produce offset curve segment groups with ordered intersection points 3424. Here, a portion of an offset curve segment group with ordered intersection points 3424 is shown. Intersection points can be ordered by their first appearance in an offset curve segment group and by their last appearance in the offset curve segment group.

For example, starting at the right of the diagram and moving to the left, an offset curve segment is formed from points 0 to 1 and another offset curve segment is formed from points 1 to 2. The offset curve segment from points 1 to 2 intersects an offset curve segment from points 14 to 15 in a first appearance (e.g., the intersection is labeled with a 1). As the offset curve segments are traced along the offset curve in this counterclockwise direction, the offset curve segment from points 14 to 15 can be seen as intersecting the offset curve segment from points 1 to 2 in its last appearance in the offset curve segment group (e.g., the intersection is labeled with a 26).

FIG. 34D is a schematic block diagram of an embodiment of a portion of an optimized offset curve module 3312 that includes the loop elimination module 3414. The loop elimination module 3414 takes one or more offset curve segment groups with ordered intersection points 3424 and eliminates loops identified by the one or more loop conditions. For example, the loop condition is an intersection point that appears both first and last in an offset curve segment group.

When there is an intersection that appears both first and last in the offset curve segment group, all offset curve segments between the first and last offset curve segment can be removed as this signifies a “loop” appearing “inside” of an offset curve. Each offset curve segment group is checked for intersection points that appears both first and last in the offset curve segment group.

In this example, the offset curve segment elimination module 3414 recognizes that an intersection point appears both first and last (e.g., 1 and 26) in the portion of the offset curve segment group with ordered intersection points 3424 and eliminates all offset curve segments and offset curve joins between that intersection point to produce a portion of a simplified offset curve segment group 3428. The first and last intersection point is labeled here as point x. The offset curve segment elimination module 3414 eliminates offset curve segments and joins between intersection point x such that the offset curve segment at point 1 ends at point x and the offset curve segment at point x ends at point 15. When all identified loops are eliminated, the loop elimination module 3414 outputs the resulting one or more simplified offset curves 3316.

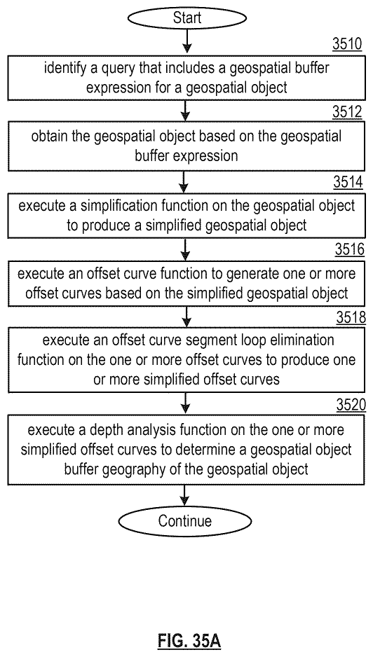

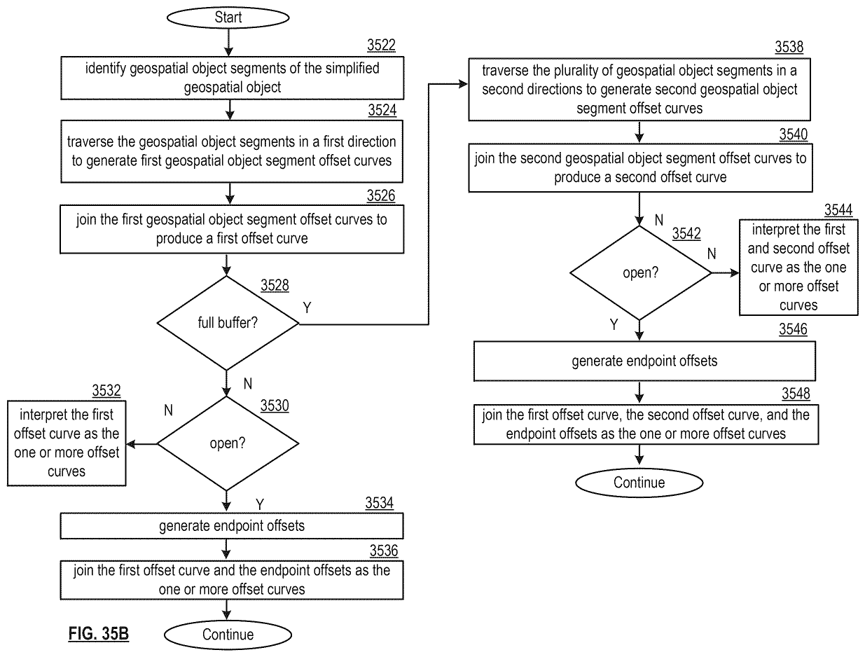

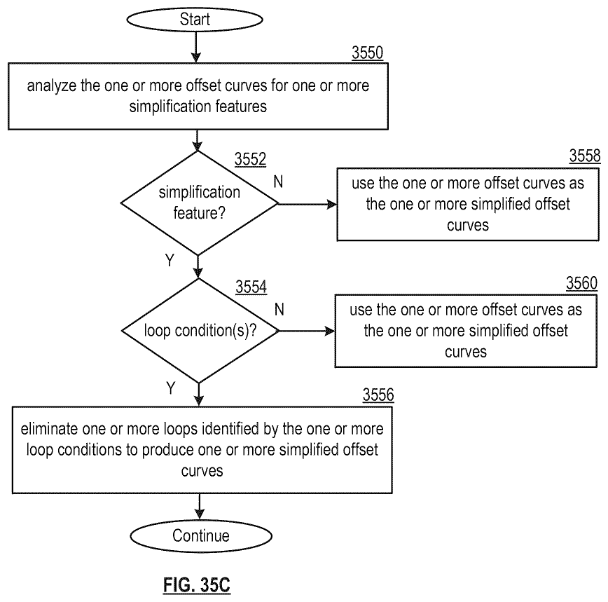

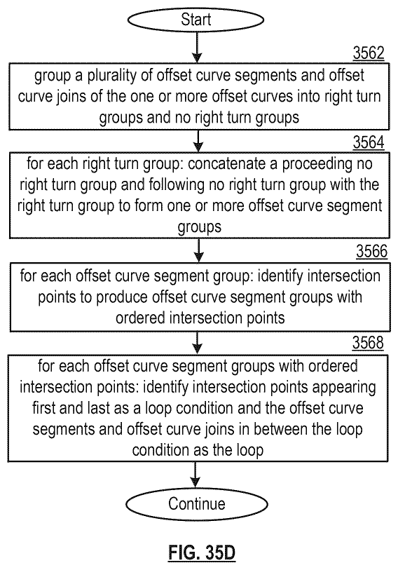

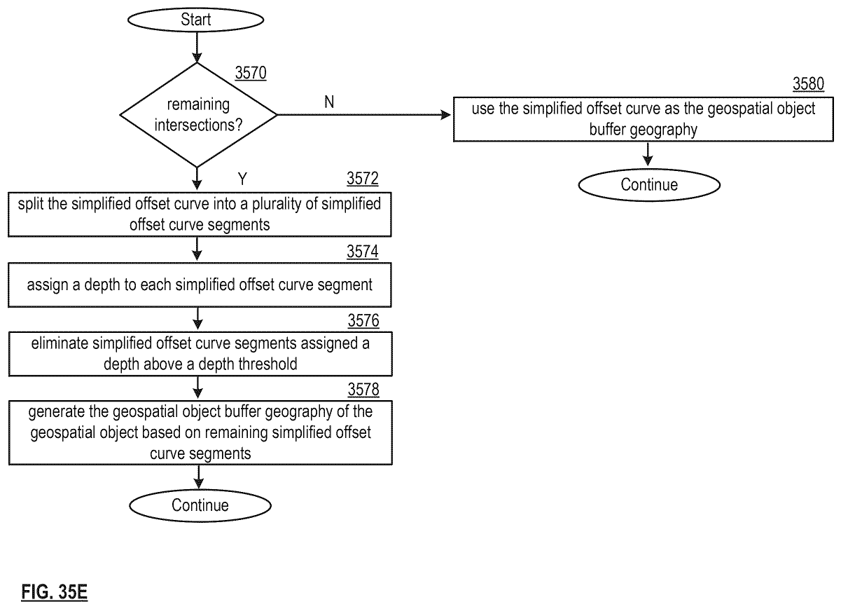

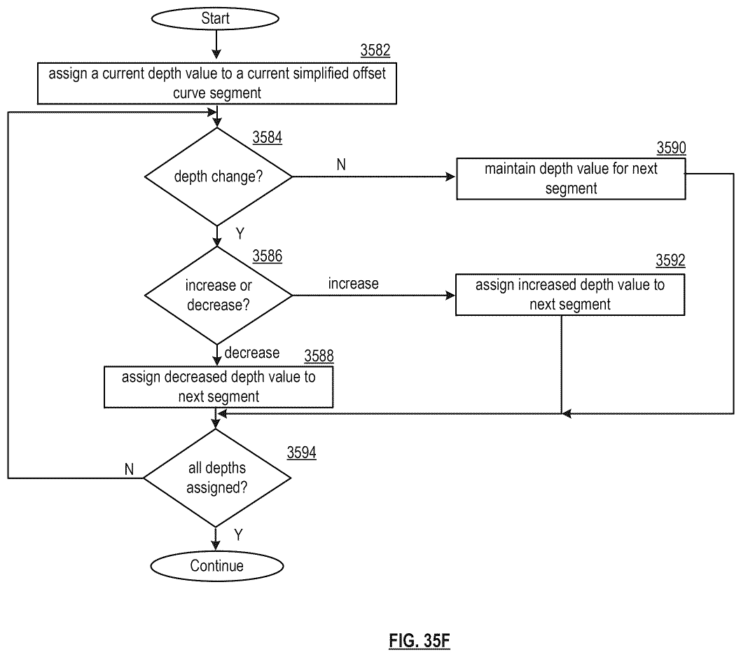

FIG. 35A is a flowchart of an example of a method of an optimized buffer process executable by a processing module of the database system. The optimized buffer process produces a geospatial object buffer geography from a geospatial object using less computational resources and power than previous methods. The processing module may be the query execution module 2718 of FIG. 27 or another processing module of the database system. The database system can utilize the processing module of one or more computing devices, where the one or more nodes execute operational instructions stored in memory accessible by the one or more nodes, and where the execution of the operational instructions causes the one or more nodes to execute, independently or in conjunction, the steps of FIG. 35A.

In particular, a node can utilize their own query execution memory resources to execute some or all of the steps of FIG. 35A, where multiple nodes implement their own query processing modules to independently execute the steps of FIG. 35A for example, to facilitate execution of a query as participants in a query execution plan. Some or all of the steps of FIG. 35A can optionally be performed by any other processing module of the database system. Some or all of the steps of FIG. 35A can be performed to implement some or all of the functionality of the database system as described in conjunction with FIGS. 27-34C, for example, by executing an optimized buffer process for a query denoting execution of a corresponding geospatial buffer expression.

Some or all of the steps of FIG. 35A can be performed to implement some or all of the functionality regarding execution of a query via the plurality of nodes in the query execution plan 2405 as described in conjunction with some or all of FIGS. 24A-25F. Some or all of steps of FIG. 35A can be performed by the database system of previous Figures in accordance with other embodiments of the database system and/or nodes discussed herein. Some or all steps of FIG. 35A can be performed in conjunction with one or more steps of any other method described herein.

The method of FIG. 35A begins with step 3510 where a processing module of the database system identifies a query that includes a geospatial buffer expression for a geospatial object. The geospatial buffer expression includes a geospatial object, a buffer distance, and one or more arguments. A geospatial object is a representation of a geographic object, such as a place or thing, that has a location on Earth. A geospatial object includes geospatial data made up of geometries such as one or more points, lines, and/or polygons such as the examples discussed with reference to FIG. 28A.

The one or more arguments may include user specified parameters that indicate how the result is to be generated. For example, the one or more arguments may indicate a full or partial buffer (e.g., external, internal, right hand, left hand or full), endcap styles (e.g., round, flat, square, etc.), join/corner styles (e.g., round, mitre/miter, bevel, etc.), error tolerances, quad_segs (the number of line segments used to approximate a quarter circle), etc. Alternatively, the one or more arguments may be default parameters. For example, for many buffer processes, endcap styles are round by default. When the one or more arguments are set by default, they may or may not be included in the buffer expression. The buffer expression can be implemented as an SQL ST_Buffer or any other type of buffer operation in any query language.

A geospatial buffer process indicated by the geospatial buffer expression takes a geospatial object and a specified buffer distance and returns a geospatial object buffer geography that represents a collection of all points within the specified distance of the geospatial object. While the term geography is primarily used herein, the term geometry may also be appropriate depending on the data type of the geospatial object. For example, geometry type data represents data in a flat, Euclidean coordinate system while geography type data represents data in a round-earth coordinate system.

The method continues with step 3512 where the processing module obtains the geospatial object indicated by the geospatial buffer expression in order to execute an optimized buffer process on the geospatial object. The optimized buffer process improves performance and reduces complexity experienced by existing buffer processes especially when processing large and/or complex geospatial objects. As an example, the geospatial object may be obtained as an input row set generated via input generation operators as a stream of data blocks sent to the processing module for processing. The optimized buffer process is executed via optimized buffer operators applied to the input row set.

The method continues with step 3514 where the processing module executes a simplification function on the geospatial object to produce a simplified geospatial object. For example, the at least one processor implements an iterative end-point fit algorithm such as a planar Douglas-Peucker simplification algorithm or a variation of the Douglas-Peucker simplification algorithm but for geospatial objects on a spherical surface. See J. L. G Pallero, Robust Line Simplification on the Surface of the Sphere, COMPUTERS & GEOSCIENCES, 83, 146-152 (2015). An iterative end-point fit algorithm decimates a curve composed of line segments to a similar curve with fewer points. Typically, when a variation of the Douglas-Peucker simplification algorithm is used on spherical surfaces, self intersection checks are required. However, this step is not required here which greatly improves performance of the simplification function.

The method continues with step 3516 where the processing module executes an offset curve function on the simplified geospatial object to produce one or more offset curves based on the simplified geospatial object. The offset curve function involves generating an offset curve segment for each geospatial object segment of the simplified geospatial object and joining the offset curve segments together to form the one or more offset curves. The offset curve function is discussed in more detail with reference to FIG. 35B.

The method continues with step 3518 where the processing module executes an offset curve segment loop elimination function on the one or more offset curves to produce one or more simplified offset curves. The offset curve segment loop elimination function is operable to remove loops caused by intersections occurring in the offset curves. Consecutive right hand turns caused by offset curve segments in the one or more offset curves introduce self intersections that form one or more offset curve segment loops in the one or more offset curves.

When several consecutive right turns form intersections contained in one overall loop in the offset curve, eliminating all the offset curve segments in that loop can greatly improve the performance and accuracy of the depth analysis function performed in the next step of the method of FIG. 35A. The offset curve segment loop elimination function will be discussed in more detail with reference to FIGS. 35C-35D.

The method continues with step 3520 where the processing module executes a depth analysis function on the one or more simplified offset curves to determine a geospatial object buffer geography of the geospatial object. The processing module executes the depth analysis function by identifying intersections still present in the one or more simplified offset curves and splitting the one or more simplified offset curves into simplified offset curve segments based on the identified intersections.

Each simplified offset curve segment is assigned a depth based on how far the offset curve segment is “inside” the one or more simplified offset curves. Simplified offset curve segments greater than (or greater than or equal to) a maximum depth threshold are eliminated and remaining simplified offset curve segments form the geospatial object buffer geography of the geospatial object. The depth analysis function is discussed in further detail with reference to FIG. 35E.

The processing module may then output the geospatial object buffer geography to at least one node of a plurality of nodes of the database system for use in the query (or another query) on a data set. As another example, the geospatial object buffer geography (e.g., an output row set of data) may be further processed by the processing module. As another example, the geospatial object buffer geography may be sent for storage in memory of the database system. As another example, the geospatial object buffer geography may be sent to a requester of the query.

FIG. 35B is a flowchart of an example of a method of an offset curve function of an optimized buffer process executable by a processing module of the database system. The offset curve function produces one or more offset curves based on the simplified geospatial object. The method begins with step 3522 where the processing module identifies geospatial object segments of the simplified geospatial object. A geospatial object segment is a portion of a line of the geospatial object defined by two distinct endpoints. When a geospatial object segment is longer than a tolerance threshold (e.g., a user specified tolerance parameter), when a geospatial object segment of the geospatial object segments is longer than a tolerance threshold, the processing module adds one or more points to the geospatial object segment to break the geospatial object segment into two or more geospatial object segment.

Breaking geospatial object segments into more segments is useful when considering geospatial objects on the surface of a sphere. Because great circle arcs on a sphere cannot be parallel, breaking up long geospatial object segments keeps the geospatial object segment and its corresponding offset curve at the correct distance.

The method continues with step 3524 where the processing module traverses the simplified geospatial object in a first direction where, for each identified geospatial object segment, a first geospatial object offset curve segment is generated by projecting the first and second points of the geospatial object segment out by a specified distance (d) at a 90-degree right-hand turn with respect to the first direction. The projected points are connected by a line to form the first geospatial object offset curve segment. An example of generating offset curve segments is described with reference to FIGS. 31A-31B.

The method continues with step 3526 where the processing module joins the first geospatial object offset curve segments to produce a first offset curve. For example, a bevel or round join may concatenate the offset curve segments in accordance with a user specified join parameter. The method continues with step 3528 where the processing module determines whether to produce a full buffer on the geospatial object. For example, the geospatial buffer expression or a default parameter indicates that the buffer result should be a full buffer (e.g., the geospatial buffer expression or a default parameter indicates that the buffer result should be a left, right, internal, or external buffer) or not a full buffer (e.g., the geospatial buffer expression or a default parameter indicates that the buffer result should be a left, right, internal, or external buffer). When the full buffer is not indicated, the first direction is indicated by a user specified or default parameter in accordance with the direction of the desired buffer side. Otherwise, with a full buffer, the first direction could be any direction.

When the processing module does not determine to produce a full buffer, the method continues with step 3530 where the processing module determines whether the geospatial object is an open geography. An open geography is a geography that has a starting point and ending point that do not meet (e.g., a line). In contrast, a closed geography is a geography that has a starting point and ending point that do meet (e.g., a closed line or polygon). When the processing module determines that the geospatial object is not an open geography (i.e., it is a closed geography), the method continues with step 3532 where the processing module interprets the first offset curve as the one or more offset curves.

When the processing module determines that the geospatial object is an open geography, the method continues with step 3534 where the processing module generates endpoint offsets for the geospatial object. For example, offset endpoints are produced by projecting the starting point of the geospatial outward a specified distance to produce a first endpoint offset and by projecting the ending point outward the specified distance to produce a second endpoint offset.

The method continues with step 3536 where the processing module joins the first offset curve and the endpoint offsets to produce the one or more offset curves. The first offset curve and the endpoint offsets are joined in accordance with an endcap style (e.g., a square style where the endcap is squared off at the buffer distance (d) beyond the geospatial object endpoint). Many styles and types of endcaps are possible.

When the processing module determines to produce a full buffer at step 3528, the method continues with step 3538 where the processing module traverses the simplified geospatial object in a second direction where, for each identified geospatial object segment, a second geospatial object offset curve segment is generated by projecting the first and second points of the geospatial object segment out by a specified distance (d) at a 90-degree right-hand turn with respect to the second direction. The projected points are connected by a line to form the second geospatial object offset curve segment.

The method continues with step 3540 where the processing module joins the second geospatial object offset curve segments to produce a second offset curve. For example, a bevel or round join may concatenate the offset curve segments in accordance with a user specified join parameter.

The method continues with step 3542 where the processing module determines whether the geospatial object is an open geography. An open geography is a geography that has a starting point and ending point that do not meet (e.g., a line). In contrast, a closed geography is a geography that has a starting point and ending point that do meet (e.g., a closed line or polygon). When the processing module determines that the geospatial object is not an open geography (i.e., it is a closed geography), the method continues with step 3544 where the processing module interprets the first offset curve and the second offset curves as the one or more offset curves.

When the processing module determines that the geospatial object is an open geography, the method continues with step 3546 where the processing module generates endpoint offsets for the geospatial object. For example, offset endpoints are produced by projecting the starting point of the geospatial outward a specified distance to produce a first endpoint offset and by projecting the ending point outward the specified distance to produce a second endpoint offset.

The method continues with step 3548 where the processing module joins the first offset curve, the second offset curve, and the endpoint offsets to produce the one or more offset curves. The first offset curve, the second offset curve, and the endpoint offsets are joined in accordance with an endcap style (e.g., a square style where the endcap is squared off at the buffer distance (d) beyond the geospatial object endpoint). Many styles and types of endcaps are possible.

FIG. 35C is a flowchart of an example of a method of an offset curve segment loop elimination function of the optimized buffer process executable by a processing module of the database system. The offset curve segment loop elimination produces one or more simplified offset curves based on the one or more offset curves.

The method begins with step 3550 where the processing module analyzes one or more offset curves to identify one or more simplification features. For example, the processing module analyzes the one or more offset curves for consecutive right-hand turns through spatial analysis techniques. When the processing module does not identify the one or more simplification features, the method continues with step 3558 where the one or more offset curves is used as the one or more simplified offset curves. When the processing module does identify the one or more simplification features, the method continues with step 3554 where the processing module analyzes the one or more offset curves with the simplification features to identify one or more loop conditions. Identifying loop conditions is discussed in more detail with reference to FIG. 35D.

When the one or more loop conditions are identified, the method continues with step 3556 where the processing module eliminates the loops identified by the one or more loop conditions to produce one or more simplified offset curves. When the one or more loop conditions are not identified, the method continues with step 3560 where the one or more offset curves can be output as the one or more simplified offset curves.

FIG. 35D is a flowchart of an example of a method of analyzing, by the processing module, the one or more offset curves to identify the one or more loop conditions. The method begins with step 3562 where the processing module groups a plurality of offset curve segments and offset curve joins of the one or more offset curves with identified simplification features into right turn groups and no right turn groups. The right turn groups include offset curve segments and offset curve joins of the plurality of offset curve segments and offset curve joins that form right turns and the no right turn groups include offset curve segments and offset curve joins of the plurality of offset curve segments and offset curve joins that do not form right turns.

The method continues with step 3564 where for each right turn group of the right turn groups, the processing modules concatenates a proceeding no right turn group of the no right turn groups and a following no right turn group of the no right turn groups with the right turn group to form one or more offset curve segment groups of the one or more offset curves.

The method continues with step 3566 where for each offset curve segment group, the processing module identifies and orders intersections in the offset curve segment group to produce offset curve segment groups with ordered intersection points. Intersection points can be ordered by their first appearance in an offset curve segment group and by their last appearance in the offset curve segment group. An example of a portion of an offset curve segment group with ordered intersection points is shown in FIG. 34C.

The method continues with step 3568 where the processing module identifies intersections appearing first and last in an offset curve segment group as a loop condition and the offset curve segments and offset curve joins in between the loop condition as the loop.

FIG. 35E is a flowchart of an example of a method of executing a depth analysis function on one or more simplified offset curves. The method begins with step 3570 where the processing module determines whether the one or more simplified offset curves include one or more remaining intersection. Intersections can be identified by using containment relationships and/or analyzing points of the offset curves and offset curve segments. For example, coordinates in the offset curve segments can be analyzed to determine which coordinates (e.g., coordinate pairs) are shared between offset curve segments.

When the one or more simplified offset curves do not contain the one or more remaining intersection, the method continues with step 3580 where the processing module uses the one or more simplified offset curves as the geospatial object buffer geography.

When the one or more simplified offset curves contain the one or more remaining intersection, the method continues with step 3572 where the processing module splits the one or more simplified offset curves with identified intersections into a plurality of simplified offset curve segments based on the one or more identified intersections.

The method continues with step 3574 where the processing module assigns a depth to each simplified offset curve segment of the plurality of simplified offset curve segments. The depth may be an integer value. The depth increases (e.g., by 1) from one offset curve segment to the next offset curve segment when the next offset curve segment is further “inside” the offset curve than the previous offset curve segment. Assigning the depth value to each simplified offset curve segment is discussed in more detail with reference to FIG. 35F.

The method continues with step 3578 where the processing module generates the geospatial object buffer geography of the geospatial object by eliminating simplified offset curve segments of the plurality of simplified offset curve segments assigned a depth value above a depth threshold. For example, when the depth threshold is 1, offset curve segments assigned a depth values higher than 1 are eliminated. This may be done by starting with an offset curve segment having a minimal depth of 1 and proceeding around the offset curve. At an intersection, the offset curve segment elimination module proceeds to the offset curve segment that preserves minimal depth. When returning to an offset curve segment already encountered, save the offset curve segment as part of the resulting geospatial object geography and continue with an unvisited offset curve segment of minimal depth until none are left.

FIG. 35F is a flowchart of an example of a method of assigning a depth value to each simplified offset curve segment. The method begins with step 3582 where the processing module assigns a current depth value to a current simplified offset curve segment of the plurality of simplified offset curve segments. For example, the processing module assigns a first simplified offset curve with a maximum depth value of 1.

The method continues with step 3584 where the processing module traverses the plurality of simplified offset curve segments to determine whether there is a depth change condition between the current simplified offset curve segment and a next simplified offset curve segment. For example, when the current simplified offset curve segment ends with an intersection point, the depth condition is detected.

When the depth change condition is not detected, the method continues with step 3590 where the processing module assigns a depth value to the next a next simplified offset curve segment that is the same as the current simplified offset curve segment's depth value.

When the depth change condition is detected, the method continues with step 3586 where the processing module determines whether the depth change condition indicates a depth increase between the current and next simplified offset curve segments or a depth decrease between the current and next simplified offset curve segments. For example, consider an example where the processing module traverses the plurality of offset curve segments in a first direction and next simplified offset curve segment is selected to the left of the current simplified offset curve. In this example, when the current offset curve segment is oriented away from the first direction from the perspective of the intersection point and the next offset curve segment is oriented toward the first direction from the perspective of the intersection point, the processing module determines that the depth change condition indicates the depth increase.

When the current offset curve segment is oriented toward the first direction from the perspective of the intersection point and the next offset curve segment is oriented away from the first direction from the perspective of the intersection point, the processing module determines that the depth change condition indicates the depth decrease.

When the depth change condition indicates the depth increase, the method continues with step 3592 where the processing module assigns an increased depth value to the next simplified offset curve segment. When the depth change indicates the depth decrease, the method continues with step 3588 where the processing module assigns a decreased depth value to the next simplified offset curve segment.

After assigning depth values at steps 3588, 3590, and 3592, the method continues with step 3594 where the processing module determines whether all of the simplified offset curve segments have been assigned a depth value. In other words, the processing module traverses the plurality of simplified offset curve segment to assign depth values to each next simplified offset curve segments of the plurality of simplified offset curve segments until each simplified offset curve segment of the plurality of simplified offset curve segments is assigned a corresponding depth value.

When not all depth values have been assigned, the method branches back to step 3584 where the processing module determines whether there is a depth change condition between the current simplified offset curve segment and a next simplified offset curve segment. When all depth values have been assigned, the method is complete.

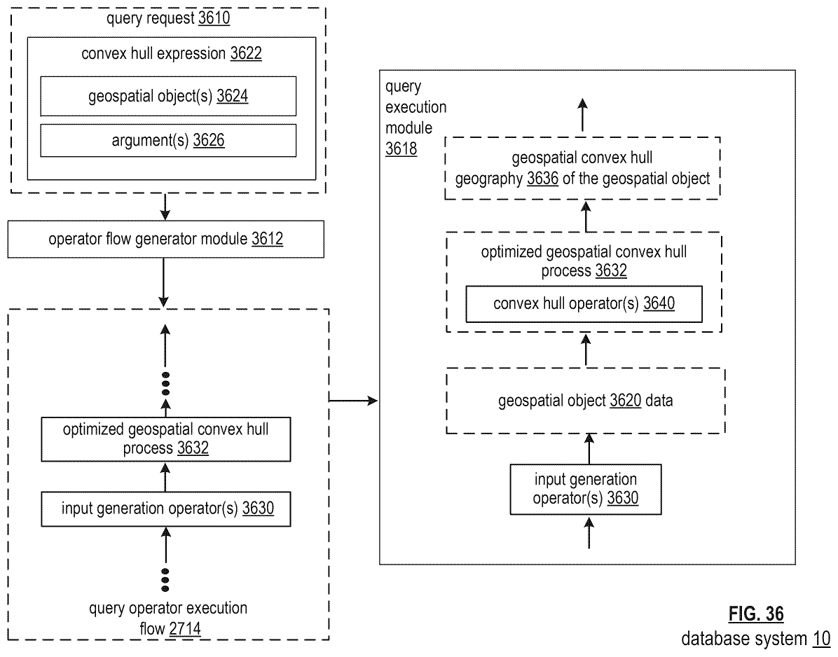

FIG. 36 36 is a schematic block diagram of an embodiment of a database system 10 executing an optimized geospatial convex hull process based on a convex hull expression 3622 of a query request 3610. The convex hull expression 3622 indicates one or more geospatial objects 3624 and optionally, one or more arguments 3626 for a geospatial convex hull process. A geospatial object 3624 is a representation of a geographic object, such as a place or thing that has a location on Earth. A geospatial object includes geospatial data made up of geometries such as one or more points, lines, and/or polygons.

A geospatial convex hull process indicated by the convex hull expression 3622 takes one or more geospatial objects such as a set of points on a spherical surface and returns a geography that represents the smallest convex geography that encloses all the geospatial objects of the input (e.g., the entire set of points). More particularly, a convex hull can be thought of as a polygon enclosing all points of an input where the vertices of the polygon maximize area while minimizing circumference.

The one or more optional arguments 3626 of the convex hull expression 3622 may include user specified parameters that indicate how the resulting geography is to be generated. For example, the one or more arguments 2728 may indicate error tolerances. When the one or more arguments are set by default, the one or more arguments may or may not be included in the convex hull expression since they are stored settings. The convex hull expression 3622 can be implemented as an SQL ST_ConvexHull or any other type of convex hull process in any query language.

The operator flow generator module 3612 can generate the query operator execution flow 3614 to indicate performance of an optimized geospatial convex hull process 3632 via one or more corresponding operators. The details of the optimized geospatial convex hull process will be discussed with reference to one or more of the following Figures. The operators of the optimized geospatial convex hull process 3632 can be configured based on the one or more geospatial objects 3624 and/or the one or more optional arguments 3626. The optimized geospatial convex hull process 3632 can be implemented via one or more serialized operators and/or multiple parallelized branches of operators configured to execute the corresponding buffer expression.

The operator flow generator module 3612 can generate the query operator execution flow 3614 to indicate performance of the optimized geospatial convex hull process 3632 upon output data blocks generated via one or more input generation operators 3630. For example, the input generation operators 3630 may include one or more serialized operators and/or multiple parallelized branches of operators utilized to retrieve a set of rows from memory, for example, to perform IO operations, to filter the set of rows, to manipulate and/or transform values of the set of rows to generate new values of a new set of rows for performing the optimized buffer process, or otherwise retrieve and/or generate the geospatial object 3620 data (e.g., an input row set indicating a set of points).

The query execution module 3618 can be implemented to execute the query operator execution flow 3614 to facilitate performance of the optimized geospatial convex hull process 3632 corresponding to the convex hull expression 3622. This can include executing the input generation operators 3630 to generate input data that may include a plurality of input rows. The plurality of input rows of an input row set can be generated via the input generation operators 3630 as a stream of data blocks sent to the optimized geospatial convex hull process 3632 for processing.

The optimized geospatial convex hull process 3632 can implement one or more convex hull operators 3640 to process a geospatial object input (e.g., an input row set) to generate a geospatial object convex hull geography (e.g., an output row set that includes a plurality of output rows). The one or more convex hull operators 3640 can be implemented as one or more operators configured to execute some or all of the corresponding optimized geospatial convex hull process 3632. The geospatial object convex hull geography 3636 may be generated as output rows of an output row set by the optimized geospatial convex hull process 3632 as a stream of data blocks emitted as a query resultant of the query request 3610 and/or sent to other operators serially after the optimized geospatial convex hull process 3632 for further processing.

The geospatial object convex hull geography 3636 may be output to at least one node of a plurality of nodes of the database system for use in a query request on a data set. For example, the query request includes the convex hull expression but also a data set for use with the resulting geospatial object convex geography. For example, the query relates to generating a geospatial object convex hull geography to determine an area of a location, and the data set relates to processing a function with data within the area. The geospatial convex hull geography 3636 may also be output as the query resultant on a data set. As another example, the geospatial object convex hull geography 3636 may be sent to memory for storage.

The query execution module 3618 may execute the query operator execution flow 3614 via a plurality of nodes 37 of a query execution plan 2405, for example, in accordance with nodes 37 participating across different levels of the plan (as discussed with reference to FIG. 24A, etc.). For example, the input generation operators 3630 are implemented via nodes at a first one or more levels of the query execution plan 2405, such as an IO level and/or one or more inner levels directly above the IO level.

The input generation operators 3630 can be implemented via a common set of nodes at these one or more levels. Alternatively, some of the input generation operators 3630 are processed via a first set of nodes of these one or more levels and some of the input generation operators 3630 are processed via a second set of nodes that have a non-null difference with and/or that are mutually exclusive with the first set of nodes.

The optimized geospatial convex hull process 3632 can be implemented via nodes at a second one or more levels of the query execution plan 2405, such as one or more inner levels directly above the first one or more levels, and/or the root level. For example, one or more nodes at the second one or more levels implementing the optimized geospatial convex hull process 3632 receive input rows for processing from child nodes implementing the input generation operators 3630. The one or more nodes implementing the optimized geospatial convex hull process 3632 at the second one or more levels can optionally belong to a same shuffle node set 2485 and can laterally exchange input rows with each other via one or more shuffle operators and/or broadcast operators via a corresponding shuffle network 2480.

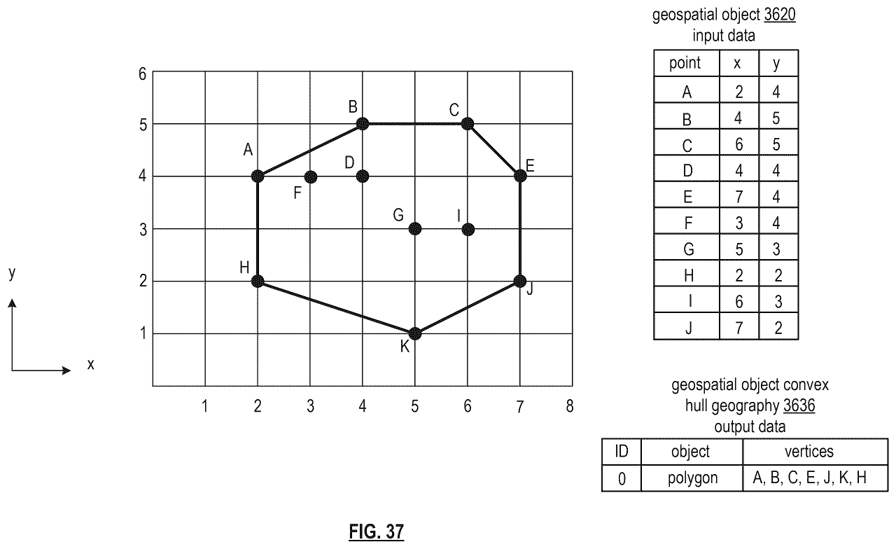

FIG. 37 is a diagram of an embodiment of a planar geospatial object convex hull geography 3636. In this example, the geospatial object 3620 input data is a data table representing a set of points (points A-J) having (x, y) coordinates. Data can be represented in many different formats and/or data structures other than the example shown. A geospatial convex hull process takes one or more geospatial objects such as a set of points (points A-J) and returns a geography that represents the smallest convex geography that encloses all the geospatial objects of the input (i.e., a polygon enclosing all points of an input where the vertices of the polygon maximize area while minimizing circumference).

Executing a geospatial convex hull process on the geospatial object 3620 input data produces a geospatial object convex hull geography 3636 output data as shown in the lower data table and plotted on the (x, y) plane. The geospatial object convex hull geography 3636 is a polygon (e.g., with an identifier (ID) of 0) represented by points A, B, C, E, J, K, and H which includes and/or encloses all the points in the input data set. As used herein, the term geography includes geometry data on planar coordinate systems.

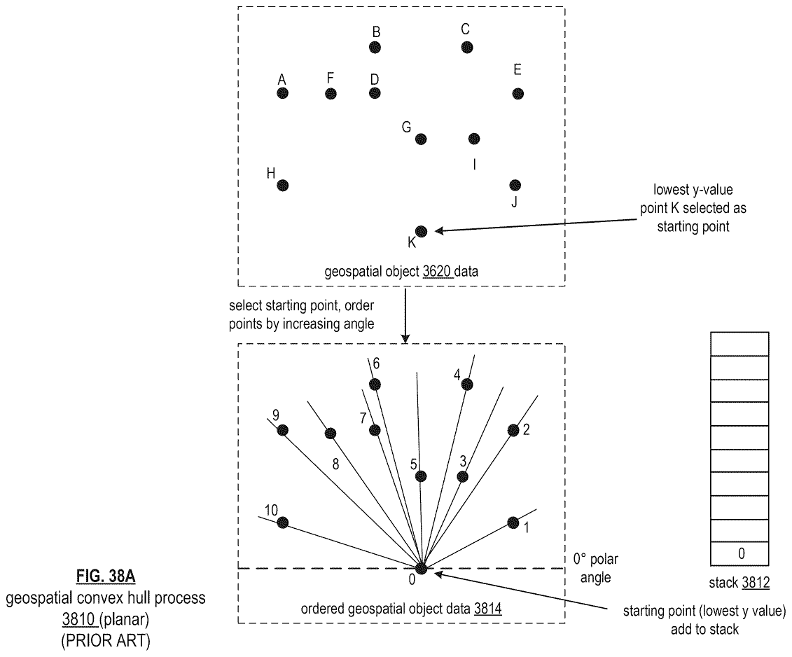

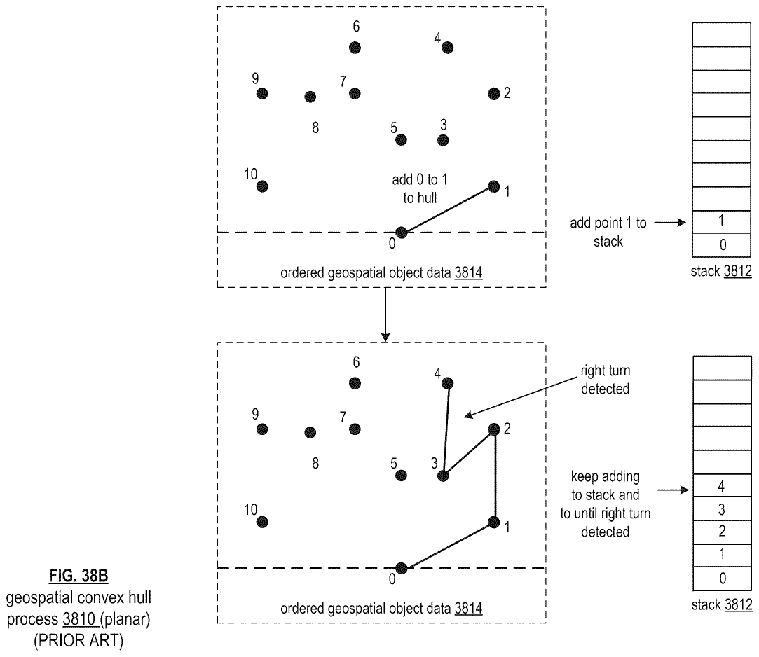

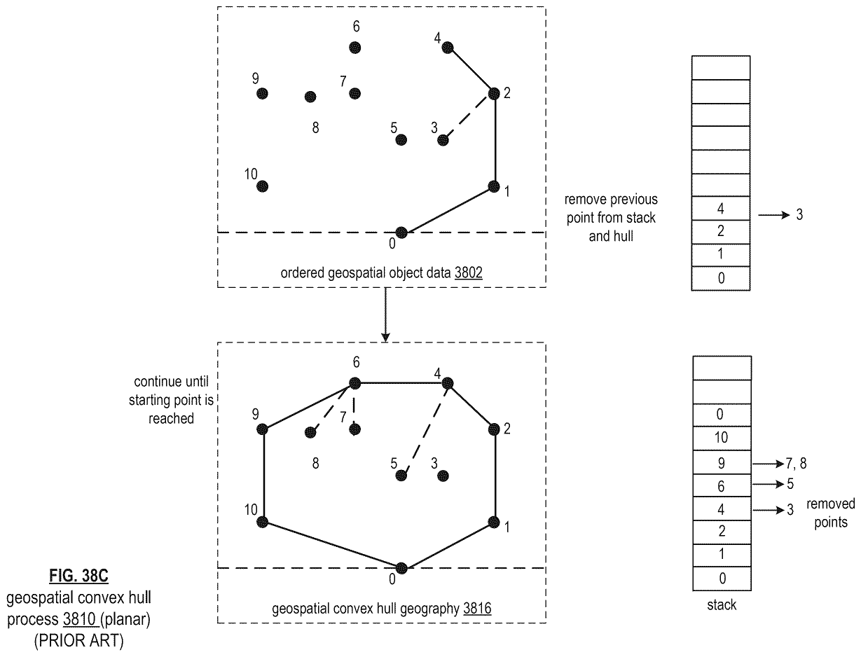

FIGS. 38A-38C are prior art diagrams of an embodiment of a planar geospatial convex hull process 3810 executable by a processing module of the database system (e.g., the query execution module). A known algorithm for determining a planar convex hull geography is the Graham scan algorithm. The Graham scan algorithm starts by determining a point that is guaranteed to be on the convex hull. For example, with a planar geography, a point with the smallest y-coordinate is often used. Here, the lowest point K of geospatial object 3620 is selected as the starting point because it has the lowest y-value of all the points in the geospatial object.

The Graham scan algorithm sorts the points by their polar angle with respect to the starting point in a sorted list such as a stack 3812 to produce ordered geospatial object data 3814 for the scan process. As shown, the points A-J are ordered from 1-10 according to their polar angle with respect to starting point 0. To initiate the scan, the starting point 0 is added to the stack 3812.

FIG. 38B continues the planar geospatial convex hull process 3810 example where a next point (point 1) is added to the geospatial convex hull geography and to the stack 3812. Each time a new point is added to stack 3812, the algorithm checks whether the last two points added to the stack 3812 form a right turn. If they do, then the last point in the stack 3813 is removed from the stack 3812 and not included in the geospatial convex hull geography. If the last two points do not form a right turn, the next point in the stack 3812 is included in the geospatial convex hull geography. In this example, a right turn is detected from point 2 to 3 to 4.

FIG. 38C continues the planar geospatial convex hull process 3810 example where when the right turn is detected from point 2 to 3 to 4, point 3 is eliminated from the stack 3812 and removed from the geospatial convex hull geography. This process continues until the starting point 0 is reached and the geospatial convex hull geography 3814 is determined.

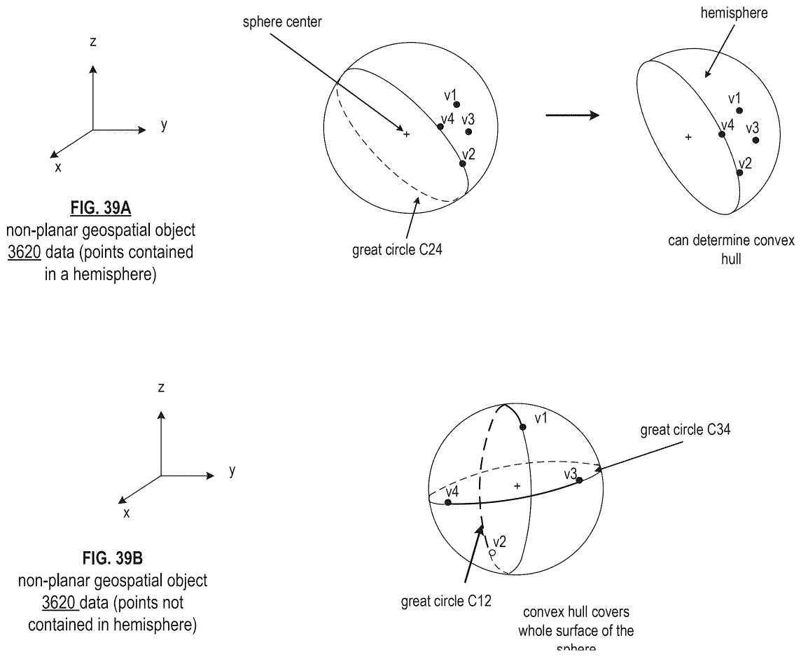

FIGS. 39A-39B are diagrams of embodiments of non-planar geospatial object 3620 data. FIG. 39A depicts an example of non-planar geospatial object 3620 such as a set of points (i.e., vertices) at v1, v2, v3, and v4 plotted on a spherical surface. Planar convex hull algorithms such as the Graham scan algorithm can be applied to non-planar geospatial objects, however, the algorithms require adaptation to the type of non-planar surface involved.

For example, with non-planar geospatial object data, an analogous starting point for the Graham scan algorithm (e.g., the point with the lowest y-value) or other planar algorithms is not guaranteed to be in the resulting convex hull geography. To adapt for this, one point from the geography (i.e., the geospatial object input data) and one reference point were sought so that the rest of the geography lied entirely to the one side of the great circle determined by those two points (i.e., whether all of the points lie within a hemisphere of the sphere). The planar adapted algorithm can then proceed by starting with the sought point from the geography. The non-existence of such points indicates that the resulting geospatial convex hull geography should be the entire sphere.

As shown in FIG. 39A, a great circle C24 is formed through vertices v2 and v4 and the rest of the geography (v1 and v3) is located to the right of the great circle C24. In this example, the set of points lie within a hemisphere of the sphere and a convex hull geography can be determined. Another way to phrase this is a convex hull geography can be determined when the set of points are in a Euclidean position. Points are in Euclidean position on a sphere when the points can be separated from the sphere center with a plane.

However, as shown in the example of FIG. 39B, the four points v1, v2, v3, and v4 of non-planar geospatial object 3620 are in a non-Euclidean position, meaning that the great circle C12 formed through points v1 and v2 splits the sphere into two hemispheres where one hemisphere contains point v4 and the other contains points v3. Similarly, the great circle C34 formed through points v3 and v4 splits the sphere into two hemispheres where one hemisphere contains point v1 and the other contains points v2. Joining points on these two great circles pairwise would cover the entire surface of the sphere such that the convex hull geography of this set of points is the whole sphere.

Therefore, it is an important step in using planar adapted convex hull algorithms on spherical geographies to determine whether the input data is contained in a hemisphere. Using the reference point and a point from the input to determine whether the input geography lies to one side of a great circle formed by those two points involves iterating over many of the points of the input geography, and, for each point, intersecting the entire geography with each of a fixed number of great circles. The runtime therefore tends to behave quadratically with the size of the input geography. At the time of the filing of the present patent application, current geospatial processes support geographies with up to approximately 32 million points. As such, computing geospatial convex hull geographies of large inputs in this manner can present a considerable performance problem.

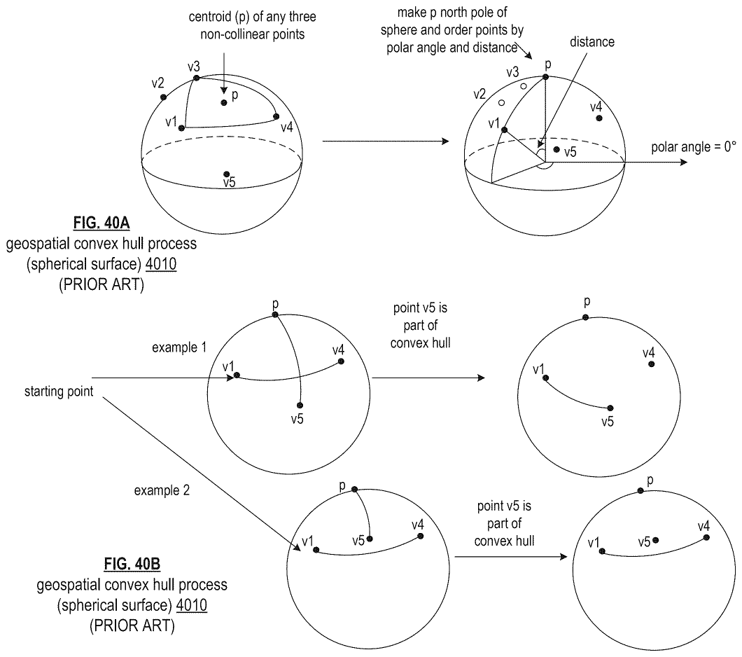

FIGS. 40A-40B are prior art diagrams of an embodiment of a planar geospatial convex hull process 4010 adapted for geospatial object(s) on a spherical surface. The planar geospatial convex hull process 4010 is in accordance with known methods. See CLARA I GRIMA & ALBERTO MARQUEZ, COMPUTATIONAL GEOMETRY ON SURFACES, 47-51 (2001). The geospatial objects are a set of points v1-v5 (i.e., also referred to herein as the input or input geography) plotted on a spherical surface. FIG. 40A illustrates locating a centroid point p from any three noncollinear points. For example, a centroid point p is located between points v1, v3 and v4. The coordinates of points v1-v5 are transformed to make point p the north pole of the sphere and then points v1-v5 are ordered by polar angle and distance from the point p. One of the furthest points from p (e.g., v1) is selected as a starting point for the planar adapted scan because it is likely on the geospatial convex hull geography.

FIG. 40B continues the example of the adapted for geospatial object(s) on a spherical surface. Using the selected starting point, v1, triples of consecutive points are examined by testing whether a line segment from reference point p to a point in the set of points intersects a segment created by consecutive points of the set of points. For example, in example 1, a segment from point p to point v5 intersects a segment from point v1 to point v4. This feature indicates that point v5 is part of the geospatial convex hull geography. Contrastingly, in example 2, a segment from point p to point v5 does not intersect the segment from point v1 to point v4. This feature indicates that point v5 is not in the geospatial convex hull geography and can be discarded from consideration.

To conduct the planar adapted convex hull algorithm, the algorithm must determine (in an efficient manner) whether the input geography lies inside some hemisphere or not.

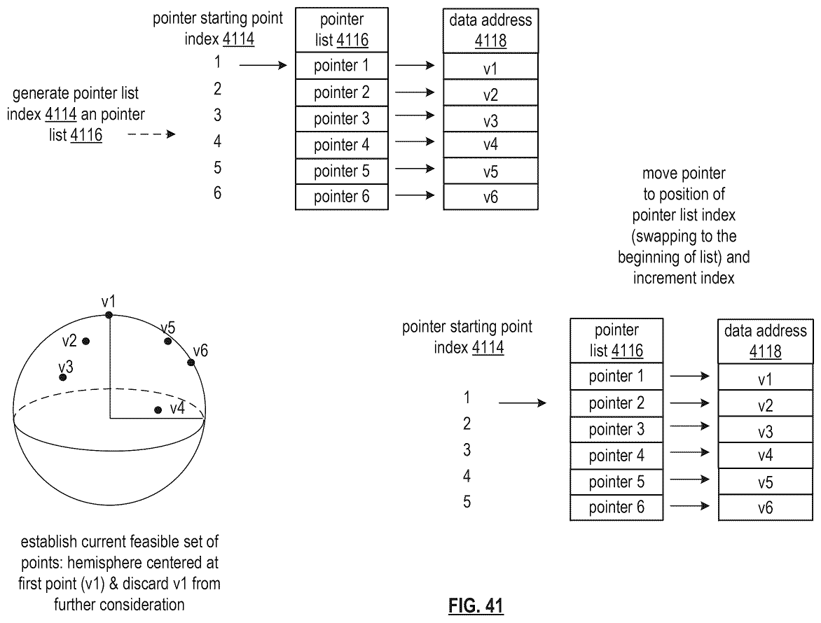

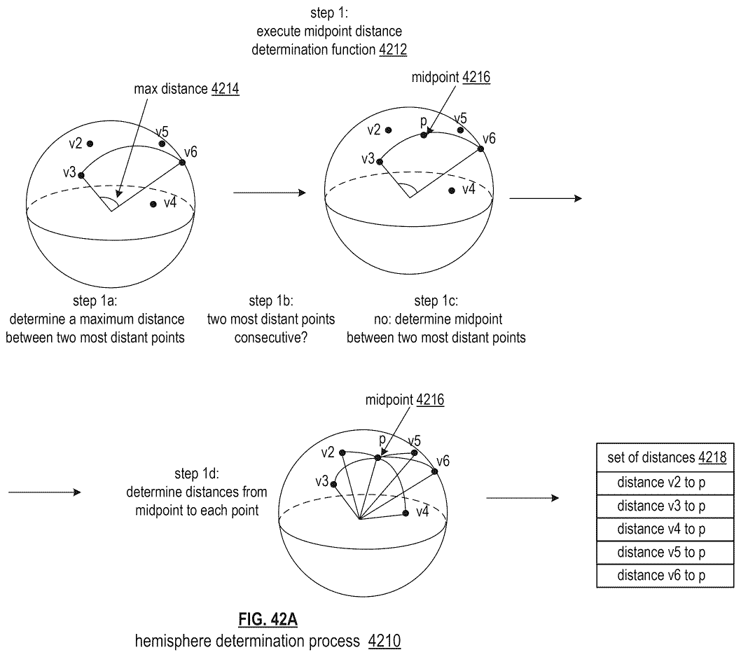

FIG. 41 is a diagram of an embodiment of initiating an optimized geospatial convex hull process for a geospatial object input that is a set of two or more points plotted on a surface of a sphere. A geospatial object input is also referred to herein as the input geography, a geospatial object, and/or the set of two or more points. When a query is identified indicating a geospatial convex hull expression for the set of two or more points, and after eliminating edge cases from consideration, the processing module generates a pointer list 4116 to each point of the set of two or more points (e.g., pointing to data addresses 4118 v1-v6) and a pointer starting point index 4114 that indicates the starting point for list of pointers. As shown, the starting point is currently at pointer 1 which points to point v1.

Edge cases that can be eliminated prior to forming the list of points include an input geography that consists of an empty set (which returns a hemisphere centered at a longitude-latitude position of (0,0) result), a single point (which returns a hemisphere centered at the point result), two antipodal points (which returns a no hemisphere result), and two non-antipodal points (which returns a hemisphere centered at the midpoint of two points result).

The processing module establishes a current feasible set of points by identifying points in a hemisphere of the sphere centered at a first point of the set of two or more points. The feasible set of points is a spherical polygon that must contain the center of a hemisphere that contains the input geography. In this example, the entire input geography (v1-v6) is contained in the current hemisphere centered on point v1.

The pointer list 4116 and pointer starting point index 4114 are used to order and reorder points during the optimized geospatial convex hull process and saves memory compared to storing a full copy. During the optimized geospatial convex hull process, points may be discarded from consideration by moving its associated pointer to the beginning of the pointer list 4116 and incrementing the pointer starting point index 4114. In this example, the processing module generates a list of pointers 4116 1-6 where each pointer points to a point of the set of points v1-v6 (e.g., data addresses 4118 for v1-v6). The pointer starting point index 4114 shows the order of pointers 1-6 in order from 1-6. Once the current feasible set of points is determined, the first point v1 can be discarded from consideration. In this case, pointer 1 to point v1 is already at the beginning of the pointer list 4116 but the pointer starting point index 4114 is incremented to show that pointer 2 to point v2 is now the first point in the current feasible the set of points that includes points v2-v6.

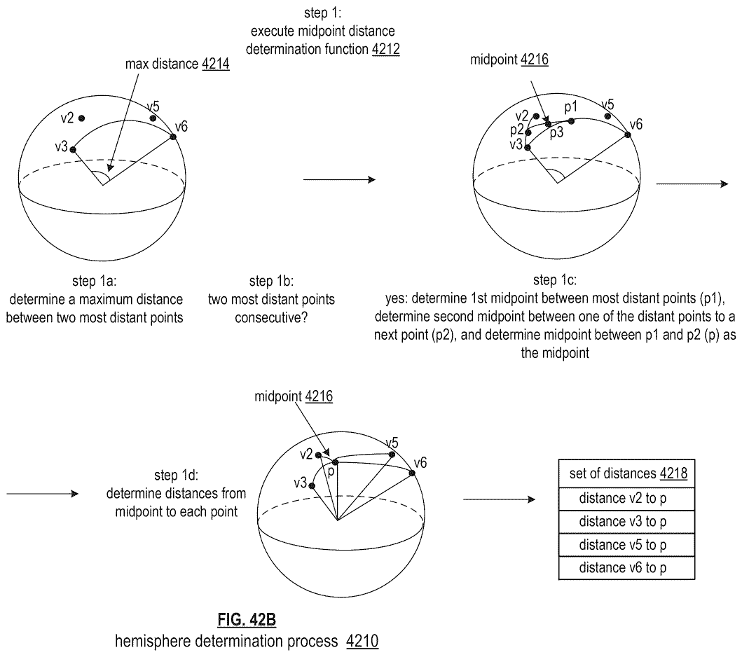

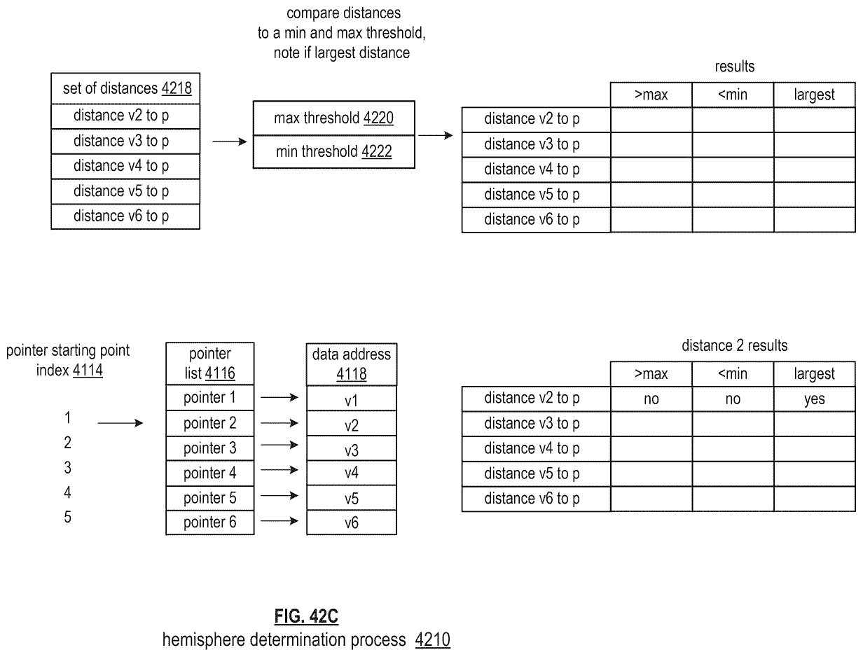

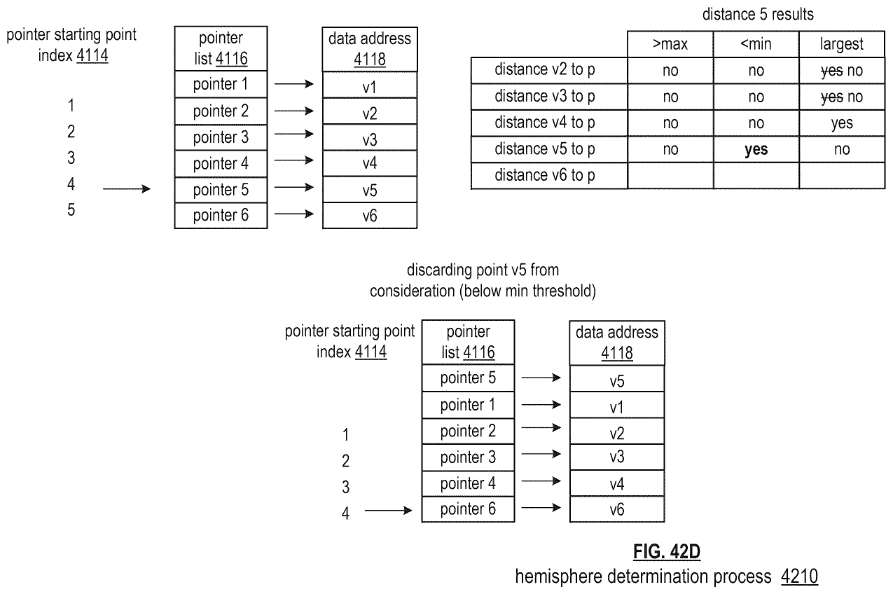

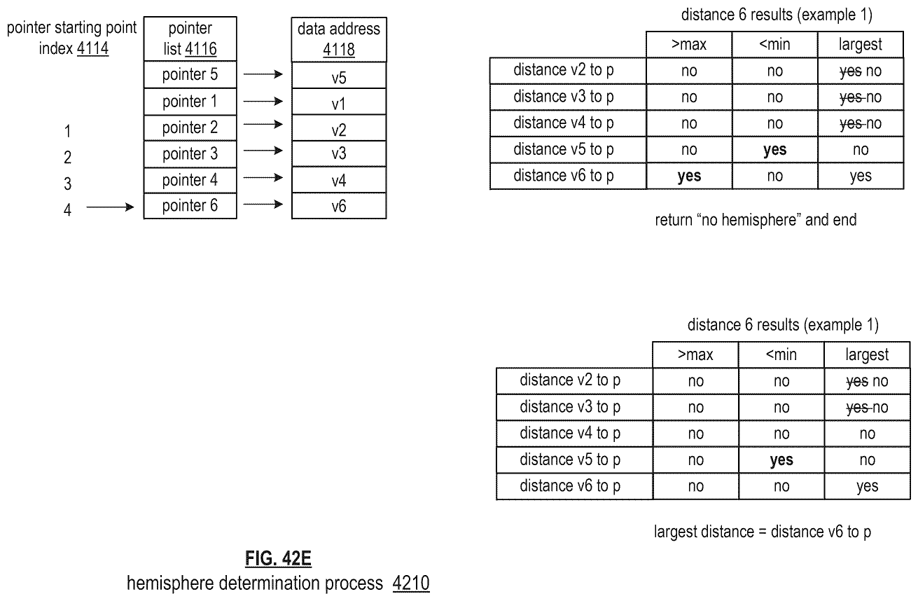

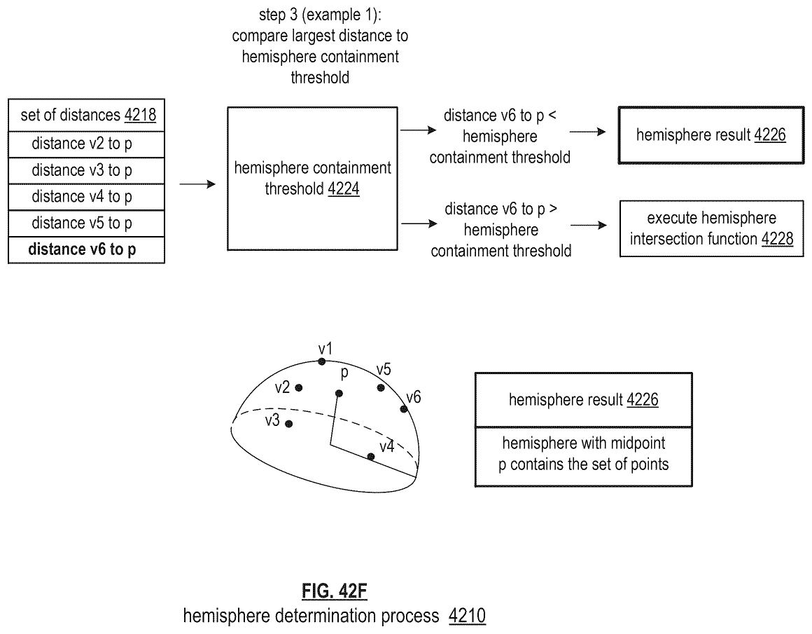

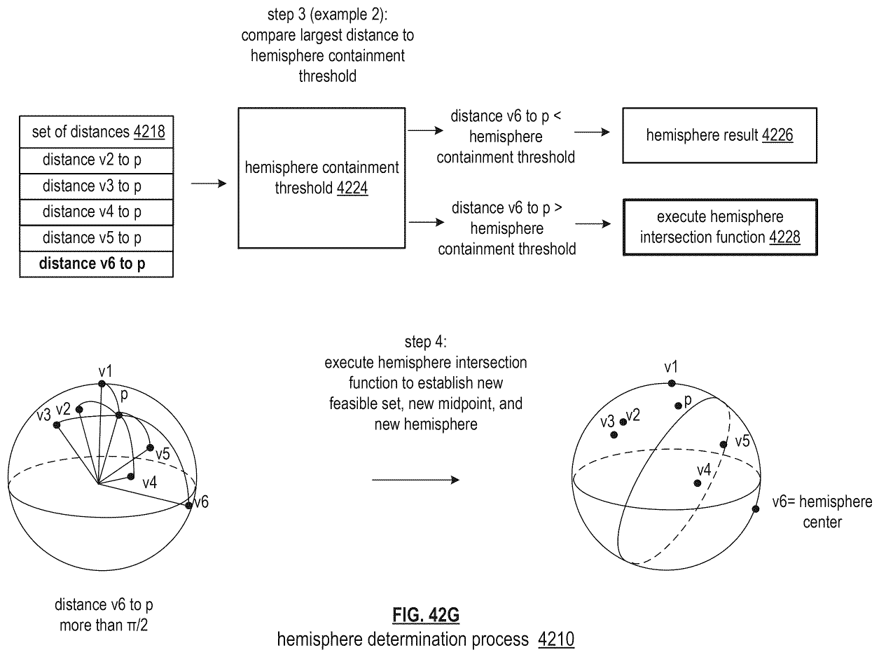

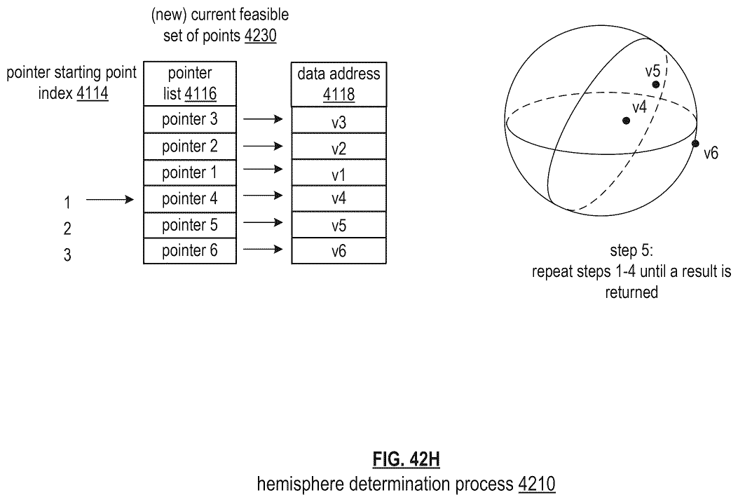

FIGS. 42A-42H are diagrams of an embodiment of a hemisphere determination process 4210 of the optimized geospatial convex hull process. The hemisphere determination process is repeated until either a “no hemisphere result” or a “hemisphere result” is produced. To improve performance of computing geospatial convex hull geography for data plotted on spherical surfaces, the optimized geospatial convex hull process includes a hemisphere determination process to identify a hemisphere that contains all the points of an input geospatial object (such as a set of points).

Identifying a hemisphere that contains the input geospatial object improves performance of the geospatial convex hull process because it does not require iterating over as many points of the input geography as with previous algorithms. When this hemisphere is identified, an adapted planar algorithm such as the Graham style scan discussed with reference to FIGS. 40A-40B can be used to more efficiently to determine the geospatial convex hull geography of a geospatial object on a spherical surface.

In FIG. 42A, the hemisphere determination process 4210 begins with step 1 where the processing module executes a midpoint distance determination function 4212 on the current feasible set of points to determine a current midpoint and a current set of distances. The midpoint distance determination function includes steps 1a-1d. In step 1a, the processing module determines a maximum distance value between two most distant points of the current feasible set of points. For example, the processing module uses a rotating-caliper method to determine that points v3 and v6 are separated by a larger distance than any other two points of the current feasible set of points.

The processing module stores the maximum distance value 4214 as the diameter of the input geography. Step 1b of the midpoint distance determination function 4212 includes determining whether the two most distance points are consecutive points. Consecutive points are points that form endpoints to a side of the input geography. If the two most distant points are consecutive, the midpoint is not in the interior of the feasible set of points. Because the midpoint is used to define the midpoint of a hemisphere that contains the input geography, the midpoint must be located in the interior of the current feasible set of points (i.e., the interior of the hull).

In this example, points v3 and v6 are not consecutive and the midpoint distance determination function 4212 continues with step 1c where the processing module determines a midpoint 4216 between the two most distant points (e.g., points v3 and v6) as a midpoint (p) (e.g., by using a midpoint calculation formula).

At step 1d, the processing module determines a distance from each point of the current feasible set of points to the midpoint 4216 to produce a set of distances 4218 (e.g., by using a known distance calculation formula). For example, the set of distances 4218 includes a distance from v2 to p, a distance from v3 to p, a distance from v4 to p, a distance from v5 to p, and a distance from v6 to p.

FIG. 42B illustrates another example of the processing module executing the midpoint distance determination function 4212 of the hemisphere determination process 4210 that includes steps 1a-1d. In this example, the current feasible set of points includes points v2, v3, v5, and v6 (point v4 has been eliminated for this particular example). At step 1a, the processing module determines a maximum distance value 4214 between two most distant points (points v3 and v6). At step 2b, the processing module determines that points v3 and v6 are consecutive (i.e., a line segment from v3 to v6 forms a side of the input geography). When the two most distant points are consecutive, a midpoint between those points is not in the interior of set of points and a new midpoint needs to be found.

The process continues with step 1c where the processing module determines a first midpoint (p1) between the two most distant points, a second midpoint (p2) between one of the two most distant points (e.g., v3) and a next point (e.g., v2), and then determines the midpoint (p) as the midpoint between the first and second midpoint. The midpoint p is now located in the interior of the current feasible set of points and can be used for the next stages of the hemisphere determination process.

At step 1d, the processing module determines a distance from each point of the set of points to the midpoint p to produce a set of distances 4218. For example, the set of distances 4218 includes a distance from v2 to p, a distance from v3 to p, a distance from v5 to p, and a distance from v6 to p.

FIG. 42C continues the example of the hemisphere determination process 4210 with step 2 where the processing module compares each distance of the set of distances 4218 to a maximum threshold 4220 and a minimum threshold 4222. For the remainder of the hemisphere determination process 4210, the example of FIG. 42A is continued (e.g., including point v4). If a point is further from the midpoint than π/2+diameter (e.g., a maximum threshold), then there is no hemisphere that contains the input geography, and the processing module returns a no hemisphere result indicating that the convex hull of the geospatial object is the entire sphere.

Some points can be discarded at this stage if their distance to the midpoint is less than π/2−diameter (e.g., a minimum threshold), as that distance is too small to eliminate any hemispheres centered in a feasible set of starting points from consideration. Points can be discarded by moving position of the pointer to the beginning of the pointer list 4116 and incrementing the pointer starting point index 4114. The pointers of points that have the largest distance from the midpoint are noted at this step.

As shown in FIG. 42C, a first set of results computed in the order of the pointer starting point index 4114 indicates that the distance from v2 to p (i.e., distance 2) is not greater than the maximum threshold and is not less than the minimum threshold. It is noted that distance 2 is the largest distance determined so far in the process.

FIG. 42D continues the example of the hemisphere determination process 4210 where a distance 5 (e.g., the distance from v5 to p) is less than a minimum threshold and is discarded from consideration in the hemisphere determination process 4210. Discarding points at an early stage reduces the time in computing future iterations. Here, point v5 is discarded by moving the point v5 pointer 5 to the beginning of the pointer list 4116 and incrementing the pointer starting point index 4414. The results also indicate that the largest distance so far is the distance from point v4 to p.

FIG. 42E continues the example of the hemisphere determination process 4210 where a distance 6 (e.g., the distance from v6 to p) is found to be greater than a maximum threshold and a “no hemisphere result” is produced. Producing the “no hemisphere result” ends the hemisphere determination process 4210. In a second example, the distance 6 is not greater than the maximum threshold and is noted as the largest distance of the set of distances.

FIG. 42F continues the example of the hemisphere determination process 4210 with step 3 where the largest distance of the set of distances 4218 is compared to a hemisphere containment threshold 4224. For example, the largest distance is the distance from v6 to p and the hemisphere containment threshold 4224 is π/2. In this example, the distance from v6 to p is less than the hemisphere containment threshold 4224 and the processing module returns the “hemisphere result” 4226. The hemisphere result 4226 indicates that a hemisphere centered at the current midpoint contains the entire input geography.

FIG. 42G illustrates a second example of step 3 of the hemisphere determination process 4210 where the largest distance of the set of distances 4218 is compared to the hemisphere containment threshold 4224 and the largest distance (e.g., distance 6, the distance from v6 to p) is not less than the hemisphere containment threshold 4224. When the largest distance is not less than the hemisphere containment threshold 4224 (e.g., π/2), the processing module determines to execute a hemisphere intersection function 4228.

At step 4, the processing module executes the hemisphere intersection function on the current feasible set of points to produce a new feasible set of points by intersecting the current feasible set of points with a hemisphere centered at the point associated with the largest distance from the midpoint (v6). The intersection may be computed using existing techniques to intersect spherical polygons. In this example, point v5 is included and shown in a new position such that it is not removed from the current feasible set.

FIG. 42H continues the example of the hemisphere determination process 4210 and depicts the new current feasible set of points 4230 defined by a new hemisphere as determined by the hemisphere intersection function 4210. Intersecting the previous feasible set of points set with a new hemisphere cuts the previous feasible set of points approximately in half, as the previous midpoint is removed. For example, the new hemisphere centered at point v6 includes the new feasible set of points v4-v6. The hemisphere determination process 4210 continues with step 5 where steps 1-4 are repeated using the new values until a result (e.g., “no hemisphere result” or “hemisphere result”) is received.

The hemisphere determination process 4210 thus can be used to determine whether the entire input geography is contained within a hemisphere. When the input geography is contained within a particular hemisphere, an adapted planar convex hull algorithm can be implemented to produce the geospatial convex hull geography in a much more efficient manner.

For the inner loop of the hemisphere determination process, finding the midpoint of the current feasible set is constant time, finding the set of distances is linear to the size of the input geography, and finding the intersection of the current feasible set with a hemisphere is (at worst case) linear in the size of the current feasible set as the size of a hemisphere polygon is constant. As the feasible set of points tends to be cut approximately in half on every execution of the inner loop, the outer loop tends to exhibit logarithmic (in the size of the input geography) behavior such that the diameter of the feasible set of points drops rapidly, greatly increasing the likelihood of finding either a point that is “too far away” for a containing hemisphere to exist, or finding that all points are close enough and that a containing hemisphere is already identified. Even when neither of these happen, there is still the likelihood of eliminating points close to the feasible set of points from consideration, further speeding up future iterations.

In practice, for common input geographies (states, countries and other politically bounded regions, lakes, rivers) which are “small” compared to the entire earth, the outer loop only needs to iterate one time, and the hemisphere determine process is linear. A worst-case input is a geography consisting of many points tightly clustered along the entirety of one side of a great circle arc. Even in this case, the geography will need several points extremely close to the great circle arc to lead to more than a handful of outer loop iterations. As the rest of the convex hull process (after determining the existence of a containing hemisphere) is O(n ln n), both parts of the optimized geospatial convex hull process are now (approximately) is O(n ln n), and the entire algorithm has greatly improved performance over the original, worst-case O(n²) algorithm. For large data sets containing tens of millions of points, the difference between an O(n²) and O(n ln n) is significant.

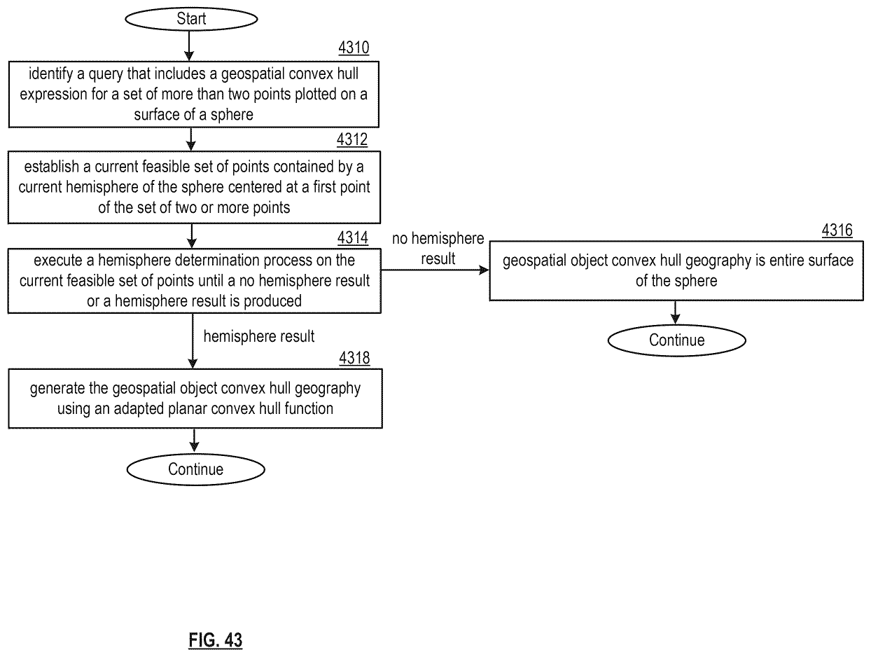

FIG. 43 is a flowchart of an example of a method of an optimized geospatial convex hull process executable by a processing module of the database system (e.g., a query execution module). The method starts with step 4310 where the processing module identifies a query that includes a geospatial convex hull expression for a geospatial object. The geospatial object in this process includes a set of more than two points plotted on a surface of a sphere. The geospatial object is also referred to herein as the input geography. Upon identifying the query, the processing module generates a list of pointers to each point of the set of two or more points and a pointer starting point index that indicates a starting point for list of pointers.

When a geospatial object includes a set of two points or less, certain edge cases are addressed in a simple manner without the need to execute the full optimized geospatial convex hull process. For example, edge cases include one of an input geography that consists of an empty set (which returns a hemisphere centered at a longitude-latitude position of (0,0) result), a single point (which returns a hemisphere centered at the point result), two antipodal points (which returns a no hemisphere result), and two non-antipodal points (which returns a hemisphere centered at the midpoint of two points result).

A geospatial convex hull process indicated by a geospatial convex hull expression takes a geospatial object such as the set of more than two points and returns a geospatial convex hull geography that represents the smallest convex geography that encloses all the geospatial object. More particularly, a convex hull can be thought of as a polygon enclosing all points of an input geography where the vertices of the polygon maximize area while minimizing circumference. The geospatial convex hull expression can be implemented as an SQL ST_ConvexHull or any other type of convex hull process in any query language and may include one or more optional arguments such as a user specified error tolerance.

An adapted planar algorithm (such as a Graham scan type algorithm) can be used to determine the geospatial convex hull geography of a set of more than two points plotted on a spherical surface, however it is necessary to determine a starting point that is located on the geospatial convex hull geography. Previous methods involve locating a reference point and any point from the input and determining whether the rest of the input geography lies to one side of a great circle formed by those two points.

These previous methods involve iterating over many of the points of the input geography, and, for each point, intersecting the entire geography with each of a fixed number of great circles. The runtime therefore tends to behave quadratically with the size of the input geography (i.e., O(n²)). At the time of the filing of the present patent application, current geospatial processes support geographies with up to approximately 32 million points. As such, computing geospatial convex hull geographies of large inputs in this manner presents a considerable performance problem.

To address this performance issue, the method continues with step 4312 where the processing module establishes a current feasible set of points of the set of two or more points contained by a current hemisphere of the sphere centered at a first point of the set of two or more points. The processing module establishes a current feasible set of points by identifying points in the hemisphere of the sphere centered at a first point of the set of two or more points.

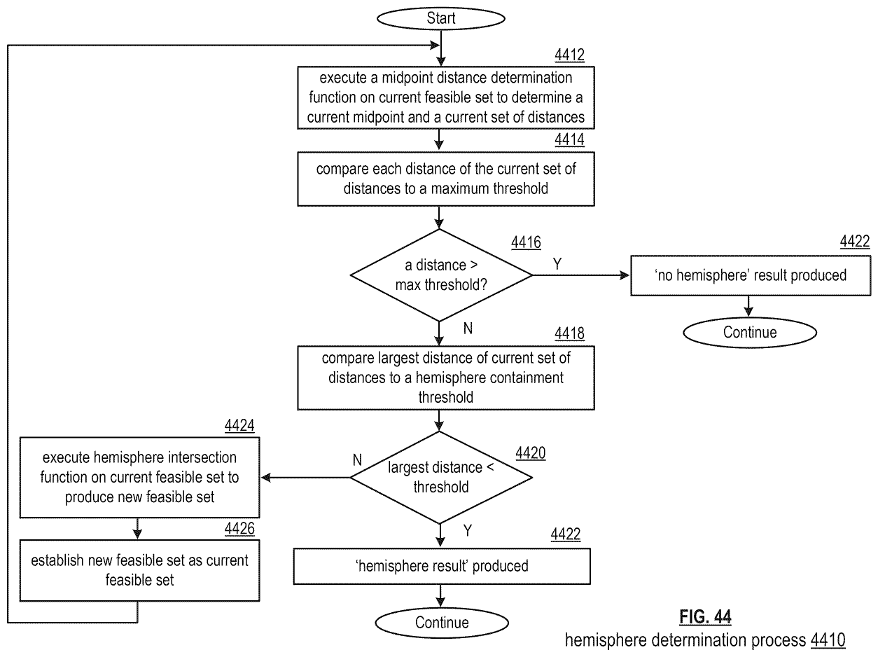

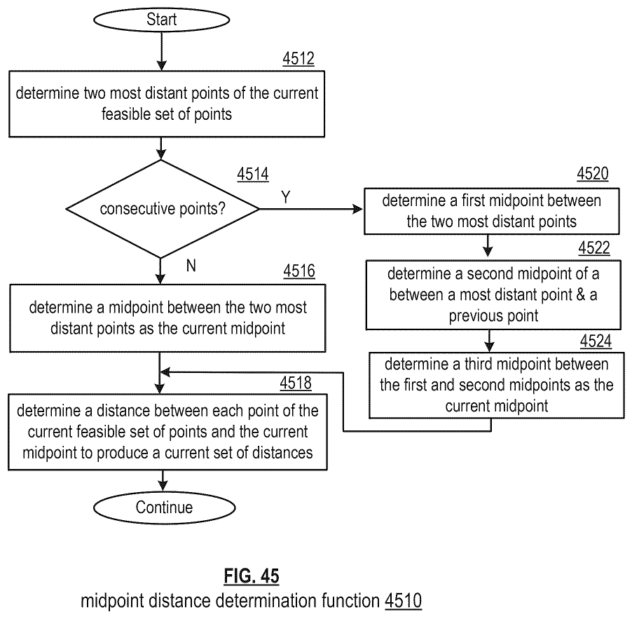

The method continues with step 4314 where the processing module executes a hemisphere determination process on the current feasible set of points until a no hemisphere result or a hemisphere result is produced. The hemisphere determination process will be discussed in more detail with reference to FIGS. 44-45. When a no hemisphere result is produced, the method continues with step 4316 where the processing module determines that the geospatial convex hull geography is the entire surface of the sphere. When a hemisphere result is produced, the method continues with step 4318 where the processing module generates the geospatial convex hull geography of the set of points using an adapted planar convex hull function such as an adapted Graham scan type algorithm as discussed with reference to FIGS. 40A-40B. By identifying a hemisphere that contains the input geography the processing module can implement an adapted planar convex hull function more efficiently to determine the geospatial convex hull geography.

FIG. 44 is a flowchart of an example of a method of executing a hemisphere determination process 4410 of the optimized geospatial convex hull process. The method begins with step 4412 where a processing module of a database system (e.g., the query execution module) executes a midpoint distance determination function on the current feasible set of points to determine a current midpoint and a current set of distances. The midpoint distance determination function will be discussed in greater detail with reference to FIG. 45.

The method continues with step 4414 where the processing module compares each distance of the set of distances to a maximum threshold. For example, the maximum threshold may be π/2+diameter where the diameter is the distance between the two most distant points of the current feasible set of points. When a distance is greater than the maximum threshold, the method continues with step 4422 where a no hemisphere result is produced. A no hemisphere result indicates no hemisphere contains the input geography and the geospatial convex hull geography of the geospatial object is the entire sphere.

Some points can also be discarded at this stage if a distance is less than π/2−diameter (e.g., a minimum threshold), as that distance is too small to eliminate any hemispheres centered in a feasible set of starting points from consideration. Points can be discarded by moving position of the pointer to the beginning of the pointer list and incrementing the pointer starting point index. The pointers of points that have the largest distance from the midpoint are noted.

When each distance is not greater than the maximum threshold, the method continues with step 4418 where the processing module compares a largest distance of the current set of distances with a hemisphere containment threshold. For example, the hemisphere containment threshold is π/2.

When the largest distance of the current set of distances is less than the hemisphere containment threshold, the method continues with step 4422 where the processing module produces the hemisphere result. A hemisphere result indicates that a hemisphere centered at the current midpoint contains the entire input geography.

When the largest distance of the current set of distances is not less than the hemisphere containment threshold, the method continues with step 4424 where the processing module executes a hemisphere intersection function on the current feasible set of points to produce a new feasible set of points and a new hemisphere. For example, the processing module executes the hemisphere intersection function by intersecting the current feasible set of points with a hemisphere centered at the point associated with the largest distance from the current midpoint. The intersection may be computed using existing techniques to intersect spherical polygons.

The method continues with step 4426 where the processing module establishes the new feasible set of points as the current feasible set of points and the new hemisphere as the current hemisphere. The method branches back to step 4412 where the processing module repeats the hemisphere determination function using the new feasible set of points as the current feasible set of points and the new hemisphere as the current hemisphere.

FIG. 45 is a flowchart of an example of a method of a midpoint distance determination function 4510 of a hemisphere determination process. The method begins with step 4512 where the processing module of the database system (e.g., the query execution module) two most distant points of the current feasible set of points. The two most distant points are separated by a larger distance than any other two points of the current feasible set of points. The distance between the two most distant points is noted as the diameter of the current feasible set of points. For example, the processing module uses a rotating-caliper method to determine the two most distant points.

The method continues with step 4514 where the processing module determines with the two most distant points are consecutive points. Consecutive points are points that form endpoints to a side of the input geography. If the two most distant points are consecutive, the midpoint is not in the interior of the feasible set of points. Because the midpoint is used to define the midpoint of a hemisphere that contains the input geography, the midpoint must be located in the interior of the current feasible set of points (i.e., the interior of the hull).

When the two most distant points are not consecutive, the method continues with step 4516 where the processing module determines a midpoint (as the current midpoint) between the two most distant points (e.g., by using a midpoint calculation formula). The method continues with step 4518 where the processing module determines a distance between each point of the current feasible set of points and the current midpoint to produce a current set of distances.

When the two most distant points are consecutive, the method continues with step 4520 where the processing module determines a first midpoint between the two most distant points. The method continues with 4522 where the processing module determines a second midpoint between one of the two most distant points and a next (or previous) point. The method continues with step 4524 where the processing module determines a third midpoint between the first midpoint and the second midpoint as the current midpoint. The current midpoint is now located in the interior of the current feasible set of points and can be used for the next stages of the hemisphere determination process. The method continues with step 4518 where the processing module determines a distance between each point of the current feasible set of points and the current midpoint to produce a current set of distances.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

The preceding technical discussion may include a discussion regarding one or more of: an advantage(s) of a solution(s) to a problem(s), a benefit(s) of a solution(s) to a problem(s), an issue(s) giving rise to a problem(s), a market need(s) for a solution(s) to a problem(s), a value proposition(s) of a solution(s) to a problem(s), and/or the like. As may be applicable, the determining of an advantage(s) of a solution(s) to a problem(s), the determination of a benefit(s) of a solution(s) to a problem(s), the determination of an issue(s) giving rise to a problem(s), the determination of a market need(s) for solving a problem(s), the determination of a value proposition(s) for solving a problem(s), and/or the like can be deemed as one or more discoveries that constitute an invention and/or constitute part of an inventive step to create an invention.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising;
identifying, by a processing module of a database system, a query that includes a geospatial buffer expression for a geospatial object;
obtaining, by the processing module, the geospatial object based on the geospatial buffer expression;
executing, by the processing module, a geospatial object simplification function on the geospatial object to produce a simplified geospatial object;
executing, by the processing module, an offset curve function on the simplified geospatial object to produce one or more offset curves;
executing, by the processing module, an offset curve segment loop elimination function on the one or more offset curves to produce one or more simplified offset curves; and
executing, by the processing module, a depth analysis function on the one or more simplified offset curves to produce a geospatial object buffer geography of the geospatial object, wherein the depth analysis function identifies and eliminates portions of the one or more simplified offset curves that are located inside the geospatial object buffer geography.

2. The method of claim 1, wherein the executing the offset curve function comprises:
identifying, by the processing module, geospatial object segments of the simplified geospatial object;
traversing, by the processing module, the geospatial object segments in a first direction, wherein for each geospatial object segment of the geospatial object segments, a first geospatial object offset curve segment is generated to produce first geospatial object offset curve segments;
joining, by the processing module, the first geospatial object offset curve segments to produce a first offset curve;
determining, by the processing module, whether to produce a full buffer on the geospatial object;
when the processing module determines to produce the full buffer:
determining, by the processing module, whether the geospatial object is an open geography; and
when the geospatial object is the open geography:
generating, by the processing module, endpoint offsets for the geospatial object; and
joining, by the processing module, the first offset curve and the endpoint offsets to produce the one or more offset curves; and
when the geospatial object is not an open geography:
interpreting, by the processing module, the first offset curve as the one or more offset curves; and
when the processing module determines to not produce the full buffer:
traversing, by the processing module, the geospatial object segments in a second direction, wherein for each geospatial object segment of the geospatial object segments, a second geospatial object offset curve segment is generated to produce second geospatial object offset curve segments;
joining, by the processing module, the second geospatial object offset curve segments to produce a second offset curve;
determining, by the processing module, whether the geospatial object is the open geography; and
when the geospatial object is the open geography:
generating, the processing module, the endpoint offsets for the geospatial object; and
joining, the processing module, the first offset curve, the second offset curve, and the endpoint offsets to produce the one or more offset curves; and
when the geospatial object is not the open geography:
interpreting, by the processing module, the first and second offset curves as the one or more offset curves.

3. The method of claim 2 further comprises:
when a geospatial object segment of the geospatial object segments is longer than a tolerance threshold, adding, by the processing module, one or more points to the geospatial object segment to break the geospatial object segment into two or more geospatial object segments.

4. The method of claim 1, wherein the executing the offset curve segment loop elimination function comprises:
analyzing, by the processing module, the one or more offset curves to identify one or more simplification features, wherein the one or more simplification features include one or more consecutive right turns present in the one or more offset curves;
when the one or more simplification features are identified:
analyzing, by the processing module, the one or more offset curves to identify one or more loop conditions; and
when the one or more loop conditions are identified:
eliminating, by the processing module, one or more loops indicated by the one or more loop conditions from the one or more offset curves to produce the one or more simplified offset curves; and
when the one or more loop conditions are not identified:
using, by the processing module, the one or more offset curves as the one or more simplified offset curves; and
when the one or more simplification features are not identified:
using, by the processing module, the one or more offset curves as the one or more simplified offset curves.

5. The method of claim 4, wherein the analyzing the one or more offset curves to identify the one or more loop conditions comprises:
grouping, by the processing module, a plurality of offset curve segments and a plurality of offset curve joins of the one or more offset curves into right turn groups and no right turn groups, wherein the right turn groups include offset curve segments and offset curve joins of the plurality of offset curve segments and the plurality of offset curve joins that form right turns and the no right turn groups include offset curve segments and offset curve joins of the plurality of offset curve segments and the plurality of offset curve joins that do not form right turns;
for each right turn group of the right turn groups, concatenating, by the processing module, a proceeding no right turn group of the no right turn groups and a following no right turn group of the no right turn groups with the right turn group to form one or more offset curve segment groups of the one or more offset curves;
for each offset curve segment group of the one or more offset curve segment groups:
identifying, by the processing module, intersection points to produce one or more offset curve segment groups with ordered intersection points;
when an ordered intersection point appears both first and last in the offset curve segment group with ordered intersection points:
identifying, by the processing module, the ordered intersection point as a loop condition of the one or more loop conditions; and
identifying, by the processing module, the offset curve segments and offset curve joins of the offset curve segment group with ordered intersection points between the ordered intersection point as a loop of the one or more loops.

6. The method of claim 1, wherein the executing the depth analysis function comprises:
determining, by the processing module, that the one or more simplified offset curves include one or more intersections;
splitting, by the processing module, the one or more simplified offset curves into a plurality of simplified offset curve segments based on the one or more intersections;
assigning, by the processing module, a current depth value to a current simplified offset curve segment of the plurality of simplified offset curve segments;
analyzing, by the processing module, a next simplified offset curve segment of the plurality of simplified offset curve segments for a depth change condition between the current simplified offset curve segment and the next simplified offset curve segment; and
when the depth change condition is detected:
determining, by the processing module, whether the depth change condition indicates a depth increase between the current simplified offset curve segment and the next simplified offset curve segment or a depth decrease between the current simplified offset curve segment and the next simplified offset curve segment;
when the depth change condition indicates the depth increase:
assigning, by the processing module, an increased depth value to the next simplified offset curve segment; and
when the depth change condition indicates the depth decrease:
assigning, by the processing module, a decreased depth value to the next simplified offset curve segment; and
when the depth change condition is not detected:
maintaining, by the processing module, a current depth value for the next simplified offset curve segment; and
traversing, by the processing module, the plurality of simplified offset curve segment to assign depth values to each next simplified offset curve segments of the plurality of simplified offset curve segments until each simplified offset curve segment of the plurality of simplified offset curve segments is assigned a corresponding depth value; and
generating, by the processing module, the geospatial object buffer geography of the geospatial object by eliminating simplified offset curve segments of the plurality of simplified offset curve segments assigned a depth value above a depth threshold.

7. The method of claim 6, wherein the analyzing the next simplified offset curve segment for the depth change condition comprises:
determining, by the processing module, that the current simplified offset curve segment ends with an intersection point of the one or more intersection points.

8. The method of claim 6 further comprises:
when the plurality of simplified offset curve segments are traversed in a first direction, and a next simplified offset curve segment is selected left of the current simplified offset curve:
when the current offset curve segment is oriented away from the first direction from a perspective of an intersection point and the next simplified offset curve segment is oriented toward the first direction from the perspective of the intersection point, determining, by the processing module, that the depth change condition indicates the depth increase; and
when the current offset curve segment is oriented toward the first direction from the perspective of the intersection point and the next offset simplified curve segment is oriented away from the first direction from the perspective of the intersection point, determining, by the processing module, that the depth change condition indicates the depth decrease.

9. The method of claim 6, wherein the generating the geospatial object buffer geography further comprises:
selecting, by the processing module, a simplified offset curve segment assigned the depth value below the depth threshold as an initial simplified offset curve segment;
starting from the initial simplified offset curve segment, traversing, by the processing module, the one or more simplified offset curves; and
when an intersection point of the one or more intersections is encountered, proceeding, by the processing module, to the next simplified offset curve segment that is assigned the depth value below the threshold, such that simplified offset curve segments of the plurality of simplified offset curve segments assigned the depth value above the depth threshold are eliminated from the geospatial object buffer geography.

10. The method of claim 1 further comprises one or more of:
outputting, by the processing module, the geospatial object buffer geography to at least one node of a plurality of nodes of the database system for use in the query on a data set;
storing, by the processing module, the geospatial object buffer geography to memory of the database system; and
providing, by the processing module, the geospatial object buffer geography to a requester of the query.

11. A non-transitory computer readable storage medium comprises:
a first memory section that stores operational instructions that, when executed by a processing module of a database system, causes the processing module to:
identify a query that includes a geospatial buffer expression for a geospatial object; and
obtain the geospatial object based on the geospatial buffer expression; and
a second memory section that stores operational instructions that, when executed by the processing module, causes the processing module to:
execute a geospatial object simplification function on the geospatial object to produce a simplified geospatial object;
execute an offset curve function on the simplified geospatial object to produce one or more offset curves;
execute an offset curve segment loop elimination function on the one or more offset curves to produce one or more simplified offset curves; and
execute a depth analysis function on the one or more simplified offset curves to produce a geospatial object buffer geography of the geospatial object, wherein the depth analysis function identifies and eliminates portions of the one or more simplified offset curves that are located inside the geospatial object buffer geography.

12. The non-transitory computer readable storage medium of claim 11, wherein the second memory section further stores operational instructions that, when executed by the processing module, causes the processing module to execute the offset curve function by:
identifying geospatial object segments of the simplified geospatial object;
traversing the geospatial object segments in a first direction, wherein for each geospatial object segment of the geospatial object segments, a first geospatial object offset curve segment is generated to produce first geospatial object offset curve segments;
joining the first geospatial object offset curve segments to produce a first offset curve;
determining whether to produce a full buffer on the geospatial object;
when the full buffer is determined to be produced:
determine whether the geospatial object is an open geography; and
when the geospatial object is the open geography:
generate endpoint offsets for the geospatial object; and
join the first offset curve and the endpoint offsets to produce the one or more offset curves; and
when the geospatial object is not an open geography:
interpret the first offset curve as the one or more offset curves; and
when the full buffer is not determined to be produced:
traverse the geospatial object segments in a second direction, wherein for each geospatial object segment of the geospatial object segments, a second geospatial object offset curve segment is generated to produce second geospatial object offset curve segments;
join the second geospatial object offset curve segments to produce a second offset curve;
determine whether the geospatial object is the open geography; and
when the geospatial object is the open geography:
generate the endpoint offsets for the geospatial object; and
join the first offset curve, the second offset curve, and the endpoint offsets to produce the one or more offset curves; and
when the geospatial object is not the open geography:
interpret the first and second offset curves as the one or more offset curves.

13. The non-transitory computer readable storage medium of claim 12, wherein the second memory section further stores operational instructions that, when executed by the processing module, causes the processing module to:
when a geospatial object segment of the geospatial object segments is longer than a tolerance threshold, add one or more points to the geospatial object segment to break the geospatial object segment into two or more geospatial object segments.

14. The non-transitory computer readable storage medium of claim 11, wherein the second memory section further stores operational instructions that, when executed by the processing module, causes the processing module to execute the offset curve segment loop elimination function by:
analyzing the one or more offset curves to identify one or more simplification features, wherein the one or more simplification features include one or more consecutive right turns present in the one or more offset curves; and
when the one or more simplification features are identified:
analyzing the one or more offset curves to identify one or more loop conditions; and
when the one or more loop conditions are identified:
eliminating one or more loops indicated by the one or more loop conditions from the one or more offset curves to produce the one or more simplified offset curves; and
when the one or more loop conditions are not identified:
using the one or more offset curves as the one or more simplified offset curves; and
when the one or more simplification features are not identified:
using the one or more offset curves as the one or more simplified offset curves.

15. The non-transitory computer readable storage medium of claim 14, wherein the second memory section further stores operational instructions that, when executed by the processing module, causes the processing module to analyze the one or more offset curves to identify the one or more loop conditions by:
grouping a plurality of offset curve segments and a plurality of offset curve joins of the one or more offset curves into right turn groups and no right turn groups, wherein the right turn groups include offset curve segments and offset curve joins of the plurality of offset curve segments and the plurality of offset curve joins that form right turns and the no right turn groups include offset curve segments and offset curve joins of the plurality of offset curve segments and the plurality of offset curve joins that do not form right turns;
for each right turn group of the right turn groups, concatenating a proceeding no right turn group of the no right turn groups and a following no right turn group of the no right turn groups with the right turn group to form one or more offset curve segment groups of the one or more offset curves;
for each offset curve segment group of the one or more offset curve segment groups:
identifying intersection points to produce one or more offset curve segment groups with ordered intersection points;
when an ordered intersection point appears both first and last in the offset curve segment group with ordered intersection points:
identifying the ordered intersection point as a loop condition of the one or more loop conditions; and
identifying the offset curve segments and offset curve joins of the offset curve segment group with ordered intersection points between the ordered intersection point as a loop of the one or more loops.

16. The non-transitory computer readable storage medium of claim 11, wherein the second memory section further stores operational instructions that, when executed by the processing module, causes the processing module to execute the depth analysis function by:
determining that the one or more simplified offset curves include one or more intersections;
splitting the one or more simplified offset curves into a plurality of simplified offset curve segments based on the one or more intersections;
assigning a current depth value to a current simplified offset curve segment of the plurality of simplified offset curve segments;
analyzing a next simplified offset curve segment of the plurality of simplified offset curve segments for a depth change condition between the current simplified offset curve segment and the next simplified offset curve segment; and
when the depth change condition is detected:
determining whether the depth change condition indicates a depth increase between the current simplified offset curve segment and the next simplified offset curve segment or a depth decrease between the current simplified offset curve segment and the next simplified offset curve segment;
when the depth change condition indicates the depth increase:
assigning an increased depth value to the next simplified offset curve segment; and
when the depth change condition indicates the depth decrease:
assigning a decreased depth value to the next simplified offset curve segment; and
when the depth change condition is not detected:
maintaining a current depth value for the next simplified offset curve segment; and
traversing the plurality of simplified offset curve segment to assign depth values to each next simplified offset curve segments of the plurality of simplified offset curve segments until each simplified offset curve segment of the plurality of simplified offset curve segments is assigned a corresponding depth value; and
generating the geospatial object buffer geography of the geospatial object by eliminating simplified offset curve segments of the plurality of simplified offset curve segments assigned a depth value above a depth threshold.

17. The non-transitory computer readable storage medium of claim 16, wherein the second memory section further stores operational instructions that, when executed by the processing module, causes the processing module to analyze a next simplified offset curve segment for the depth change condition by:
determining that the current simplified offset curve segment ends with an intersection point of the one or more intersection points.

18. The non-transitory computer readable storage medium of claim 16, wherein the second memory section further stores operational instructions that, when executed by the processing module, causes the processing module to:
when the plurality of simplified offset curve segments are traversed in a first direction, and next simplified offset curve segment is selected to left of the current simplified offset curve:
when the current offset curve segment is oriented away from the first direction from a perspective of an intersection point and the next simplified offset curve segment is oriented toward the first direction from the perspective of the intersection point, determine that the depth change condition indicates the depth increase; and
when the current offset curve segment is oriented toward the first direction from the perspective of the intersection point and the next simplified offset curve segment is oriented away from the first direction from the perspective of the intersection point, determine that the depth change condition indicates the depth decrease.

19. The non-transitory computer readable storage medium of claim 16, wherein the second memory section further stores operational instructions that, when executed by the processing module, causes the processing module to generate the geospatial object buffer geography further by:
selecting a simplified offset curve segment assigned the depth value below the depth threshold as an initial simplified offset curve segment;
starting from the initial simplified offset curve segment, traversing the one or more simplified offset curves; and
when an intersection point of the one or more intersections is encountered, proceeding to the next simplified offset curve segment that is assigned the depth value below the threshold, such that simplified offset curve segments of the plurality of simplified offset curve segments assigned the depth value above the depth threshold are eliminated from the geospatial object buffer geography.

20. The non-transitory computer readable storage medium of claim 11, wherein a third memory section that stores operational instructions that, when executed by the processing module, causes the processing module to execute one or more of:
outputting the geospatial object buffer geography to at least one node of a plurality of nodes of the database system for use in the query on a data set;
storing the geospatial object buffer geography to memory of the database system; and
providing the geospatial object buffer geography to a requester of the query.
